(19) United States
(12) Patent Application Publication
(10) Pub. No.: US 2022/0120117 A1
(43) Pub. Date: Apr. 21, 2022

(54) DUAL FUNCTION LATCH ASSEMBLY AND RETRACTABLE STRIKER AND/OR RETRACTABLE RATCHET ASSEMBLY FOR DUAL DOOR PILLARLESS DOOR SYSTEM AND METHOD OF OPERATION THEREOF

(71) Applicant: MAGNA CLOSURES INC., NEWMARKET (CA)

(72) Inventors: Franco Giovanni Ottino, Ippolito Nievo (IT); Francesco Cumbo, Pisa (IT); Ann-Margaret MOZOLA, Newmarket (CA); Roman CETNAR, Newmarket (CA); Fabio TERMINE, Livorno (IT); Luca BIGAZZI, Ponsacco (IT)

(21) Appl. No.: 17/506,060

(22) Filed: Oct. 20, 2021

Related U.S. Application Data
(60) Provisional application No. 63/185,349, filed on May 6, 2021.
(60) Provisional application No. 63/166,671, filed on Mar. 26, 2021.
(60) Provisional application No. 63/133,878, filed on Jan. 5, 2021.
(60) Provisional application No. 63/094,501, filed on Oct. 21, 2020.

(51) Int. Cl. E05B 81/56; E05B 81/06; E05B 81/22; E05B 81/16; E05B 81/66; E05B 81/74; E05B 83/38; E05B 77/54; E05B 77/04; E05B 85/26; B60J 5/04

(52) U.S. Cl. CPC E05B 81/56; E05B 81/06; E05B 81/22; E05B 81/16; E05B 81/66; B60J 5/0479; E05B 83/38; E05B 77/54; E05B 77/04; E05B 85/26; B60J 5/0468; E05B 81/74

(57) ABSTRACT

A door latch system is provided for a motor vehicle having a front door having a forward portion configured for sealed engagement with an A-pillar and a rear door having a rearward portion configured for sealed engagement with a C-pillar, the front and rear doors being configured for movement relative to a vehicle body of the motor vehicle to bring respective rearward and forward portions into sealed engagement with one another to close off a B-pillarless opening bounded by the vehicle body. The door latch system includes a retractable striker assembly and/or retractable ratchet assembly attached to one of the front and rear doors and includes a respective retractable striker and/or retractable ratchet movable between extended and retracted positions.

### CROSS-REFERENCE TO RELATED APPLICATIONS

This application claims the benefit of U.S. Provisional Application Ser. No. 63/185,349, filed May 6, 2021, and of U.S. Provisional Application Ser. No. 63/166,671, filed Mar. 26, 2021, and of U.S. Provisional Application Ser. No. 63/133,878, filed Jan. 5, 2021, and of U.S. Provisional Application Ser. No. 63/094,501, filed Oct. 21, 2020, all of which are incorporated herein by reference in their entirety.

### FIELD

The present disclosure relates generally to closure member systems for motor vehicles and, more particularly, to a retractable striker or ratchet assembly for a dual door pillar-less door system for securing vehicle doors of the door system relative to a vehicle body.

### BACKGROUND

This section provides background information related to the present disclosure which is not necessarily prior art.

A typical motor vehicle is equipped with at least one pair of doors to provide access to a passenger compartment. Specifically, most vehicles include driver-side and passenger-side swing doors that are pivotably supported from the vehicle body to move between closed and open positions. These doors are each equipped with a latch assembly having a latch mechanism operable in a latched mode to hold the door in its closed position and in an unlatched mode to permit movement of the door to its open position. The latch assembly is also equipped with a latch release mechanism that is selectively actuated (manually via a handle-actuated release system and/or via a power-operated release system) to shift the latch mechanism into its unlatched mode.

In some vehicles, such as pick-up trucks with extended cabs, the vehicle body is formed with an enlarged door opening without a structural B-pillar. Such “pillar-less or pillarless” dual-door closure systems typically include a front swing door pivotably hinged along or adjacent its front edge to a front vertical structural portion (i.e., the A-pillar) and/or to a horizontal structural portion of the vehicle body adjacent the A-pillar, of the door opening and a rear swing door pivotably hinged along or adjacent its rear edge to a rear vertical structural portion (i.e., the C-pillar) and/or to a horizontal structural portion of the vehicle body adjacent the C-pillar, of the door opening. The absence of the intermediate structural pillar (i.e., the B-pillar), requires that one or both of the front and rear doors latches along at least one or both of upper and lower portions of the enlarged access opening while the front door latches directly to the rear door or also latches one or both of upper and lower portions of the enlarged access opening. If, for example, the front door latches to the rear door, the latch assembly in the rear door cannot be unlatched until the front door latch assembly has been released and the front door swung to its open position.

In such “pillarless” dual-door closure systems, challenges can arise in establishing a reliable seal and fixed closure between the doors and the vehicle body due to an inability to utilize the missing B-pillar to establish leverage relative to a door hinge(s). Further complicating the ability to establish a tight seal and fixed closure can arise from the nature of the doors used in B-pillarless applications to “float” with “play” relative to the vehicle body prior to be fully closed, particularly in door applications hinged utilizing a non-fixed pivot axis to attach the doors to the vehicle body, such encountered when a translatable type hinge is used, e.g. 4-bar linkage type attachment mechanisms.

Further yet, in such “pillarless” dual-door closure systems, there is a lack of advancement made in the ability to present and/or cinch such doors. Additionally, it is desired to conceal components associated with dual-door closure systems, particularly in the region of the pillarless door opening in order to minimize potential obstructions and/or locations upon which a person may trip and/or have clothing get caught-up.

In view of the above, there remains a need to develop alternative latch assemblies, closure systems and latch associated mechanisms which address and overcome limitations and drawbacks associated with known dual door pillar-less door systems as well as to provide increased convenience and enhanced operational capabilities.

### SUMMARY

This section provides a general summary of the present disclosure and is not intended to be considered a comprehensive and exhaustive listing of its full scope or all aspects, objectives and features.

It is an aspect of the present disclosure to provide a door latch system for use in a B-pillarless dual-door closure system of a motor vehicle, wherein the dual-door closure system includes a front door and a rear door, and wherein cinchable closure latch assemblies can be fixed along or proximate upper and lower edges of the front door and/or the rear door, wherein the cinchable closure latch assemblies function to retain the front and rear doors in a closed position in sealed engagement with a vehicle body of the motor vehicle.

In accordance with this and other aspects, a door latch system for a motor vehicle including a front door having a forward portion configured for sealed engagement with an A-pillar and a rear door having a rearward portion configured for sealed engagement with a C-pillar, with the front and rear doors being configured for movement relative to a vehicle body of the motor vehicle to bring respective rearward and forward portions into sealed engagement with one another to close off a B-pillarless opening bounded by the vehicle body is provided. The door latch system includes a cinchable first latch assembly configured to releasably lock an upper edge of at least one of the front door and the rear door to the vehicle body, and a cinchable second latch assembly configured to releasably lock a lower edge of the at least one front door and the rear door to the vehicle body.

In accordance with another aspect, the cinchable first latch assembly can be configured to releasably lock the upper edge of the front door to the vehicle body and the cinchable second latch assembly can be configured to releasably lock the lower edge of the front door to the vehicle body. Further, a cinchable third latch assembly can be configured to releasably lock the upper edge of the rear door to the vehicle body, and a cinchable fourth latch assembly can be configured to releasably lock the lower edge of the rear door to the vehicle body.

In accordance with another aspect, the cinchable first latch assembly and the cinchable third latch assembly can be spaced from one another a first distance and the cinchable second latch assembly and the cinchable fourth latch assembly can be spaced from one another a second distance, wherein the first distance is greater than the second distance.

In accordance with another aspect, a cinchable fifth latch assembly can configured to releasably lock the rearward portion of the front door with the forward portion of the rear door in sealed engagement with one another.

In accordance with another aspect, the cinchable first latch assembly and the cinchable third latch assembly can be spaced from one another a first distance and the cinchable second latch assembly and the cinchable fourth latch assembly can be spaced from one another a second distance, wherein the first distance is substantially equal to the second distance.

In accordance with another aspect, a cinchable sixth latch assembly can be configured to releasably lock the forward portion of the front door with the A-pillar and a cinchable seventh latch assembly can be configured to releasably lock the rearward portion of the rear door with the C-pillar.

In accordance with another aspect, the cinchable first latch assembly and the cinchable third latch assembly can be spaced from one another a first distance and the cinchable second latch assembly and the cinchable fourth latch assembly can be spaced from one another a second distance, wherein the first distance is less than the second distance.

In accordance with another aspect, at least one of the cinchable first latch assembly, the cinchable second latch assembly, the cinchable third latch assembly and the cinchable fourth latch assembly can include a striker assembly with a striker that is moveable along an axis between an extended position, corresponding to a presented position of the front and rear doors, and a retracted position, corresponding to a cinched position of the front and rear doors.

In accordance with another aspect, each of the cinchable first latch assembly, the cinchable second latch assembly, the cinchable third latch assembly and the cinchable fourth latch assembly can include a striker assembly with a striker that is moveable along an axis between an extended position, corresponding to a presented position of the front and rear doors, and a retracted position, corresponding to a cinched position of the front and rear doors.

In accordance with another aspect, a method for configuring a door latch system for a B-pillarless dual-door arrangement of a motor vehicle to maintain a front door and a rear door of the B-pillarless dual-door arrangement in a closed position in sealed engagement with a vehicle body of the motor vehicle is provided. The method includes: configuring a cinchable first latch assembly to releasably lock an upper edge of the front door and/or the rear door to the vehicle body, and configuring a cinchable second latch assembly to releasably lock a lower edge of the front door and/or the rear door to the vehicle body.

In accordance with another aspect, the method can further include configuring the cinchable first latch assembly to releasably lock the upper edge of the front door to the vehicle body and configuring the cinchable second latch assembly to releasably lock the lower edge of the front door to the vehicle body. Further, configuring a cinchable third latch assembly to releasably lock the upper edge of the rear door to the vehicle body, and configuring a cinchable fourth latch assembly to releasably lock the lower edge of the rear door to the vehicle body.

In accordance with another aspect, the method can further include configuring the cinchable first latch assembly and the cinchable third latch assembly to be spaced from one another a first distance and configuring the cinchable second latch assembly and the cinchable fourth latch assembly to be spaced from one another a second distance, wherein the first distance is greater than the second distance.

In accordance with another aspect, the method can further include configuring a cinchable fifth latch assembly to releasably lock a rearward portion of the front door with a forward portion of the rear door in sealed engagement with one another.

In accordance with another aspect, the method can further include configuring a cinchable sixth latch assembly to releasably lock the forward portion of the front door with the A-pillar and configuring a cinchable seventh latch assembly to releasably lock the rearward portion of the rear door with the C-pillar.

In accordance with another aspect, the method can further include configuring the cinchable first latch assembly and the cinchable third latch assembly to be spaced from one another a first distance and configuring the cinchable second latch assembly and the cinchable fourth latch assembly to be spaced from one another a second distance, wherein the first distance is substantially equal to the second distance.

In accordance with another aspect, the method can further include configuring the cinchable first latch assembly and the cinchable third latch assembly to be spaced from one another a first distance and configuring the cinchable second latch assembly and the cinchable fourth latch assembly to be spaced from one another a second distance, wherein the first distance is less than the second distance.

In accordance with another aspect, a method of maintaining a front door and a rear door of a B-pillarless dual-door arrangement of a motor vehicle in a closed position in sealed engagement with a vehicle body of the motor vehicle is provided. The method includes configuring at least one of the front door and the rear door to be latched and cinched along an upper edge of the at least one front door and rear door to the vehicle body. The method further incudes configuring the at least one front door and rear door to be latched and cinched along a bottom edge of the at least one front door and rear door to the vehicle body.

In accordance with another aspect, the method can further include configuring both the front door and the rear door to be latched and cinched to the vehicle body.

In accordance with another aspect, the method can further include configuring the front door and the rear door to be latched and cinched together between a rearward portion of the front door and a forward portion of the rear door.

In accordance with another aspect, a striker assembly for moving a vehicle door from a closed position to a presented position, whereat a ratchet of a latch mechanism releasably maintains the vehicle door in a partially opened position, and for returning the vehicle door from the presented position to the closed position is provided. The striker assembly includes a striker moveable along an axis from a retracted position, corresponding to the closed position of the vehicle door, to an extended position, corresponding to the presented position of the vehicle door. Further, a powered actuator is operably coupled with the striker, wherein the powered actuator is configured to move the striker from the retracted position to the extended position and from the extended position to the retracted position.

In accordance with another aspect, the striker assembly can further include a linkage assembly operably coupling the striker with the powered actuator.

In accordance with another aspect, the striker assembly can further include a gear train operably coupling the striker with the powered actuator.

In accordance with another aspect, the linkage assembly is configured to convert rotational movement of gear members of the gear train into translational movement of the striker.

In accordance with another aspect, the striker assembly can further include a locking lever configured to releasably lock the striker in the retracted position.

In accordance with another aspect, the striker assembly can further include a cam member configured in operable communication with the locking lever to move the locking lever between a locked position, whereat the locking lever maintains the striker in the retracted position, and an unlocked position, whereat the striker is free to move under power to the extended position.

In accordance with another aspect, a door latch system for a motor vehicle having a front door having a forward portion configured for sealed engagement with an A-pillar of a vehicle body of the motor vehicle and a rear door having a rearward portion configured for sealed engagement with a C-pillar of the vehicle body of the motor vehicle, with the front and rear doors being configured for movement relative to the vehicle body to bring respective rearward and forward portions into sealed engagement with one another to close off a B-pillarless opening bounded by the vehicle body, is provided. The door latch system includes at least one latch assembly configured to releasably lock at least one of the front door and the rear door to the vehicle body. The at least one latch assembly has a latch mechanism fixed to one of the vehicle body and at least one of the front door and the rear door, and a striker assembly fixed to the other of the vehicle body and at least one of the front door and the rear door. The ratchet mechanism includes a ratchet movable between a striker capture position and a striker release position. The striker assembly includes a striker movable along an axis between a retracted position and an extended position. The door latch system further includes a controller configured in operable communication with the latch mechanism and the striker assembly. The controller is configured to signal the ratchet to move between the striker capture position and the striker release position and to signal the striker to move between the retracted position and an extended position.

In accordance with another aspect, the controller can be configured to signal the striker to move from the retracted position to the extended position, whereat the at least one of the front door and the rear door is moved from a closed position to a presented position, and to releasably maintain the ratchet in the striker capture position to releasably maintain the at least one of the front door and the rear door in the presented position.

In accordance with another aspect, the controller, while the striker is in the extended position, can be configured to signal the ratchet to move from the striker capture position to the striker release position to allow the at least one of the front door and the rear door to be moved from the presented position to an open position.

In accordance with another aspect, the controller, while the striker is in the extended position and the ratchet is in the striker capture position, can be configured to signal the striker to move from the extended position to the retracted position to return the at least one of the front door and the rear door from the presented position to the closed position.

In accordance with another aspect, a method of moving a door from a fully closed position to a presented, partially opened position, and then, from the presented, partially opened position to a fully open position is provided. The method includes steps of: detecting a door open signal; controlling the powered striker assembly to move the door from the closed position to a partially opened position; detecting the powered striker assembly being in its fully extended position; detecting a door open signal; and releasing the latch mechanism from latched engagement with the striker, whereat the door is free to be moved, such as manually by a user, from the presented, partially opened position to the fully open position.

A method of moving a door from a fully closed position to a presented, partially opened position, and then, optionally, from the presented, partially opened position to a fully open position, and optionally, from the presented, partially opened position to the fully closed position is provided. The method includes the steps of: while the door is in the fully closed position, detecting a door open signal; controlling the powered striker assembly to move the door from the fully closed position to the presented, partially opened position; detecting the powered striker assembly being in its fully extended position; and optionally, detecting a door open signal; and releasing the latch mechanism from latched engagement with the striker, whereat the door is free to be moved from the presented, partially opened position to the fully open position. Further and optionally, while the door is in the presented, partially opened position, detecting a door close signal; and controlling the powered striker assembly to move the door from the presented, partially opened position to the fully closed position.

In accordance with another aspect, the method can further include automatically detecting the door close signal in response to a preset, lapsed period of time without detecting a door open signal. Accordingly, the door, upon remaining in the presented, partially opened position for a predetermined amount of time, can be automatically returned to the fully closed position.

It is an aspect of the present disclosure to provide a latch assembly for a closure system having first and second closure members each movable between open and closed positions. The latch assembly includes a primary latch mechanism for the first closure member that has a primary actuation group operable to control actuation of the first closure member. In addition, the latch assembly includes a secondary latch mechanism for the second closure member that has a secondary actuation group operable to control actuation of the second closure member. The primary latch mechanism, primary actuation group, secondary latch mechanism and secondary actuation group are all integrated into the housing. The latch assembly additionally includes a controller unit that is also integrated into the housing. The controller unit is coupled to the primary and secondary actuation groups and is configured to determine which of the primary actuation group and the secondary actuation group to actuate. The controller unit controls actuation of at least one of the primary actuation group and the secondary actuation group accordingly.

In another aspect of the disclosure, the latch assembly further includes a switching unit coupled to the controller unit and to the primary and secondary actuation groups. The controller unit is further configured to control the switching unit to actuate and control actuation of the at least one of the primary actuation group and the secondary actuation group.

In another aspect of the disclosure, the primary actuation group of the primary latch mechanism includes a primary ratchet moveable between a striker release position and a striker capture position. In addition the primary actuation group of the primary latch mechanism includes a primary pawl moveable between a ratchet holding position for holding the primary ratchet in its striker capture position and a ratchet releasing position for permitting the primary ratchet to move to its striker release position. The primary actuation group is operable for moving the primary pawl between its ratchet holding position and its ratchet release position. The secondary actuation group of the secondary latch mechanism includes a secondary ratchet moveable between a striker release position and a striker capture position. The secondary actuation group of the secondary latch mechanism also includes a secondary pawl moveable between a ratchet holding position for holding the secondary ratchet in its striker capture position and a ratchet releasing position for permitting the secondary ratchet to move to its striker release position and the secondary actuation group is operable for moving the secondary pawl between its ratchet holding position and its ratchet release position.

It is another aspect of the disclosure to provide a dual door pillar-less door system for a motor vehicle with a first front door and a first rear door disposed on a first side of the motor vehicle and a second front door and a second rear door disposed on a second side of the motor vehicle opposite the first side. The door system includes a first side latch assembly that includes a first primary latch mechanism for the first front door that has a first primary actuation group operable to control actuation of the first front door. The first side latch assembly also has a first secondary latch mechanism for the first rear door that has a first secondary actuation group operable to control actuation of the first rear door. In addition, the first side latch assembly has a first side controller unit coupled to the first primary and first secondary actuation groups and is configured to control actuation of at least one of the first primary actuation group and the first secondary actuation group. The door system also includes a second side latch assembly having a second primary latch mechanism for the second front door that has a second primary actuation group operable to control actuation of the second front door. In addition, the second side latch assembly includes a second secondary latch mechanism for the second rear door that has a second secondary actuation group operable to control actuation of the second rear door. The second side latch assembly additionally includes a second side controller unit in communication with the first side controller unit and coupled to the second primary and second secondary actuation groups and configured to control actuation of at least one of the second primary actuation group and the second secondary actuation group.

In another aspect of the disclosure, the door system further includes a plurality of obstacle detection sensors in communication with the first side controller unit and the second side controller unit. The plurality of obstacle detection sensors are configured to detect an object or a gesture adjacent the first front door and the first rear door and the second front door and the second rear door. The first side controller unit is further configured to adjust the control of the actuation of the at least one of the first primary actuation group and the first secondary actuation group based on the detection of the object or the gesture. The second side controller unit is also further configured to adjust the control of the actuation of the at least one of the second primary actuation group and the second secondary actuation group based on the detection of the object or the gesture.

In another aspect of the disclosure, the first side controller unit is further configured to receive at least one closure member opening command from an input source selected from the group consisting of a handle switch, a body control module, and a key fob. The first side controller unit is also configured to determine whether the object or the gesture is adjacent at least one of the first front door or the first rear door. In addition, first side controller unit is configured to determine which of the first primary actuation group and the first secondary actuation group to actuate based on the at least one closure member opening command from the input source and whether the object or the gesture is adjacent the at least one of the first front door or the first rear door. The second side controller unit is further configured to receive the at least one closure member opening command from the input source selected from the group consisting of the handle switch, the body control module, and the key fob. The second side controller unit is also configured to determine whether the object or the gesture is adjacent at least one of the second front door or the second rear door. The second side controller unit is additionally configured to determine which of the second primary actuation group and the second secondary actuation group to actuate based on the at least one closure member opening command from the input source and whether the object or the gesture is adjacent the at least one of the second front door or the second rear door.

Yet another aspect of the disclosure is to provide a method of operating a dual door pillar-less door system of a vehicle with a plurality of closure members is also provided. The method includes the step of receiving at least one closure member opening command from an input source selected from the group consisting of a handle switch, a body control module, and a key fob. The method continues with the step of determining which of a primary actuation group and a secondary actuation group of at least one latch assembly to actuate. The next step of the method is controlling actuation of at least one of the primary actuation group and the secondary actuation group of the at least one latch assembly based on the determination of which of the primary actuation group and the secondary actuation group to actuate.

In another aspect of the disclosure, the plurality of closure members include a first front door and a first rear door and a second front door and a second rear door. The door system further includes a plurality of obstacle detection sensors configured to detect an object or a gesture adjacent the first front door and the first rear door and the second front door and the second rear door and the method further includes the step of detecting the object or the gesture adjacent the first front door and the first rear door and the second front door and the second rear door.

In another aspect of the disclosure, the method further includes the step of determining whether the at least one closure member opening command from the input source includes one closure member opening command. The method continues with the step of controlling the actuation of both of the first front door and the first rear door using a first side controller unit on a first side of the vehicle or both of the second front door and the second rear door using a second side controller unit on a second side of the vehicle opposite the first side based on the detecting the object or the gesture adjacent the first front door and the first rear door and the second front door and the second rear door in response to determining the at least one closure member opening command from the input source includes one closure member opening command. Next, determining whether the at least one closure member opening command from the input source includes two closure member opening commands. The method also includes the step of controlling the actuation of both of the first front door and the first rear door on the first side using the first side controller unit or both of the second front door and the second rear door using a second side controller unit on the second side and communicating an opposite side open command to one of the first side controller unit and the second side controller unit in response to determining the at least one closure member opening command from the input source includes two closure member opening commands. The method proceeds by controlling the actuation of both of the second front door and the second rear door using the second side controller unit in response to receiving the opposite side open command from the first side controller unit.

In another aspect of the disclosure, the method further includes the step of determining whether the at least one closure member opening command from the input source includes one closure member opening command. The method continues with the step of controlling the actuation of the first front door using a first side controller unit on a first side of the vehicle or actuation of the second front door using a second side controller unit on a second side of the vehicle opposite the first side based on the detecting the object or the gesture adjacent the first front door and the first rear door and the second front door and the second rear door in response to determining the at least one closure member opening command from the input source includes one closure member opening command. The method proceeds by determining whether the at least one closure member opening command from the input source includes two closure member opening commands. Next, controlling the actuation of the first front door and the first rear door using the first side controller unit on the first side of the vehicle or the second front door and the second rear door using the second side controller unit on the second side of the vehicle in response to determining the at least one closure member opening command from the input source includes two closure member opening commands. The next step of the method is determining whether the at least one closure member opening command from the input source includes three closure member opening commands. The method also includes the step of controlling the actuation of both of the first rear door and the first rear door on the first side of using the first side controller unit or both of the second front door and the second rear door using a second side controller unit on the second side and communicating an opposite side open command to one of the first side controller unit and the second side controller unit in response to determining the at least one closure member opening command from the input source includes three closure member opening commands. The method continues with the step of controlling the actuation of both of the first front door and the first rear door using the first side controller unit or both of the second front door and both of the second rear door using the second side controller unit in response to receiving the opposite side open command from the first side controller unit.

It is another aspect of the disclosure to provide a closure system for a motor vehicle having first and second closure members each movable between open and closed positions relative to a vehicle body of the motor vehicle. The closure system includes a retractable striker assembly attached to one of the first and second closure members and including a retractable striker being movable by a retractable striker actuator between an extended position and a retracted position. The retractable striker is engaged by another of the first and second closure members in the extended position and the retractable striker is disengaged by the another of the first and second closure members in the retracted position. At least one controller unit is in communication with the retractable striker assembly. The at least one controller unit is configured to receive door release signals corresponding to operation of a plurality of handles of the first and second closure members and a vehicle status. The at least one controller unit is also configured to control the retractable striker actuator to move the retractable striker based on the door release signals and vehicle status thereby selectively allowing or preventing the first and second closure members to be opened independently of one another.

It is yet another aspect of the disclosure to provide a method of operating a closure system for a motor vehicle having first and second closure members each movable between open and closed positions relative to a vehicle body of the motor vehicle. The method includes the step of receiving door release signals corresponding to operation of a plurality of handles of the first and second closure members and a vehicle status using at least one controller unit. The method continues with the step of moving a retractable striker using a retractable striker actuator of a retractable striker assembly attached to one of the first and second closure members between an extended position in which the retractable striker is engaged by the another of the first and second closure members and a retracted position in which the retractable striker is disengaged by the another of the first and second closure members based on the door release signals and vehicle status using the at least one controller unit thereby selectively allowing or preventing the first and second closure members to be opened independently of one another.

It is an aspect of the disclosure to provide a closure system for a motor vehicle having first and second closure members each movable between open and closed positions relative to a vehicle body of the motor vehicle. The closure system includes a retractable striker assembly and/or a retractable ratchet assembly attached to one of the first and second closure members and including a retractable striker and/or a retractable ratchet being movable by an actuator between an extended position and a retracted position. The retractable striker is engaged by another of the first and second closure members in the extended position and the retractable striker is disengaged by the another of the first and second closure members in the retracted position. The retractable ratchet is engaged by a striker in the extended position and the retractable ratchet is disengaged from the striker in the retracted position. At least one controller unit is in communication with the retractable striker assembly and/or the retractable ratchet assembly. The at least one controller unit is configured to receive door release signals corresponding to operation of a plurality of handles of the first and second closure members and a vehicle status. The at least one controller unit is also configured to control the actuator to move the retractable striker and/or the retractable ratchet based on the door release signals and vehicle status thereby selectively allowing or preventing the first and second closure members to be opened independently of one another.

It is yet another aspect of the disclosure to provide a method of operating a closure system for a motor vehicle having first and second closure members each movable between open and closed positions relative to a vehicle body of the motor vehicle. The method includes the step of receiving door release signals corresponding to operation of a plurality of handles of the first and second closure members and a vehicle status using at least one controller unit. The method continues with the step of moving a retractable striker using a retractable striker actuator of a retractable striker assembly and/or a retractable ratchet using a retractable ratchet actuator of a retractable ratchet assembly attached to one of the first and second closure members between an extended position and a retracted position based on the door release signals and vehicle status using the at least one controller unit thereby selectively allowing or preventing the first and second closure members to be opened independently of one another.

It is yet another aspect of the disclosure to provide a closure system for a motor vehicle having first and second closure members each movable between open and closed positions relative to a vehicle body of the motor vehicle. The closure system including a retractable striker assembly and/or retractable ratchet assembly attached to one of the first and second closure members and including a respective retractable striker and/or retractable ratchet being movable between an extended position whereat at least one the one of the first and second closure members is configured to be maintained in a closed position, and a retracted position, whereat the at least one of the first and second closure members is configured to be moved to an open position.

It is yet another aspect of the disclosure to provide a closure system for a motor vehicle having at least one closure member movable between open and closed positions relative to a vehicle body of the motor vehicle. The closure system includes a retractable ratchet assembly including a retractable ratchet movable by a retractable ratchet actuator along a ratchet translation axis between a retracted position released from a striker whereat the at least one closure member is movable to the open position and an extended position for captured engagement with the striker whereat the at least one closure member is in the closed position.

It is yet another aspect of the disclosure to provide the retractable ratchet including a pair of ratchets being configured for scissor-like movement between a striker capture position whereat the striker is releasably retained between the pair of ratchets and a striker release position whereat the striker is removed from the pair of ratchets.

It is yet another aspect of the disclosure to provide a ratchet biasing member that urges the pair of ratchets toward their striker release position.

It is yet another aspect of the disclosure to provide the pair of ratchets being sandwiched between a moveable frame plate and a moveable back plate, with one of the pair of ratchets being coupled to the moveable frame plate and the moveable back plate by a first pin for pivotal movement about the first pin and with the other of the pair of ratchets being coupled to the moveable frame plate and the moveable back plate by a second pin for pivotal movement about the second pin, with the first pin being spaced from the second pin.

It is yet another aspect of the disclosure to provide the moveable frame plate and the moveable back plate being receiving in a housing for slidable movement in the housing along the ratchet translation axis.

It is yet another aspect of the disclosure to provide a pawl lever pivotably attached to the housing, with the pawl lever being operably coupled with the retractable ratchet by a pawl to move the retractable ratchet along a ratchet translation axis.

It is yet another aspect of the disclosure to provide an actuator including a ratchet motor operably coupled to pawl lever to pivot pawl lever and move the pawl and the retractable ratchet along a ratchet translation axis in a first direction to the extended position in response to the retractable ratchet motor being energized.

It is yet another aspect of the disclosure to provide the pawl lever being configured to move the pawl and the retractable ratchet along the ratchet translation axis in a second direction to the retracted position in response to the retractable ratchet motor being driven.

It is yet another aspect of the disclosure to provide a pawl spring configured to impart a bias on the pawl to move the pawl toward, and into forcible engagement with the retractable ratchet.

It is yet another aspect of the disclosure to provide a method of operating a closure system for a motor vehicle having at least one closure member movable between open and closed positions relative to a vehicle body of the motor vehicle. The method includes receiving a door release signal corresponding to operation of a release mechanism of the at least one closure member using at least one controller unit. Further, moving at least one of a retractable striker using a retractable striker actuator of a retractable striker assembly and/or a retractable ratchet using a ratchet actuator of a retractable ratchet assembly attached to the at least one closure member between an engaged, extended position in which the at least one closure member is closed, and a disengaged, retracted position in which the at least one closure member is free to be opened.

It is yet another aspect of the disclosure for the method to include moving the at least one retractable striker and/or the retractable ratchet along a linearly straight axis between the engaged, extended position and the disengaged, retracted position.

It is yet another aspect of the disclosure for the method to include moving the at least one retractable striker and/or the retractable ratchet between the engaged, extended position and the disengaged, retracted position taking into account the vehicle status using the at least one controller unit thereby selectively allowing or preventing the at least one closure member to be opened and closed.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a perspective view of a motor vehicle equipped with a B-pillarless dual-door closure system;

FIG. 2 is a side elevation view of a portion of the motor vehicle shown in FIG. 1 with the doors of the dual-door B-pillarless closure system located in a closed position;

FIG. 3 is a side isometric view of a portion of the motor vehicle shown in FIG. 1 with the doors of the B-pillarless dual-door closure system located in a partially open position;

FIG. 4 is an isometric view of a closure latch assembly for use with at least one of the doors of the B-pillarless dual-door closure system and which is configured to provide anti-chucking and cinching functions in accordance with the present disclosure;

FIG. 4A is a side elevation view of the closure latch assembly of FIG. 4 shown with a ratchet of the B-pillarless closure latch assembly in a secondary striker capture position;

FIG. 4B is an opposite side elevation view of FIG. 4A;

FIG. 5 is a view similar to FIG. 4 showing the ratchet in the secondary striker capture position, a cinch lever in an unactuated position, a cancellation lever in a disengaged position, and an anti-chuck lever in a disengaged position;

FIG. 5A is side elevation view of a portion of FIG. 5 showing the cinch lever initiating engagement with the ratchet;

FIG. 6 is a view similar to FIG. 5 showing the ratchet in an intermediate position between the secondary striker capture position and the striker over-travel position, the cinch lever in an intermediate position between the unactuated position and an actuated position, the cancellation lever in the disengaged position, and the anti-chuck lever in the disengaged position;

FIG. 6A is a side elevation view of FIG. 6 showing the ratchet being rotated by the cinch lever and the pawl being rotated by the ratchet;

FIG. 7 is a view similar to FIG. 6 showing the ratchet in an intermediate position between the secondary striker capture position and the striker over-travel position, the cinch lever in an intermediate position between the unactuated position and an actuated position, the cancellation lever in an engaged position, and the anti-chuck lever in the disengaged position;

FIG. 7A is a side elevation view of FIG. 7 showing the ratchet being rotated by the cinch lever and the pawl being rotated by the ratchet;

FIG. 8 is a view similar to FIG. 7 showing the ratchet in the striker over-travel position, the cinch lever in the actuated position, the cancellation lever in the engaged position shown blocking the anti-chuck lever and maintaining the anti-chuck lever in the disengaged position;

FIG. 8A is a side elevation view of FIG. 8 showing the ratchet rotated by the cinch lever to the striker over-travel position and the cancellation lever engaged with and blocking the anti-chuck lever in the disengaged position;

FIG. 9 is a view similar to FIG. 8 showing the ratchet returned to a primary striker capture position via a bias imparted by a ratchet spring, the cinch lever returned to the unactuated position via a bias imparted by a cinch lever spring, the cancellation lever returned to the disengaged position via a bias imparted by a cancellation lever spring, and the anti-chuck lever in the disengaged position just prior to being returned to an engaged position via a bias imparted by an anti-chuck lever spring;

FIG. 10 is a view similar to FIG. 9 showing the ratchet in the primary striker capture position, the cinch lever in the unactuated position, the cancellation lever in the disengaged position, and the anti-chuck lever returned to an engaged position via the anti-chuck lever spring to inhibit the ratchet from moving toward the striker over-travel position;

FIG. 10A is a side elevation view of FIG. 10 showing the anti-chuck lever engaging a stop lug segment of the ratchet to inhibit the ratchet from moving toward the striker over-travel position;

FIG. 11A is a schematic top plan view illustrating hinge and seal arrangements of a front door having a forward portion configured for sealed engagement with an A-pillar via a door-to-body seal member and a rear door having a rearward portion configured for sealed engagement with a C-pillar via a door-to-body seal member, the front and rear doors being configured for movement relative to a vehicle body of the motor vehicle via hinge members to bring a rearward portion of the front door and a forward portion of the rear door into sealed engagement with one another via a door-to-door seal member to close off a B-pillarless opening, wherein the rearward portion of the front door and the forward portion of the rear door do not overlap one another;

FIG. 11B is a view similar to FIG. 11A in accordance with another aspect of the disclosure, wherein a rearward portion of a front door and a forward portion of a rear door overlap one another;

FIG. 11C is a side elevation view of FIG. 11A;

FIG. 11D is a side elevation view of FIG. 11B;

FIG. 12A is a schematic side plan view of a front door and a rear door in accordance with FIG. 11A illustrating a plurality of cinchable latch assemblies arranged in accordance with one aspect of the disclosure;

FIG. 12B is a view similar to FIG. 12A of a front door and a rear door in accordance with FIG. 11B illustrating a plurality of cinchable latch assemblies arranged in accordance with another aspect of the disclosure;

FIG. 12C is a schematic top plan view of FIG. 12B;

FIG. 13A is a schematic side plan view of a front door and a rear door in accordance with FIG. 11A illustrating a plurality of cinchable latch assemblies arranged in accordance with another aspect of the disclosure;

FIG. 13B is a view similar to FIG. 13A of a front door and a rear door in accordance with FIG. 11B illustrating a plurality of cinchable latch assemblies arranged in accordance with another aspect of the disclosure;

FIG. 13C is a schematic top plan view of FIG. 13B;

FIG. 14A is a schematic side plan view of a front door and a rear door in accordance with FIG. 11A illustrating a plurality of cinchable latch assemblies arranged in accordance with another aspect of the disclosure;

FIG. 14B is a view similar to FIG. 14A of a front door and a rear door in accordance with FIG. 11B illustrating a plurality of cinchable latch assemblies arranged in accordance with another aspect of the disclosure;

FIG. 14C is a schematic top plan view of FIG. 14B;

FIG. 15A is a schematic side plan view of a front door and a rear door in accordance with FIG. 11A illustrating a plurality of cinchable latch assemblies arranged in accordance with another aspect of the disclosure;

FIG. 15B is a view similar to FIG. 15A of a front door and a rear door in accordance with FIG. 11B illustrating a plurality of cinchable latch assemblies arranged in accordance with another aspect of the disclosure;

FIG. 15C is a schematic top plan view of FIG. 15B;

FIG. 16 is a schematic side plan view of a front door and a rear door in accordance with FIG. 11A illustrating a plurality of cinchable latch assemblies arranged in accordance with another aspect of the disclosure;

FIG. 17 is a schematic side plan view of a front door and a rear door in accordance with FIG. 11B illustrating a plurality of cinchable latch assemblies arranged in accordance with another aspect of the disclosure;

FIG. 17A is a schematic top plan view of FIG. 17;

FIG. 18 is a flow diagram illustrating a method of configuring a door latch system for a B-pillarless dual-door arrangement of a motor vehicle to maintain the B-pillarless dual-door arrangement in a closed position in sealed engagement with a vehicle body of the motor vehicle;

FIG. 19 is a flow diagram illustrating a method of maintaining a front door and a rear door of a B-pillarless dual-door arrangement of a motor vehicle in a closed position in sealed engagement with a vehicle body of the motor vehicle;

FIG. 20 is an isometric view of a power striker assembly of a closure latch assembly for use with at least one of the doors of a B-pillarless dual-door closure system and which is configured to provide presenter and cinching functions in accordance with the present disclosure;

FIG. 21 is an exploded isometric view of the power striker assembly of FIG. 20;

FIG. 22 is a view similar to FIG. 20 looking from a different perspective;

FIG. 23 is a backside view of the power striker assembly of FIG. 22;

FIG. 24 is a view similar to FIG. 23 with a backplate removed for clear viewing of internal components only;

FIG. 25 is a view similar to FIG. 24 with a motor assembly removed therefrom;

FIG. 26 is an isometric backside view of FIG. 25;

FIG. 27 is a plan backside of FIG. 25;

FIG. 28 is a side isometric view of a portion of the motor vehicle shown in FIG. 1 with pivotal front and rear doors of the B-pillarless dual-door closure system located in a partially open position in accordance with another aspect of the disclosure;

FIG. 29 is a schematic top view of the pivotal front and rear doors of FIG. 28 shown in an open position with a pair of power striker assemblies illustrated in a deployed position;

FIG. 30 is a view similar to FIG. 29 illustrating the rear door cinched to a fully closed position with the power striker assembly therefor shown in a retracted position and the front door being moved from the open position toward a closed position;

FIG. 31 is a view similar to FIG. 30 illustrating the power striker assembly of the front door engaged with a ratchet of the closure latch assembly of the front door, with the power striker assembly shown in the deployed position;

FIG. 32 is a view similar to FIG. 31 illustrating the power striker assembly of the front door in a retracted position and the front door cinched to a fully closed position;

FIG. 33 is a view similar to FIG. 32 illustrating a signal being sent to a controller configured in operable communication with the front and rear door closure latch assemblies to move the front door to a presented, partially opened position;

FIG. 34 is a view similar to FIG. 33 illustrating the front door moved to the presented, partially opened position;

FIG. 35 is a view similar to FIG. 34 illustrating the front door closure latch assembly in an unlatched state and the front door being moved from the presented, partially opened position toward the fully opened position;

FIG. 36 is a flow diagram illustrating a method of moving a closure panel from a fully closed position to a presented, partially opened position, and then, from the presented, partially opened position to a fully open position;

FIG. 37 is a view similar to FIG. 34 illustrating a front door and a rear door of a B-pillarless dual-door closure system having overlapping edges, with the front door shown in a presented, partially opened position and the rear door being moved toward a fully open position in accordance with another aspect of the disclosure;

FIG. 38 is a schematic side plan view of a translatable front door and a translatable rear door in accordance with another aspect of the disclosure illustrating a closure latch assembly having a power striker assembly arranged in accordance with another aspect of the disclosure;

FIG. 39 is a schematic top view of the translatable front and rear doors of FIG. 38 shown in a fully closed position with a power striker assembly illustrated in a retracted position;

FIG. 40 is a view similar to FIG. 39 illustrating a striker of the power striker assembly moved from a retraced position to an extended position;

FIG. 41 is a view similar to FIG. 40 illustrating a ratchet of the closure latch assembly released from the power striker assembly of the rear door translated to an open position and the striker moved to a retracted position;

FIG. 42 is a view similar to FIG. 41 illustrating the front door translated to an open position;

FIG. 43 is a view similar to FIG. 40 illustrating the ratchet engaged with the power striker assembly while in the extended position;

FIG. 44 is a view similar to FIG. 39 illustrating the power striker assembly moved from the extended position to the retracted position and the front and rear doors shown in the fully closed position;

FIG. 45 is a flow diagram illustrating a method of cinching a door with a power striker assembly in accordance with another aspect of the disclosure;

FIGS. 46-48 show another motor vehicle equipped with separate latch assemblies for each door that are operated by a passive entry feature used in conjunction with an electronic key fob;

FIGS. 49 and 49A depicts an additional example motor vehicle with a “pillar-less” door system with first and second moveable closure members latched using a single latch assembly according to aspects of the disclosure;

FIGS. 50A-50D show operation of the latch assembly of FIG. 52A according to aspects of the disclosure;

FIGS. 51A-51E show latch mechanisms with actuation groups for the first and second closure members of the latch assembly according to aspects of the disclosure;

FIG. 52 is a general block diagram of an electronic control circuit of the latch assembly according to aspects of the disclosure;

FIGS. 53A-53D depict operation of the door system using the latch assembly on each of a first side and a second side of the motor vehicle according to aspects of the disclosure;

FIGS. 54 and 55 are block diagrams of the door system including a plurality of obstacle detection sensors according to aspects of the disclosure;

FIGS. 56A-56D depict operation of the door system using the latch assembly on each of the first side and the second side of the motor vehicle while using the plurality of obstacle detection sensors according to aspects of the disclosure;

FIGS. 57-59 show steps of a method of operating the door system according to aspects of the disclosure;

FIGS. 61 to 63 illustrate exemplary closure systems for the motor vehicle including a retractable striker assembly according to aspects of the disclosure;

FIGS. 64A-64C show a first embodiment of the retractable striker assembly according to aspects of the disclosure;

FIGS. 65-67 illustrate a second embodiment, third embodiment, and fourth embodiment of the retractable striker assembly according to aspects of the disclosure;

FIGS. 68A-68C show the second embodiment of the retractable striker assembly of FIG. 62 during its operation according to aspects of the disclosure;

FIGS. 69A-69C show the third embodiment of the retractable striker assembly of FIG. 63 during its operation according to aspects of the disclosure;

FIGS. 70A-70C show the fourth embodiment of the retractable striker assembly of FIG. 64 during its operation according to aspects of the disclosure;

FIG. 71 is a block diagram of the closure system of FIG. 60 according to aspects of the disclosure;

FIGS. 72A and 72B show an example of at least one master latch assembly of the closure system according to aspects of the disclosure;

FIGS. 73A and 73B show an example of at least one slave latch assembly of the closure system according to aspects of the disclosure;

FIGS. 74-80E illustrate steps of a method of operating the closure system of FIG. 60 according to aspects of the disclosure;

FIG. 81 illustrates a linkage assembly for attaching first and second closure members respectively to the A-pillar and C-pillar of the vehicle body, according to aspects of the disclosure;

FIGS. 82A and 82B illustrate opposite side perspective views of another latch assembly for the motor vehicle including a retractable ratchet assembly according to aspects of the disclosure;

FIGS. 83A and 83B illustrate opposite side perspective views of an actuator assembly of the latch assembly of FIGS. 79A and 79B;

FIGS. 84A and 84B illustrate opposite side perspective views of a frame plate assembly of the latch assembly of FIGS. 79A and 79B;

FIGS. 85A-85C illustrate the retractable ratchet assembly of the latch assembly of FIGS. 79A and 79B;

FIGS. 86A-86D illustrate the latch assembly being actuated to move from a retracted, unlatched position to an extended, latched position;

FIGS. 87A-87D illustrate the latch assembly being returned from the extended, latched position to the retracted, unlatched position;

FIG. 88 illustrates another method of operating a closure system for a motor vehicle having at least one closure member movable between open and closed positions relative to a vehicle body of the motor vehicle;

FIG. 89 illustrates a closure system having a retractable striker assembly in accordance with further aspects of the present disclosure;

FIG. 90A illustrates the closure system of FIG. 89 showing the retractable striker assembly in an extended state such that a moveable striker of the retractable striker assembly is in a deployed position for engaging with a latch assembly shown in a closed or latched state;

FIG. 90B illustrates the closure system of FIG. 89 showing the retractable striker assembly in a retracted state such that the moveable striker is in a retracted position and disengaged from the latch assembly in an unlatched or releasing state;

FIGS. 91A to 91D, illustrate a sequence of views showing an opening or releasing operation of the closure system of FIG. 89;

FIGS. 92A to 92E, illustrate a sequence of views showing a closing or latching operation of the closure system of FIG. 89;

FIG. 93 illustrates a possible configuration of the closure system of FIG. 89;

FIG. 94 illustrates yet another possible configuration of the closure system of FIG. 89;

FIG. 95A illustrates the closure system of FIG. 94 showing the retractable striker assembly in an extended state such that a moveable striker of the retractable striker assembly is in a deployed position for engaging with the latch assembly shown in a closed or latched state;

FIG. 95B illustrates the closure system of FIG. 94 showing the retractable striker assembly in a retracted state such that the moveable striker is in a retracted position and disengaged from the latch assembly in an unlatched or releasing state;

FIGS. 96A to 96D, illustrate a sequence of views showing an opening or releasing operation of the closure system of FIG. 94;

FIGS. 97A to 97E, illustrate a sequence of views showing a closing or latching operation of the closure system of FIG. 94; and

FIG. 98 shows a method of releasing a latch assembly in accordance with aspects of the present disclosure.

### DETAILED DESCRIPTION OF EXAMPLE EMBODIMENTS

Example embodiments of a door latch system for a B-pillarless dual-door arrangement of a motor vehicle to maintain the B-pillarless dual-door arrangement in a closed position in sealed engagement with a vehicle body of the motor vehicle will now be more fully described with reference to the accompanying drawings. These example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

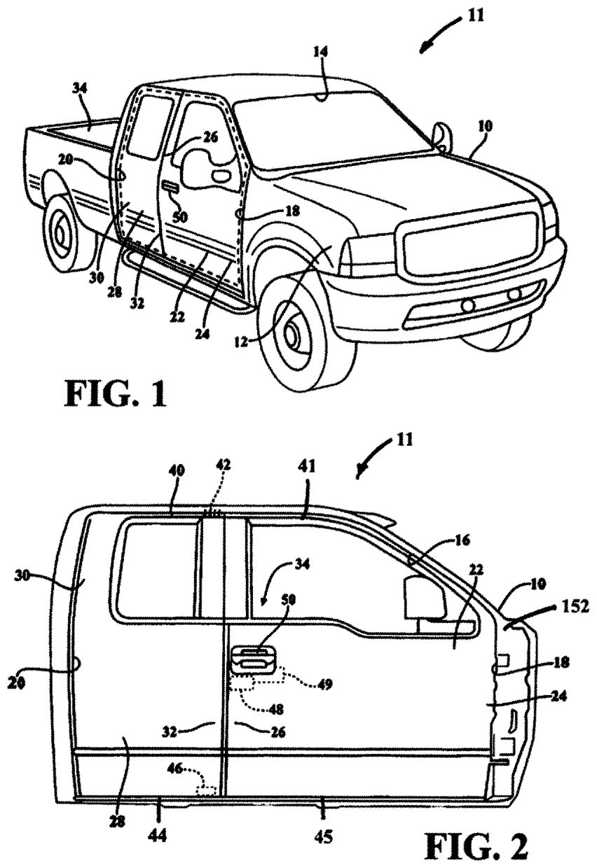

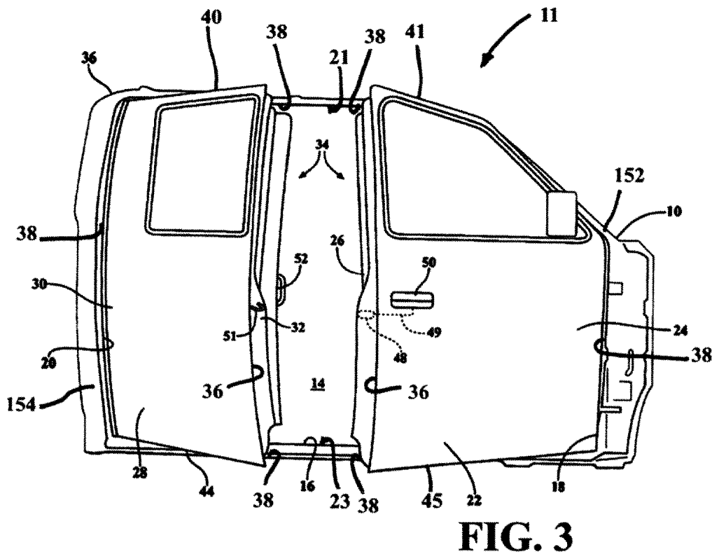

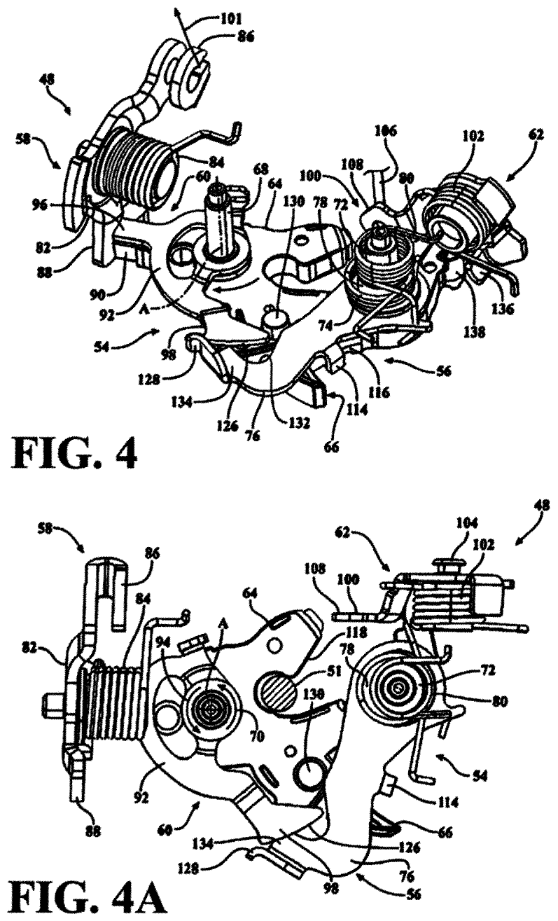

Referring initially to FIGS. 1-3, a motor vehicle 11 is shown configured as a pickup truck, by way of example and without limitation, including a vehicle body 10 having an exterior 12 and an interior 14 defining a passenger compartment. Connecting exterior 12 and interior 14 of vehicle body 10 is a continuous or “pillar-less” side opening 16 (FIG. 3) defining a first or front terminal end 18 and a second or rear terminal end 20, with there being no vertically extending pillar, commonly referred to as a “B-pillar”, extending from a horizontal upper body surface 21 to a horizontal lower body surface 23 of the vehicle body 10 between the front and rear terminal ends 18, 20. Accordingly, opening 16 is “B-pillar-less.” Providing a first moveable closure panel, also referred to as closure member, for a front portion of opening 16 is a first or front door 22 having a forward portion 24 pivotably and/or translatably connected or coupled via front hinges and/or link members (not shown), wherein front hinges or link members are connected to an “A-pillar” and/or one or both of upper body surface 21 and lower body surface 23 of vehicle body 10 adjacent to front terminal end 18 of opening 16. Front door 22 has a rearward portion 26 generally opposite its pivotal and/or translatable connection to vehicle body 10. Providing a second moveable closure panel or closure member for a rear portion of opening 16 is a second or rear door 28. Rear door 28 has a rearward portion 30 which is pivotably and/or translatably connected via rear hinges and/or link members (not shown), wherein rear hinges and/or link members are connected to a “C-pillar” and/or one or both of upper body surface 21 and lower body surface 23 of vehicle body 10 adjacent to rear terminal end 20 of opening 16 and has a forward portion 32 generally opposite to its pivotal connection. When front door 22 and rear door 28 are closed together, the extreme end of rearward portion 26 of front door 22 can be operably latched to and/or directly latched to the extreme end of forward portion 32 of rear door 28, wherein rearward portion 26 and forward portion 32 can be configured in overlapped relation with one another, if desired. Accordingly, front door 22 and rear door 28 together define a B-pillar-less, dual-door motor vehicle closure arrangement, also referred to as motor vehicle closure system 34.

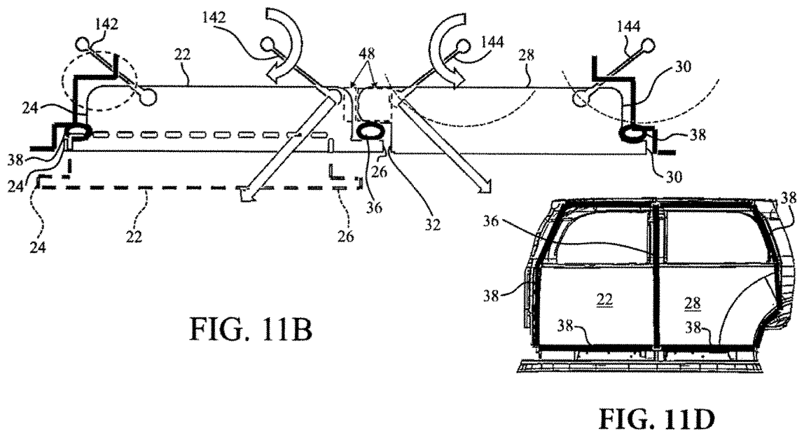

Rear door 28 is schematically shown having an upper or top edge 40 and a lower or bottom edge 44 and front door 22 is schematically shown having an upper or top edge 41 and a lower or bottom edge 45. When closed, front door 22 and rear door 28 have a releasable, operable latched connection with one another and with vehicle body 10 to provide a reliable closure of front door 22 and rear door 28 with vehicle body 10, with a reliable seal being formed by at least one or more seal members, such as a door-to-door seal member D2D seal member 36 and/or a door-to-body D2B seal member 38 (FIGS. 11A and 11B), as discussed further below. At least one or more (plurality) upper (first) and/or lower (second) cinchable door-to-body D2B latch assembly 42, 46 and/or side (third) cinchable door-to-door D2D closure latch assembly 48 can be incorporated with front and/or rear door 22, 28 to facilitate maintaining front and rear doors 22, 28 in their releasable, locked and sealed closed positions. A latch actuation mechanism 49 can be associated with a front door handle 50. The latch actuation mechanism 49 may be manually-operated and/or power-operated to facilitate the release of a corresponding latch assembly, such as third closure latch assembly 48, by way of example and without limitation. A release handle 52 (FIG. 3) can be provided on an interior wall along forward portion 32 of rear door 28 and can be actuated, with front door 22 open, to concurrently shift an associated latch assembly, such as each of first closure latch assembly 42 and second closure latch assembly 46, by way of example and without limitation, from its latched mode into its unlatched mode to permit rear door 28 to move toward its open position.

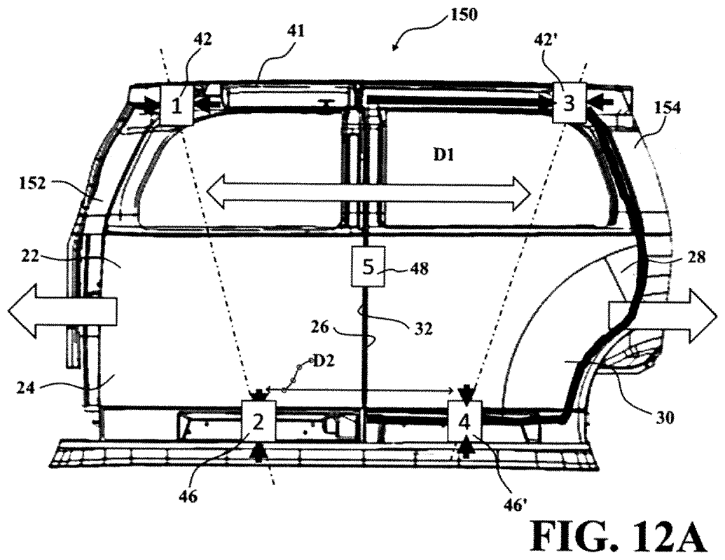

Those skilled in the art will recognize that the particular location of first, second and third closure latch assemblies 42, 46, 48, shown schematically in FIGS. 1-3 is merely intended to illustrate an exemplary dual-door latching arrangement and is not intended to limit the present disclosure, as it will be recognized that other arrangements are possible, such as discussed hereafter with reference to FIGS. 12-17, and considered to be within the scope of the present disclosure. It is to be recognized that the type of latch release mechanism employed can be varied in accordance with the inventive concepts associated with cinching aspects of the present disclosure and those skilled in the art will appreciate that any known power and/or manual latch release mechanism having a cinch mechanism can be associated with each of the closure latch assemblies. Dual-door systems may also include sliding door systems, tailgate systems, access hatch systems, or other ingress/egress systems.

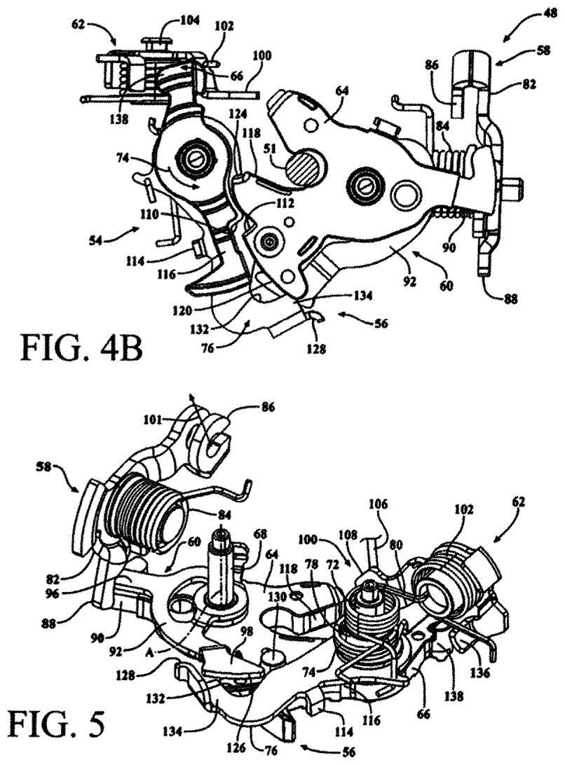

Referring now to FIGS. 4-4B, various components of a non-limiting embodiment of a closure latch assembly in accordance with an aspect of the disclosure will be described to clearly indicate integration of a cinching feature/mechanism, into a latch mechanism to render the latch mechanism “cinchable” for the purpose of eliminating door slop (play), rattle noise, commonly referred to as “chucking” noise, between front door 22 and rear door 28, while allowing front and/or rear doors 22, 28 to be cinched and sealed with vehicle body 10 from an at least partially open position to a fully closed position via the cinching feature. It is to be understood that the closure latch assembly hereinafter described can be used with rear door 28 and/or front door 22 in any one or more of the upper, lower and/or intermediate latch assembly positions.

FIG. 4 illustrates an example of third cinchable closure latch assembly 48, which can be mounted to a portion of front and/or rear door 22, 28. Closure latch assembly 48 is operable to releasably latch to a striker′, such as can be fixed to an associated region of front and/or rear door 22, 28 or vehicle body 10, shown in FIG. 3, by way of example and without limitation as the edge portion of rear door 28.

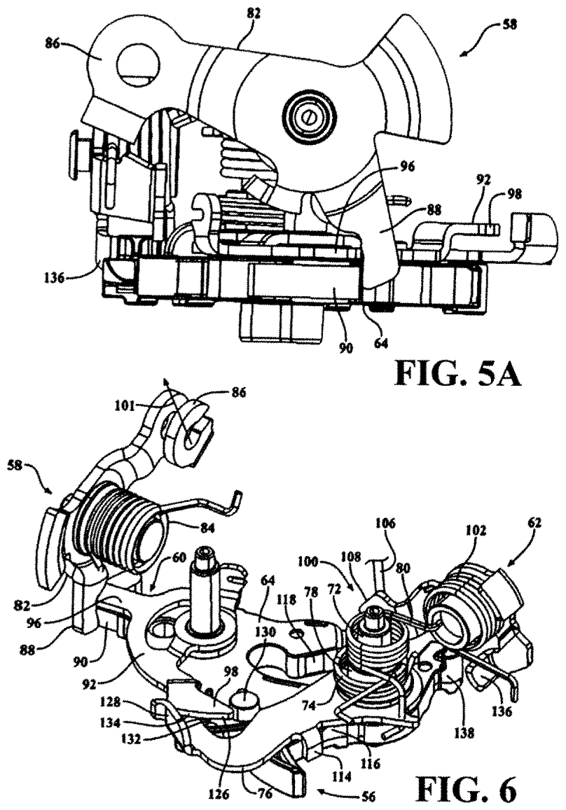

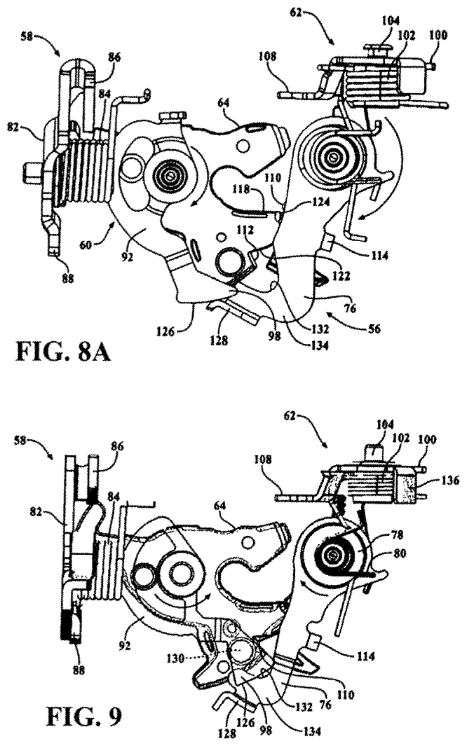

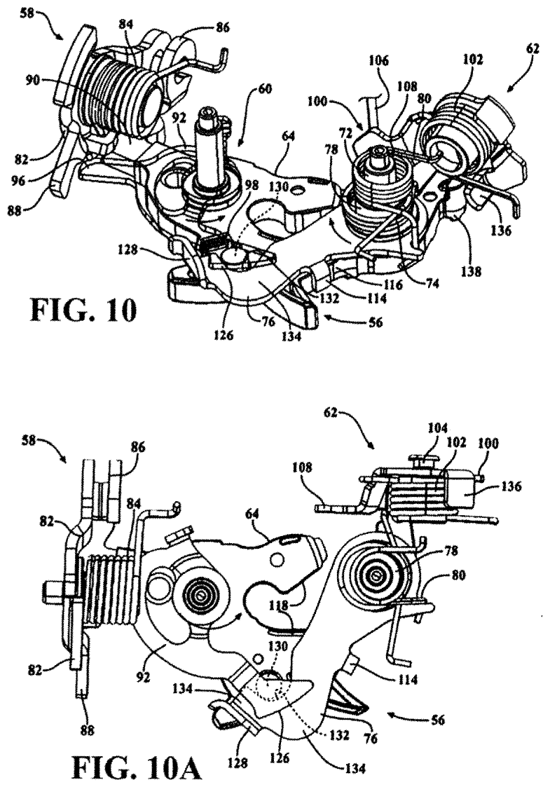

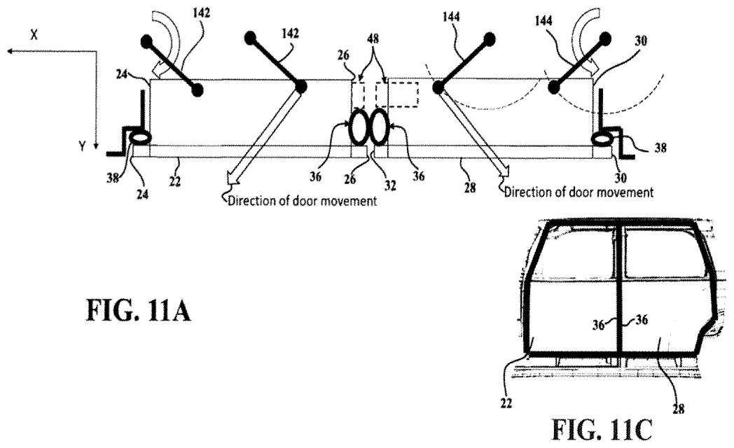

Closure latch assembly 48 includes a latch mechanism 54, an anti-chucking mechanism 56, a cinch mechanism 58, an anti-chucking cancellation mechanism 60, and a latch release mechanism 62. Latch mechanism 54 includes a ratchet 64 and a pawl 66. Ratchet 64 is pivotably supported on a frame plate via a ratchet rivet 68 for rotation about an axis A between a striker release position, a secondary striker capture position (FIGS. 4, 4A, 5, 5A), a primary striker capture position (FIGS. 9, 10, 10A), and a striker over-travel position (FIGS. 8, 8A). Ratchet 64 is normally biased toward its striker release position via a ratchet spring shown schematically at 70 (FIG. 4A). Pawl 66 is pivotably supported on frame plate via a pawl rivet 72 for movement relative to ratchet 64 between a ratchet holding position and a ratchet releasing position. Pawl 66 is normally biased toward its ratchet holding position via a pawl spring 74.

Anti-chucking mechanism 56 generally includes an anti-chuck lever 76, an anti-chuck washer 78, and an anti-chuck lever spring 80. Anti-chuck lever 76 is pivotably supported, such as via pawl rivet 72 also supporting pawl 66 for pivotal movement, by way of example and without limitation, for pivoting movement between a released position, also referred to as disengaged position, and an engaged position. Anti-chuck lever spring 80 is operable to normally bias anti-chuck lever 76 toward its engaged position.

Cinch mechanism 58 generally includes a cinch lever 82 and a cinch lever spring 84. Cinch lever 82 has an actuator arm 86 configured for operable communication with an actuation member, such as via a cable or rod, wherein actuation member can be mechanically, electromechanically and/or electronically actuatable, for example by an actuator 101 having an electric motor. Cinch lever 82 also has a drive arm 88 configured for selective driving engagement with a ratchet cinch arm, also referred to as driven member, ear or cog 90, of ratchet 64. Cinch lever spring 84 is operable to normally bias cinch lever 82 clockwise (as viewed in FIG. 4) toward an unactuated position.

Anti-chucking cancellation mechanism 60 generally includes an anti-chucking cancellation lever, referred to hereafter as cancellation lever 92, and a cancellation lever spring shown schematically at 94 (FIG. 4A). Cancellation lever 92 is pivotably supported, such as on ratchet rivet 68, for movement between a disengaged position, also referred to as rest position, and an engaged position, also referred to as holding position. Cancellation lever 92 has an actuator arm, also referred to as driven arm 96, configured for selective engagement with drive arm 88 of cinch lever 82 and a blocking arm 98 configured for selective engagement with anti-chucking lever 76. Cancellation lever spring 94 is operable to normally bias cancellation lever 92 counterclockwise (as viewed in FIG. 4) toward the disengaged position.

Latch release mechanism 62 is shown to generally include a release lever 100 and a release lever spring 102. Release lever 100 is pivotably mounted on a release lever rivet 104 for movement between a non-actuated position and an actuated position. Release lever spring 102 is configured to normally bias release lever 100 toward its non-actuated position. Release cable 106 is adapted to be interconnected between a first lug segment 108 of release lever 100 and door handle 50 so as to permit release lever 100 to move from its non-actuated position to its actuated position in response to actuation of door handle 50.

Referring now to FIGS. 5-8A, a series of sequential views are provided to illustrate a cinching operation of closure latch assembly 48. In particular, FIGS. 5 and 5A show closure latch assembly 48 in a partially opened and partially closed state, anti-chucking mechanism 56 in a released, disengaged position, cinch lever 82 in a pre-travel state, whereat actuation of a cinch actuator (not shown) is initiated to start to pivot cinch lever 82, cancellation lever 92 is in the rest or disengaged position, and latch release mechanism 62 in a non-actuated state. Specifically, ratchet 64 is shown in its secondary striker capture position (striker 51 mounted to rear door 28 is not shown), pawl 66 is shown (FIG. 4B) held in its secondary locked position via engagement of a pawl latch lug 110 with a secondary latch shoulder 112 formed on ratchet 64, anti-chuck lever 76 is shown held in its released position via engagement of a generally L or hook-shaped lever lug segment 114 formed on anti-chuck lever 76 with a first elongated leg portion 116 of pawl 66. The aforementioned states/positions are caused via movement of front door 22 from its open position toward its closed position, whereupon striker 51 is caused to enter a fishmouth segment of a latch housing frame plate (not shown) and engage a guide channel 118 formed in ratchet 64, thereby forcibly pivoting ratchet 64 in a closing (i.e., counterclockwise as viewed in FIG. 4B) direction from its striker release position toward its primary striker capture position in opposition to the biasing of ratchet spring 70. Such action causes pawl latch lug 110 to continue to ride along a first ratchet cam surface 120 on ratchet 164 so as to continue to hold pawl 66 in its ratchet releasing position. As noted, when pawl 66 is held in its ratchet releasing position, anti-chuck lever 76 is retained and held in its released position via engagement of lever lug segment 114 with elongated leg portion 116 of pawl 66.

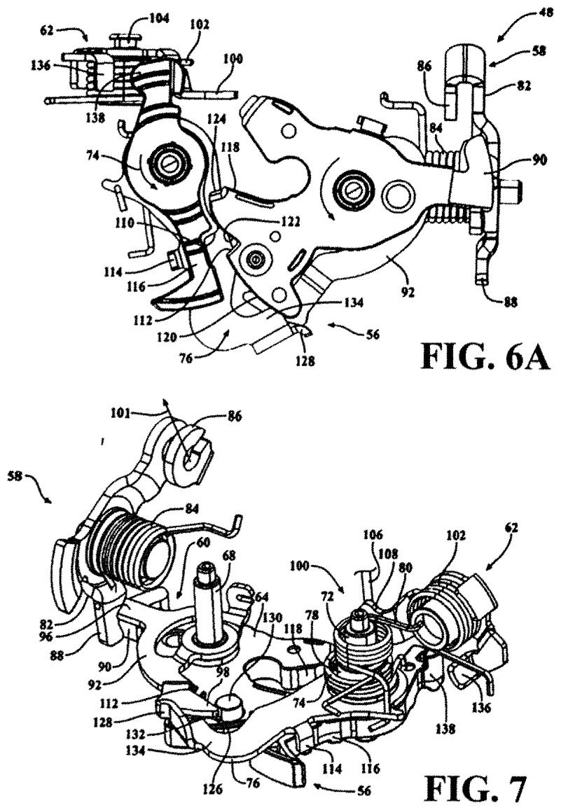

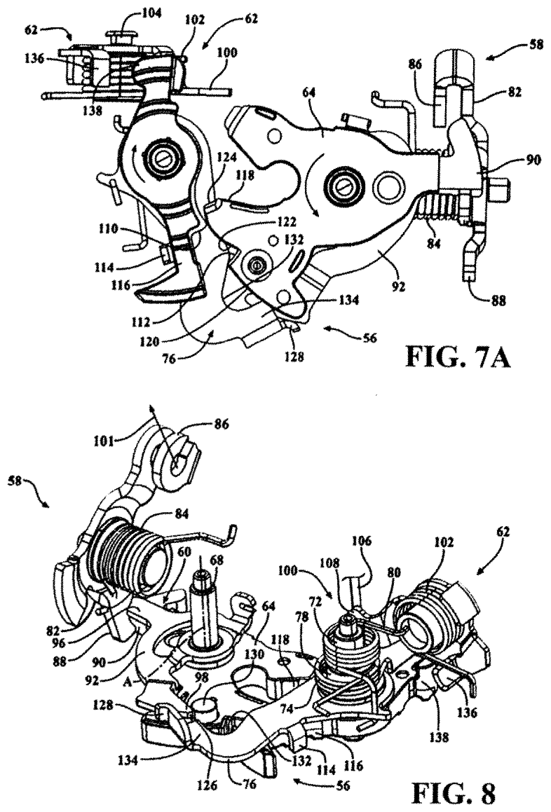

Referring next to FIG. 6, continued actuation and rotation of the cinch lever 82 causes continued rotation of ratchet 64 in the closing direction from the secondary striker capture position toward the over-travel position, whereupon pawl latch lug 110 rides along a second ratchet cam surface 122 formed on ratchet 64, whereat drive arm 88 of cinch lever 82 initiates engagement with actuator arm 96 of cancellation lever 92 (shown in rest, disengaged position in FIG. 6). Then, as cinch lever 82 continues to rotate, drive arm 88 pushes actuator arm 96 and pivots cancellation lever 92 against the bias of cancellation lever spring 94 to a holding or engaged position, also referred to as the blocking position (FIG. 7). In the blocking position, an abutment portion, also referred to as stop surface 126, of blocking arm 98 of cancellation lever 92 is brought into position to confront a projection 128 of anti-chuck lever 76 (projection 128 is shown extending laterally outwardly from a generally planar surface of anti-chuck lever 76) to obstruct movement of anti-chuck lever 76 under the bias of anti-chuck lever spring 80. As such, anti-chuck lever 76 is temporarily restrained against movement to its engaged position. As a result, as shown in FIG. 8, ratchet 64 moves past its primary striker capture position into its striker over-travel position, such as due to front door 22 being moved to its fully closed (i.e., a “hard slam”) position. This rotation of ratchet 64 to its striker over-travel position permits pawl spring 74 to forcibly move pawl 66 into its ratchet holding position relative to ratchet 64. However, such over-travel of ratchet 64 does not result in completed latching engagement between pawl latch lug 110 and primary latch shoulder 124. FIG. 9 illustrates subsequent slight rotation of ratchet 64 in a releasing (i.e. counterclockwise) direction caused by ratchet spring 70 which, in turn, causes pawl latch lug 110 to engage primary latch shoulder 124 of ratchet 64, thereby causing pawl 66, while in its primary ratchet holding position, to hold ratchet 64 in its primary striker capture position. In this position, latch mechanism 54 is operating in its latched mode.

Thereafter, as shown in FIG. 10, cancellation lever 92 is caused to move back to its rest, disengaged position under the bias of cancellation lever spring 94, thereby allowing anti-chuck lever spring 80 to forcibly pivot anti-chuck lever 76 in the engaging direction until a raised stop feature, also referred to as anti-chucking pin, stop lug segment or simply stop lug 130, on ratchet 64 is retained in engagement against an anti-chuck latch shoulder 132 formed in generally hook-shaped end segment 134 of anti-chuck lever 76. This biased, confronting engagement between stop lug 130 and anti-chuck latch shoulder 132 establishes an engagement interface between ratchet 64 and anti-chuck lever 76. Thus, anti-chuck lever 76 is now located in its engaged position such that anti-chucking mechanism 56 is operating in its engaged mode, whereat ratchet 64 is prevented from pivoting from its primary striker capture position toward its striker over-travel position, thereby preventing the generation of chucking noise. To subsequently shift closure latch assembly 48 from its latched mode into its unlatched mode, release cable 106 pulls on release lever 100 for causing release lever 100 to move from its non-actuated position into its actuated position. Such pivotal movement of release lever 100 causes in a tab segment 136 on release lever 100 to engage a second leg portion 138 of pawl 66, wherein second leg portion 138 is located on an opposite side of pawl rivet 72 from first leg portion 116, for causing pawl 66 to forcibly move from its ratchet holding position into its ratchet releasing position, thereby permitting ratchet 64 to rotate from its primary striker capture position (FIG. 10A) back to its striker release position. As is understood, a power actuator, such as an electric motor and gearset, could be used to pivot release lever 100 from its non-actuated position into its actuated position to provide a power latch release feature. As pawl 66 rotates toward its ratchet releasing position, a drive surface of first elongate leg portion 116 engages lever lug segment 114 of anti-chuck lever 76 to pivot anti-chuck lever 76 to its released position. Anti-chuck lever 76 remains positioned in its released position as long as ratchet 64 remains in positions other than its primary striker capture position, due to engagement of lever lug segment 114 with elongate leg portion 116 of pawl 66, thereby allowing cancellation lever 92 to pivot to its engaged position, as discussed above, while a cinching operation is being performed to move ratchet 64 to its over-travel position while closing front door 22.

FIGS. 11A and 11B illustrate front door 22 and rear door 28 hinge and seal arrangements in accordance with an aspect of the disclosure. In FIG. 11A, the rearward portion 26 of front door 22 and the forward portion 32 of rear door 28 do not overlap one another, but rather, form a butt joint with one another upon being moved to their respective closed positions. To facilitate forming a reliable seal therebetween, at least one and shown as each door 22, 28 can include door-to-door seal 36 along the respective rearward and forward portions 36, 32. To further facilitate forming a reliable seal between front door 22, rear door 28 and vehicle body 10, door-to-body seal(s) 38 can be provided for sealed engagement with respective upper edges 41, 40 of front and rear doors 22, 28, respective bottom edges 45, 44 of front and rear doors 22, 28, and respective forward and rearward portions 24, 30 of front and rear doors 22, 28.

Front and rear doors 22, 28 are configured for powered movement such that the motion is not merely pivotal, but also translational, by way of example and without limitation. Accordingly, the forward portion 24 of front door 22 and the rearward portion 30 of rear door 28 translate outwardly from vehicle body 10, such that front and rear doors 22, 28 move along an X-axis extending along a length of the motor vehicle 11 and along a Y-axis extending along a width of the motor vehicle 11. The X-Y axes movement of front and rear doors 22, 28 can be facilitated via front and rear 4-bar linkage hinges 142, 144, by way of example and without limitation. The powered movement can be facilitated by any known presenter and/or power-actuated door opening mechanism. It is to be recognized that manual operation for moving front and rear doors 22, 28 is also contemplated herein.

In FIG. 12A, a door latch system 150 for motor vehicle 11 is shown for securing front door 22 and forward portion 24 thereof in sealed engagement with an A-pillar 152 and rear door 28 and rearward portion 30 thereof in sealed engagement with a C-pillar 154. Front and rear doors 22, 28 are configured for movement relative to vehicle body 10 of the motor vehicle 11, as discussed above, to bring rearward portion 26 of front door 22 and frontward portion 32 of rear door 28 into releasably locked and sealed engagement with one another to close off a B-pillarless opening 16 bounded by the vehicle body 10. It is to be recognized that the door latch system 150 can be provided on both side of motor vehicle 11, as desired.

Door latch system 150 includes a first cinchable latch assembly having a cinch mechanism, referred to hereafter as first latch assembly 42, configured to releasably lock upper edge 41, 42 of at least one of the front door 22 and the rear door 28 to the vehicle body 10, and a second cinchable latch assembly having a cinch mechanism, referred to hereafter as second latch assembly 46, configured to releasably lock a lower edge 44, 45 of the at least one front door 22 and rear door 28 to the vehicle body 10. In the non-limiting embodiment of FIG. 12A, the first latch assembly 42 is configured to releasably lock the upper edge 41 of the front door 22 to the upper body surface 21 of vehicle body 10 and the second latch assembly 46 is configured to releasably lock the lower edge 45 of the front door 22 to the lower body surface 23 of vehicle body 10. Further, door latch system 150 is shown including a third cinchable latch assembly having a cinch mechanism, referred to hereafter as third latch assembly 42′, configured to releasably lock upper edge 40 of the rear door 28 to the upper body surface 21 of vehicle body 10, and a fourth cinchable latch assembly having a cinch mechanism, referred to hereafter as fourth latch assembly 46′, configured to releasably lock lower edge 44 of the rear door 28 to the lower body surface 23 of vehicle body 10. Further yet, door latch system 150 is shown including a fifth cinchable latch assembly, referred to hereafter as fifth latch assembly 48, configured to releasably lock the rearward portion 26 of the front door 22 with the forward portion 32 of the rear door 28, such that rearward portion 26 of the front door 22 and forward portion 32 of the rear door 28 are releasably closed in sealed engagement with one another.

The first latch assembly 42 and the third latch assembly 42′ are spaced from one another a first distance D1 and the second latch assembly 46 and the fourth latch assembly 46′ are spaced from one another a second distance D2, wherein the first distance D1 is greater than the second distance D2. In the non-limiting embodiment, as illustrated, the first latch assembly 42 is immediately adjacent the A-pillar 152 and the third latch assembly 42′ is immediately adjacent the C-pillar 154. Meanwhile, the second latch assembly 46 is spaced from the A-pillar 152 and the fourth latch assembly 46′ is spaced from the C-pillar 154. In the illustrated embodiment, the second latch assembly 46 is shown about midway between forward portion 24 and rearward portion 26 of front door 22 and fourth latch assembly 46′ is shown about midway between forward portion 32 and rearward portion 30 of rear door 28. With first latch assembly 42 and third latch assembly 42′ being immediately adjacent A-pillar 152 and C-pillar 154, respectively, secure locking and sealing of front door 22 to A-pillar 152 and rear door 28 to C-pillar 154 is attained, while fifth latch assembly 48 functions to secure locking and sealing of front door 22 to rear door 28 despite the wide spacing of first and third latch assemblies 42, 42′. First and third latch assemblies 42, 42′ function to provide enhanced securement along directions of the X and Y axes (FIG. 11A), while second and fourth latch assemblies 46, 46′ function to provide enhanced securement along directions of the Y and Z axes (Z axis extending along the vehicle width). The embodiment of FIG. 12A has a sealing arrangement as illustrated in FIG. 11A, with each the front door 22 and the rear door 28 having a door-to-door seal 36 running along the respective rearward portion 26 and forward portion 32, wherein the fifth latch assembly 48 facilitates bringing seals 36 into sealed engagement with one another and with vehicle body 10.

In FIG. 12B, a door latch system 150′ for motor vehicle 11 is shown in accordance with another aspect for securing front door 22 and forward portion 24 thereof in sealed engagement with an A-pillar 152 and rear door 28 and rearward portion 30 thereof in sealed engagement with a C-pillar 154. Door latch system 150′ includes first latch assembly 42, second latch assembly 46, third latch assembly 42′, fourth latch assembly 46′ and fifth latch assembly 48, as discussed above for door latch system 150; however, a notable difference is with regard to the location and spacing of second latch assembly 46 and fourth latch assembly 46′, with first latch assembly 42 and third latch assembly 42′ being the same or substantially the same. Rather than second latch assembly 46 and fourth latch assembly 46′ being located approximately midway between forward portion 24 of front door 22 and rearward portion 30 of rear door 28, second latch assembly 46 is located immediately adjacent rearward portion 26 of front door 22 and fourth latch assembly 46′ is located immediately adjacent forward portion 32 of rear door 28. This location of second latch assembly 46 and fourth latch assembly 46′ is facilitated by rearward portion 26 of front door 22 and forward portion 24 of front door 22 being configured in overlapping relation with one another, as shown in FIG. 11B.

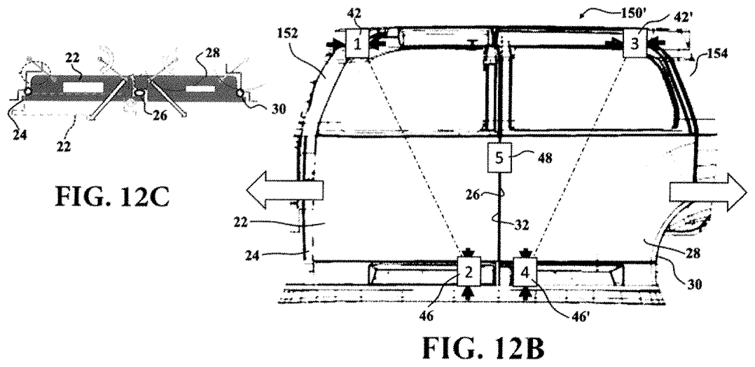

In FIG. 13A, a door latch system 250 for motor vehicle 11 is shown in accordance with another aspect for securing front door 22 and forward portion 24 thereof in sealed engagement with an A-pillar 152 and rear door 28 and rearward portion 30 thereof in sealed engagement with a C-pillar 154. Door latch system 250 includes first latch assembly 42, second latch assembly 46, third latch assembly 42′, fourth latch assembly 46′ and fifth latch assembly 48, as discussed above for door latch system 150; however first latch assembly 42 and the third latch assembly 42′ are spaced from one another a first distance d1 and the second latch assembly 46 and the fourth latch assembly 46′ are spaced from one another a second distance d2, wherein the first distance d1 is equal to or substantially equal to the second distance d2. Further, the first latch assembly 42 and the second latch assembly 46 are spaced from the A-pillar 152, shown as being intermediate forward portion 24 and rearward portion 26 of front door 22, and the third latch assembly 42′ and the fourth latch assembly 46′ are spaced from the C-pillar 154, shown as being intermediate forward portion 32 and rearward portion 30 of rear door 28. Fifth latch assembly 48 facilitates forming a reliable closure and seal between front and rear doors 22, 28 even with the spacing of latch assemblies 42, 42′, 46, 46′ from rearward and forward portions 26, 32. The embodiment of FIG. 13A has a sealing arrangement as illustrated in FIG. 11A, with each the front door 22 and the rear door 28 having a door-to-door seal 36 running along the respective rearward portion 26 and forward portion 32, wherein the fifth latch assembly 48 facilitates bringing seals 36 into sealed engagement with one another and with vehicle body 10.

In FIG. 13B, a door latch system 250′ for motor vehicle 11 is shown in accordance with another aspect for securing front door 22 and forward portion 24 thereof in sealed engagement with an A-pillar 152 and rear door 28 and rearward portion 30 thereof in sealed engagement with a C-pillar 154. Door latch system 250′ includes first latch assembly 42, second latch assembly 46, third latch assembly 42′, fourth latch assembly 46′ and fifth latch assembly 48, as discussed above for door latch system 250; however, rather the rearward portion 26 of front door 22 and forward portion 24 of front door 22 forming a butt joint, they are configured in overlapping relation with one another, as shown in FIG. 11B. Otherwise, door latch system 250′ is the same or substantially the same as door latch system 250.

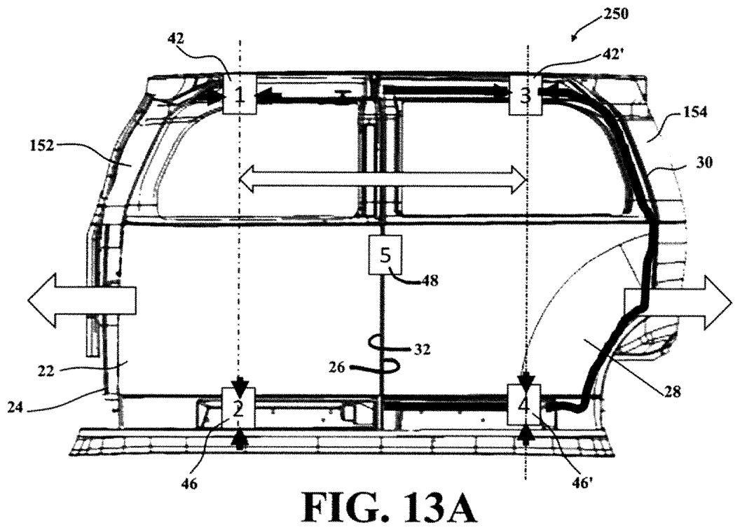

In FIG. 14A, a door latch system 350 for motor vehicle 11 is shown in accordance with another aspect for securing front door 22 and forward portion 24 thereof in sealed engagement with an A-pillar 152 and rear door 28 and rearward portion 30 thereof in sealed engagement with a C-pillar 154. Door latch system 350 includes first latch assembly 42, second latch assembly 46, third latch assembly 42′, fourth latch assembly 46′ and fifth latch assembly 48, as discussed above for door latch system 150; however, a notable difference is with regard to the location and spacing of latch assemblies 42, 42′, 46, 46′. Rather than first latch assembly 42 and the third latch assembly 42′ being spaced from one another a first distance D1 and the second latch assembly 46 and the fourth latch assembly 46′ being spaced from one another a second distance D2, wherein the first distance D1 is greater than the second distance D2, first latch assembly 42 and the third latch assembly 42′ are spaced from one another a first distance D1′ and the second latch assembly 46 and the fourth latch assembly 46′ are spaced from one another a second distance D2′, wherein the first distance D1′ is less than the second distance D2′. In the embodiment illustrated, first latch assembly 42 is located immediately adjacent rearward portion 26 of front door 22 and third latch assembly 42′ is located immediately adjacent forward portion 32 of rear door 28, while second latch assembly 46 is located immediately adjacent forward portion 24 of front door 22, and thus, immediately adjacent A-pillar 152, and fourth latch assembly 46′ is located immediately adjacent rearward portion 30 of rear door 28, and thus, immediately adjacent C-pillar 154. The embodiment of FIG. 14A has a sealing arrangement as illustrated in FIG. 11A, with each the front door 22 and the rear door 28 having a door-to-door seal 36 running along the respective rearward portion 26 and forward portion 32, wherein the fifth latch assembly 48 facilitates bringing seals 36 into sealed engagement with one another and with vehicle body 10.

In FIG. 14B, a door latch system 350′ for motor vehicle 11 is shown in accordance with another aspect for securing front door 22 and forward portion 24 thereof in sealed engagement with an A-pillar 152 and rear door 28 and rearward portion 30 thereof in sealed engagement with a C-pillar 154. Door latch system 350′ includes first latch assembly 42, second latch assembly 46, third latch assembly 42′, fourth latch assembly 46′ and fifth latch assembly 48, as discussed above for door latch system 250; however, rather the rearward portion 26 of front door 22 and forward portion 24 of front door 22 forming a butt joint, they are configured in overlapping relation with one another, as shown in FIG. 11B. Otherwise, door latch system 350′ is the same or substantially the same as door latch system 350.

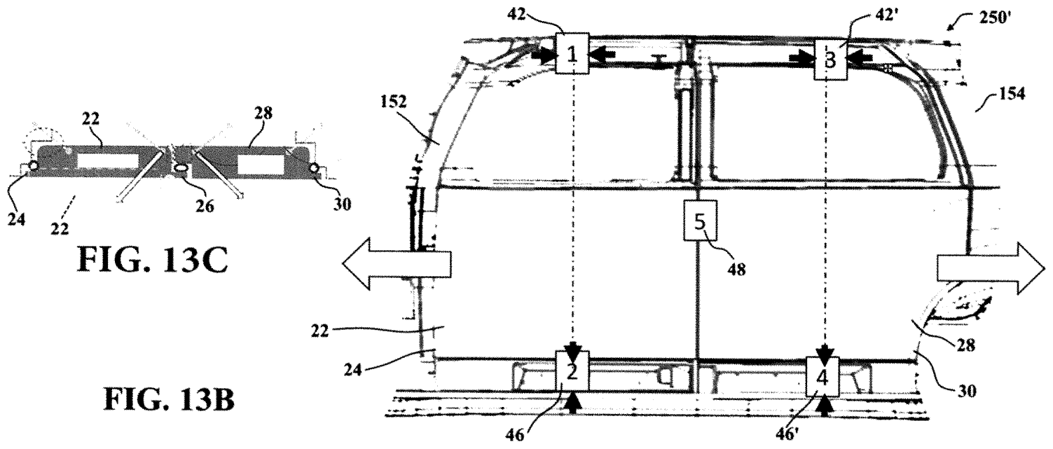

In FIG. 15A, a door latch system 450 for motor vehicle 11 is shown in accordance with another aspect for securing front door 22 and forward portion 24 thereof in sealed engagement with an A-pillar 152 and rear door 28 and rearward portion 30 thereof in sealed engagement with a C-pillar 154. Door latch system 450 includes first latch assembly 42, second latch assembly 46, third latch assembly 42′, fourth latch assembly 46′, but not a fifth latch assembly to secure rearward portion 26 of front door 22 with forward portion 32 of rear door 28, as discussed above for door latch systems 150, 150′, 250, 250′, 350, 350′. Accordingly, a door-to-door latch is not required. This, in part, can be facilitated by positioning first latch assembly 42, second latch assembly 46, third latch assembly 42′, and fourth latch assembly 46′ immediately adjacent rearward portion 26 of front door 22 and forward portion 32 of rear door 28. However a sixth latch assembly 48′ is configured to releasably lock the forward portion 24 of the front door 22 with the A-pillar 152 and a seventh latch assembly 48″ is configured to releasably lock the rearward portion 30 of the rear door 28 with the C-pillar 154. Sixth latch assembly 48′ is arranged generally midway between upper edge 41 of front door 22 and bottom edge 45 of front door 22 and seventh latch assembly 48″ is arranged generally midway between upper edge 40 of rear door 28 and bottom edge 44 of rear door 28. The embodiment of FIG. 15A has a sealing arrangement as illustrated in FIG. 11A, with each the front door 22 and the rear door 28 having a door-to-door seal 36 running along the respective rearward portion 26 and forward portion 32, wherein the fifth latch assembly 48 facilitates bringing seals 36 into sealed engagement with one another and with vehicle body 10.

In FIG. 15B, a door latch system 450′ for motor vehicle 11 is shown in accordance with another aspect for securing front door 22 and forward portion 24 thereof in sealed engagement with an A-pillar 152 and rear door 28 and rearward portion 30 thereof in sealed engagement with a C-pillar 154. Door latch system 450′ includes first latch assembly 42, second latch assembly 46, third latch assembly 42′, fourth latch assembly 46′, sixth latch assembly 48′, and seventh latch assembly 48″, as discussed above for door latch system 450; however, rather the rearward portion 26 of front door 22 and forward portion 24 of front door 22 forming a butt joint, they are configured in overlapping relation with one another, as shown in FIG. 11B. Otherwise, door latch system 450′ is the same or substantially the same as door latch system 450.

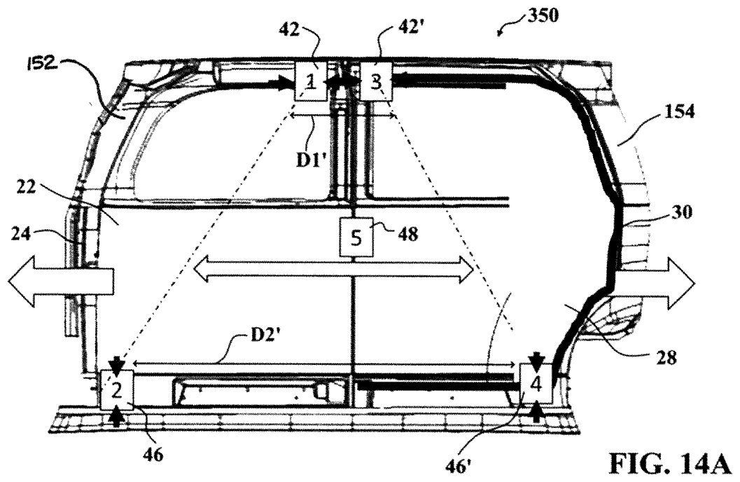

In FIG. 16, a door latch system 550 for motor vehicle 11 is shown in accordance with another aspect for securing front door 22 and forward portion 24 thereof in sealed engagement with an A-pillar 152 and rear door 28 and rearward portion 30 thereof in sealed engagement with a C-pillar 154. Door latch system 550 includes first latch assembly 42, second latch assembly 46, third latch assembly 42′, fourth latch assembly 46′, sixth latch assembly 48′, and seventh latch assembly 48″, as discussed above for door latch system 450, and also a fifth latch assembly 48 to secure rearward portion 26 of front door 22 with forward portion 32 of rear door 28, as discussed above for door latch systems 150, 150′, 250, 250′, 350, 350′. The embodiment of FIG. 16 has a sealing arrangement as illustrated in FIG. 11A, with the front door 22 and the rear door 28 forming a butt joint and each having a door-to-door seal 36 running along the respective rearward portion 26 and forward portion 32, wherein the fifth latch assembly 48 facilitates bringing seals 36 into sealed engagement with one another and with vehicle body 10.

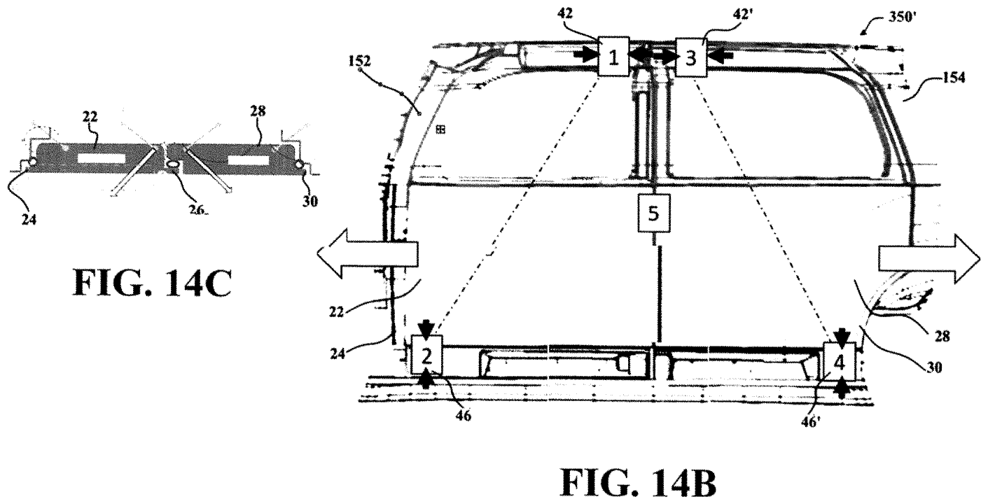

In FIG. 17, a door latch system 650 for motor vehicle 11 is shown in accordance with another aspect for securing front door 22 and forward portion 24 thereof in sealed engagement with an A-pillar 152 and rear door 28 and rearward portion 30 thereof in sealed engagement with a C-pillar 154. Door latch system 650 includes first latch assembly 42, second latch assembly 46, fifth latch assembly 48, sixth latch assembly 48′, and seventh latch assembly 48″. First latch assembly 42 is shown configured to lock upper edge 40 of rear door 28 to upper body surface 21 of vehicle body 10, while second latch assembly 46 is shown configured to lock bottom edge 44 of rear door 28 to lower body surface 23 of vehicle body 10. Sixth latch assembly 48′ is configured to releasably lock the forward portion 24 of the front door 22 with the A-pillar 152 and a seventh latch assembly 48″ is configured to releasably lock the rearward portion 30 of the rear door 28 with the C-pillar 154. Fifth latch assembly 48 is configured to secure rearward portion 26 of front door 22 with forward portion 32 of rear door 28, as discussed above for door latch systems 150, 150′, 250, 250′, 350, 350′. With the first latch assembly 42 and the second latch assembly 46 being immediately adjacent the forward portion 32 of rear door 28, and with the forward portion 32 of rear door 28 overlapping the rearward portion 26 of front door 22, a door-to-body latch for front door 22, other than sixth latch assembly 48′, is not needed. It is further contemplated herein that door-to-door fifth latch assembly 48 could be eliminated.

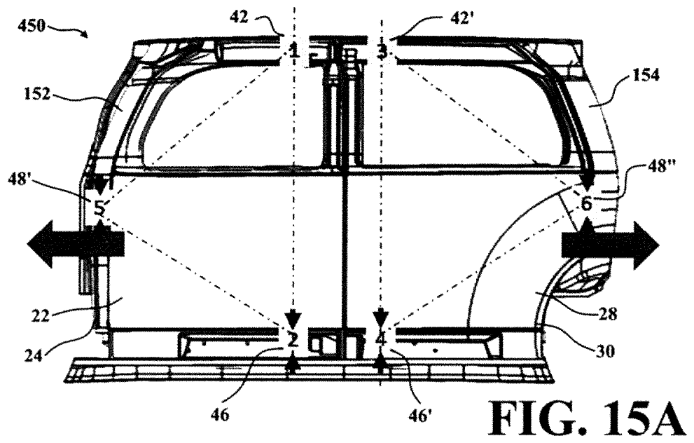

In FIG. 18, a method of 1000 for configuring a door latch system 150, 150′, 250, 250′, 350, 350′, 450, 450′, 550, 650 for a B-pillarless dual-door arrangement of a motor vehicle 11 to maintain a front door 22 and a rear door 28 of the B-pillarless dual-door arrangement in a closed position in sealed engagement with a vehicle body 10 of the motor vehicle 11 is illustrated. The method 1000 includes a step 1050 of configuring a cinchable first latch assembly 42 to releasably lock an upper edge 40, 41 of the front door 22 and/or the rear door 28 to the vehicle body 10, and a step 1100 of configuring a cinchable second latch assembly 46 to releasably lock a lower edge 44, 45 of the front door 22 and/or the rear door 28 to the vehicle body 10.

The method 1000 can further include a step 1150 of configuring the cinchable first latch assembly 42 to releasably lock the upper edge 41 of the front door 22 to the vehicle body 10 and configuring the cinchable second latch assembly 46 to releasably lock the lower edge 45 of the front door 22 to the vehicle body 10, and further including: configuring a cinchable third latch assembly 42′ to releasably lock the upper edge 40 of the rear door 28 to the vehicle body 10, and configuring a cinchable fourth latch assembly 46′ to releasably lock the lower edge 44 of the rear door 28 to the vehicle body 10.

The method 1000 can further include a step 1200 of configuring the cinchable first latch assembly 42 and the cinchable third latch assembly 42′ to be spaced from one another a first distance D1 and configuring the cinchable second latch assembly 46 and the cinchable fourth latch assembly 46′ to be spaced from one another a second distance D2, wherein the first distance D1 is greater than the second distance D2.

The method 1000 can further include a step 1250 of configuring a cinchable fifth latch assembly 48 to releasably lock a rearward portion 26 of the front door 22 with a forward portion 32 of the rear door 28 in sealed engagement with one another.

The method 1000 can further include a step 1300 of configuring the cinchable first latch assembly 42 and the cinchable third latch assembly 42′ to be spaced from one another a first distance d1 and configuring the cinchable second latch assembly 46 and the cinchable fourth latch assembly 46′ to be spaced from one another a second distance d2, wherein the first distance d1 is substantially equal to the second distance d2.

The method 1000 can further include a step 1350 of configuring a cinchable sixth latch assembly 48′ to releasably lock the forward portion 24 of the front door 22 with the A-pillar 152 and configuring a cinchable seventh latch assembly 48″ to releasably lock the rearward portion 30 of the rear door 28 with the C-pillar.

The method 1000 can further include a step 1400 of configuring the cinchable first latch assembly 42 and the cinchable third latch assembly 42′ to be spaced from one another a first distance D1′ and configuring the cinchable second latch assembly 46 and the cinchable fourth latch assembly 46′ to be spaced from one another a second distance D2′, wherein the first distance D1′ is less than the second distance.

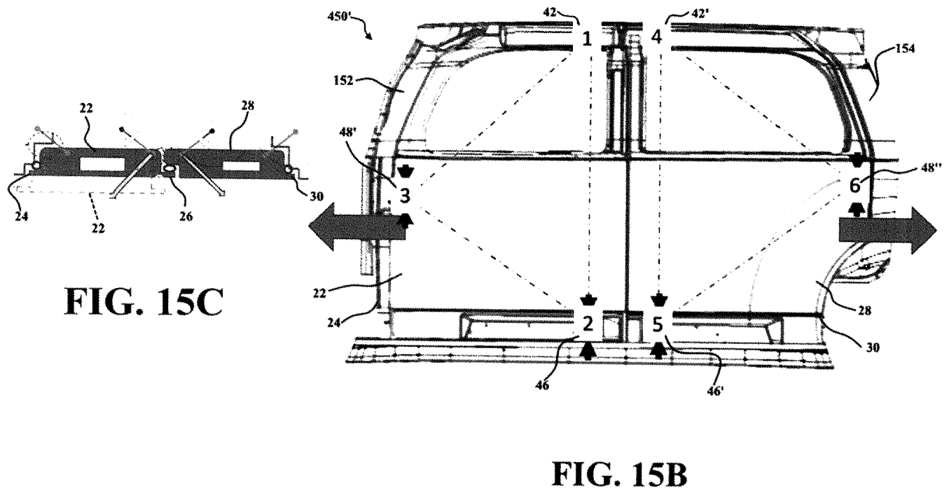

In FIG. 19, a method of 2000 of maintaining a front door 22 and a rear door 28 of a B-pillarless dual-door arrangement of a motor vehicle 11 in a closed position in sealed engagement with a vehicle body 10 of the motor vehicle 11 is illustrated. The method 2000 includes a step 2100 of configuring at least one of the front door 22 and the rear door 28 to be latched and cinched along an upper edge 41, 40 of the at least one front door 22 and rear door 28 to the vehicle body 10. The method 2000 further incudes a step 2200 of configuring the at least one front door 22 and rear door 28 to be latched and cinched along a bottom edge 45, 44 of the at least one front door 22 and rear door 28 to the vehicle body 10.

The method 2000 can further include a step 2300 of configuring both the front door 22 and the rear door 28 to be latched and cinched to the vehicle body 10.

The method 2000 can further include a step 2400 of configuring the front door 22 and the rear door 28 to be latched and cinched together between a rearward portion 26 of the front door 22 and a forward portion 32 of the rear door 28.

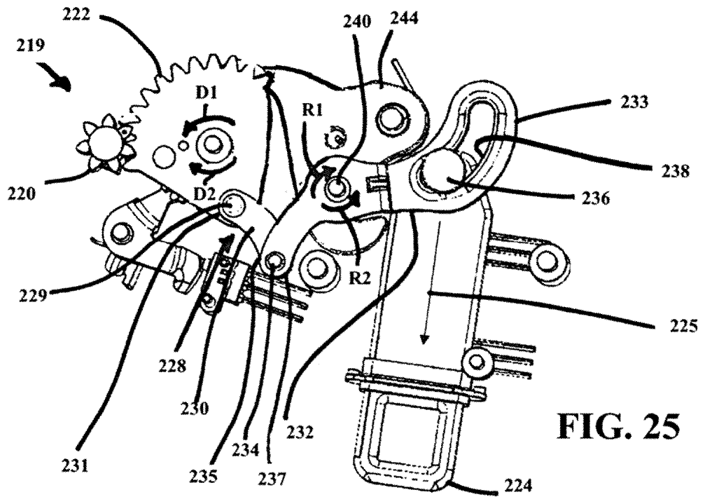

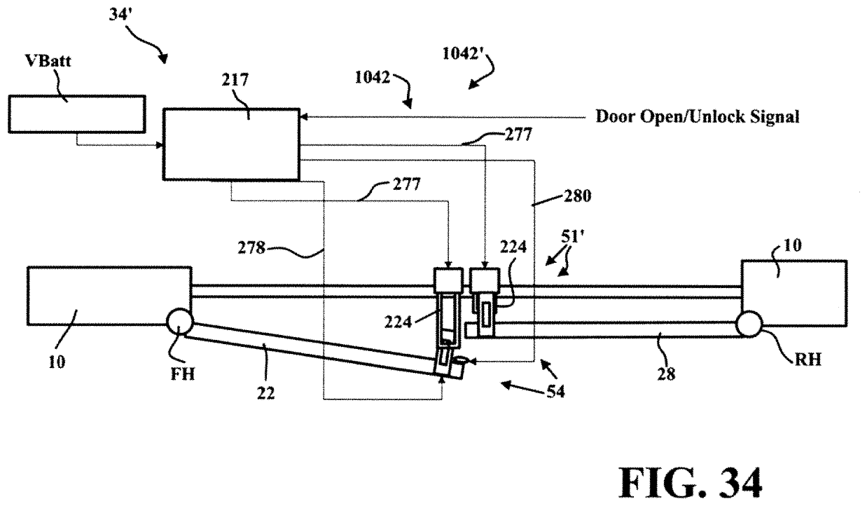

Referring now to FIG. 28, a motor vehicle 11′ similar to motor vehicle 11 of FIG. 3 is shown, wherein the same reference numerals are used to identify like features. Motor vehicle 11′ includes a vehicle body 10 having an exterior 12 and an interior 14, with a continuous or “pillar-less” side opening 16 defining a first or front terminal end 18 and a second or rear terminal end 20, with there being no vertically extending pillar extending from a horizontal upper body surface 21 to a horizontal lower body surface 23 between the front and rear terminal ends 18, 20. A first or front door 22 has a forward portion 24 pivotably connected or coupled via front hinges FH, wherein front hinges FH are connected to an “A-pillar”. Front door 22 has a rearward portion 26 generally opposite its pivotal connection to vehicle body 10. A second or rear door 28 has a rearward portion 30 which is pivotably connected via rear hinges RH, wherein rear hinges RH are connected to a “C-pillar” of vehicle body 10 adjacent to rear terminal end 20 of opening 16 and has a forward portion 32 generally opposite to its pivotal connection. When front door 22 and rear door 28 are closed together, the extreme end of rearward portion 26 of front door 22 can be operably latched to and/or directly latched to the extreme end of forward portion 32 of rear door 28, wherein rearward portion 26 and forward portion 32 can be configured in overlapped relation (FIG. 37) with one another, if desired.

Rear door 28 is schematically shown having an upper or top edge 40 and a lower or bottom edge 44 and front door 22 is schematically shown having an upper or top edge 41 and a lower or bottom edge 45. When closed, front door 22 and rear door 28 have a releasable, operably latched connection with vehicle body 10, and optionally with one another, to provide a reliable closure of front door 22 and rear door 28 with vehicle body 10, with a reliable seal being formed by at least one or more seal members, such as a door-to-door seal member D2D seal member 36 and/or a door-to-body D2B seal member 38, as discussed above with reference to FIGS. 11A and 11B. At least one or more (plurality) upper (first) and/or lower (second) presenting and cinchable door-to-body D2B latch assembly 1042, 1042′, 1046, 1046′ and/or side (third) presenting and cinchable door-to-door D2D closure latch assembly 1048 are incorporated with front and/or rear door 22, 28 to facilitate presenting front and rear doors 22, 28 as well as positioning and maintaining front and rear doors 22, 28 in their releasable, locked and sealed closed positions. A latch actuation mechanism 49 can be associated with front and/or rear doors 22, 28, shown as being operably connected to a front door handle 50, by way of example and without limitation. The latch actuation mechanism 49 may be manually-operated and/or power-operated to facilitate the release of a corresponding latch assembly, such as third closure latch assembly 1048, by way of example and without limitation. A release handle 52 (FIG. 3) can be provided on an interior wall of front and/or rear doors 22, 28, shown as being along forward portion 32 of rear door 28, by way of example and without limitation, and can be actuated, with front door 22 open, to concurrently shift an associated latch assembly, such as each of first closure latch assembly 1042, 1042′ and second closure latch assembly 1046, 1046′, by way of example and without limitation, from its latched mode into its unlatched mode to permit rear door 28 to move toward its open position. Accordingly, front door 22 and rear door 28, along with first and/or second presenting and cinchable door-to-body D2B latch assembly 1042, 1042′, 1046, 1046′ and/or third presenting and cinchable door-to-door D2D closure latch assembly 1048, define a pillarless dual-door motor vehicle closure arrangement, also referred to as pillarless motor vehicle closure panel or pillarless door system 34′ with a door latch system 750 providing presenter and cinching functionality.

The inclusion and particular location of first, and/or second and/or third closure latch assembly 1042, 1042′, 1046, 1046′, 1048 is merely intended to illustrate an exemplary dual-door latching arrangement and is not intended to limit the present disclosure, as discussed above for closure latch assemblies 42, 46, 48.

Closure latch assembly 1042, 1042′, 1046, 1046′, 1048, in accordance with an aspect of the disclosure, will be described to clearly indicate integration of a presenter and cinching feature/mechanism, into a striker assembly 51′ to provide the closure latch assembly 1042, 1042′, 1046, 1046′, 1048 with presenter and cinching functionality for the purposes of facilitating opening front door 22 and rear door 28 without “popping” noise from D2D and D2B seal members 36, 38, while eliminating door slop (play), rattle noise, commonly referred to as “chucking” noise, between front door 22 and rear door 28, while further allowing front and/or rear doors 22, 28 to be cinched and sealed with vehicle body 10 from an at least partially open position to a fully closed position via the cinching feature. It is to be understood that the closure latch assembly hereinafter described can be used with rear door 28 and/or front door 22 in any one or more of the upper, lower and/or intermediate latch assembly positions.

Closure latch assembly 1042, 1042′, 1046, 1046′, 1048 can include a latch mechanism 54 as discussed above for closure latch assembly 42, 46, 48 and as illustrated in FIGS. 4-10A, and thus, no further discussion is believed necessary regarding latch mechanism 54.

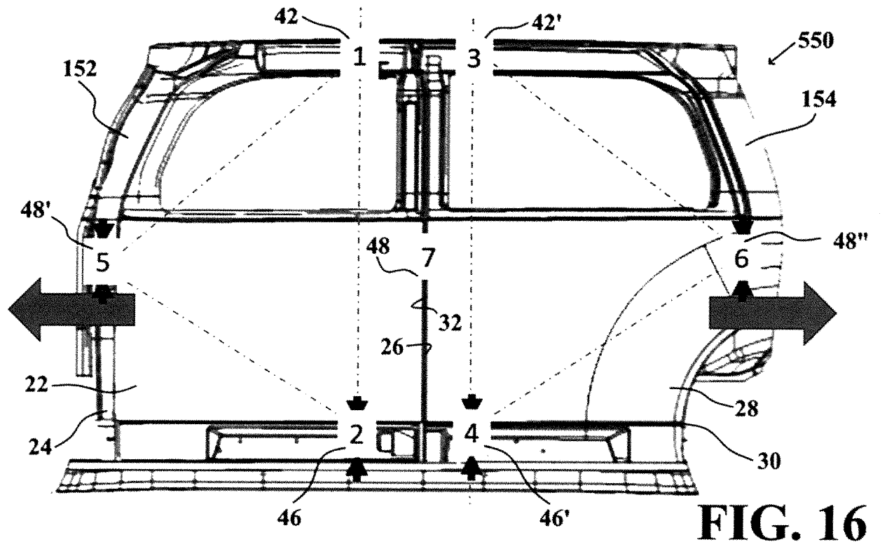

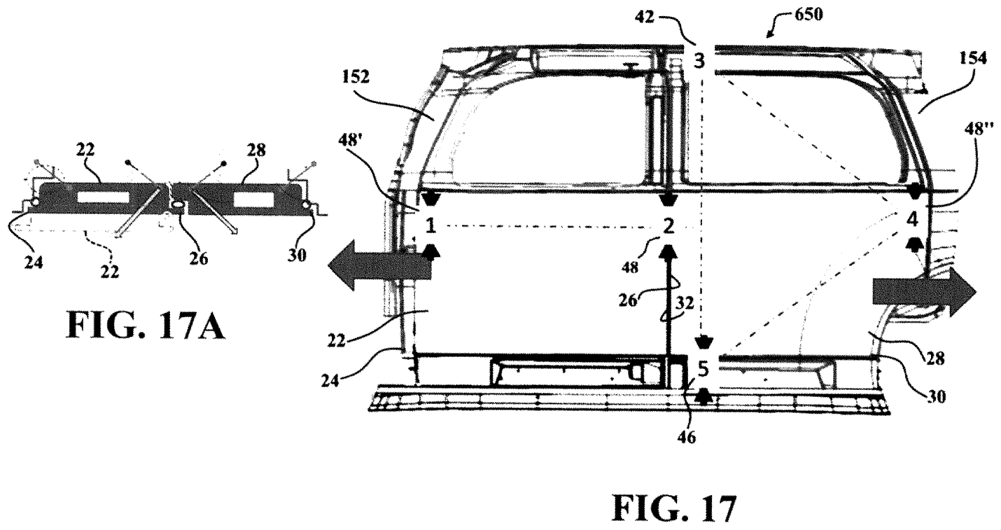

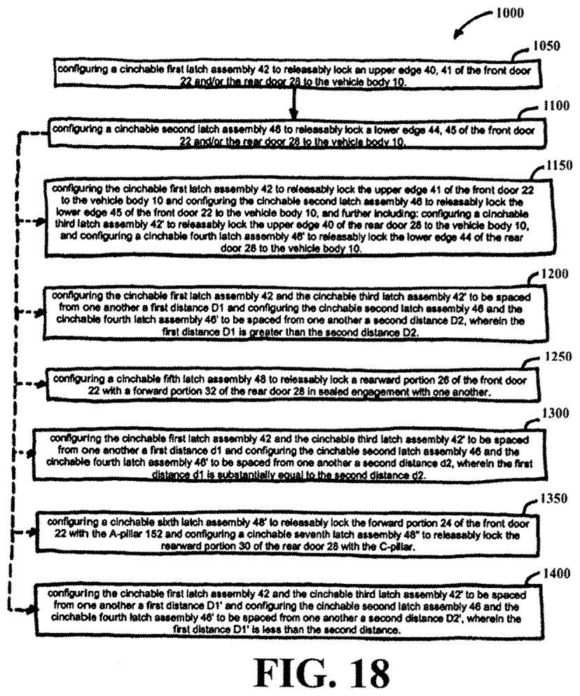

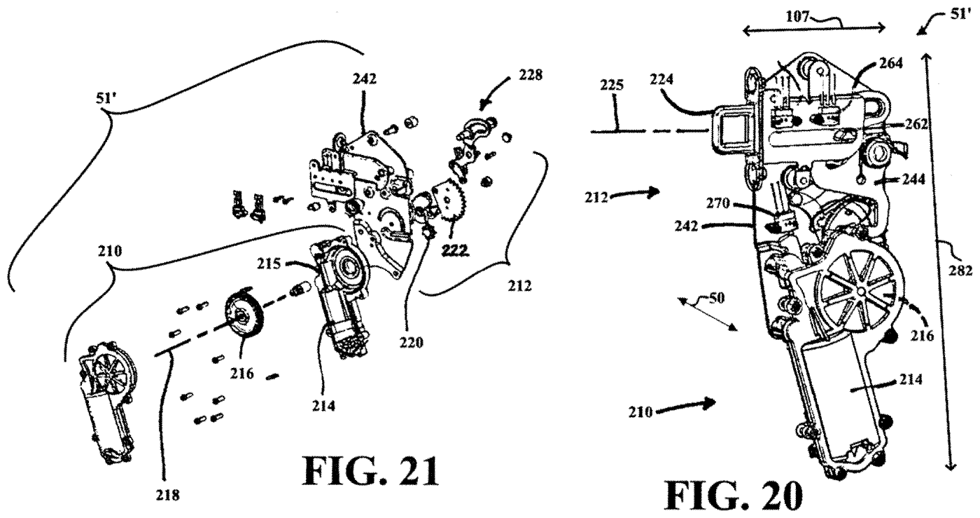

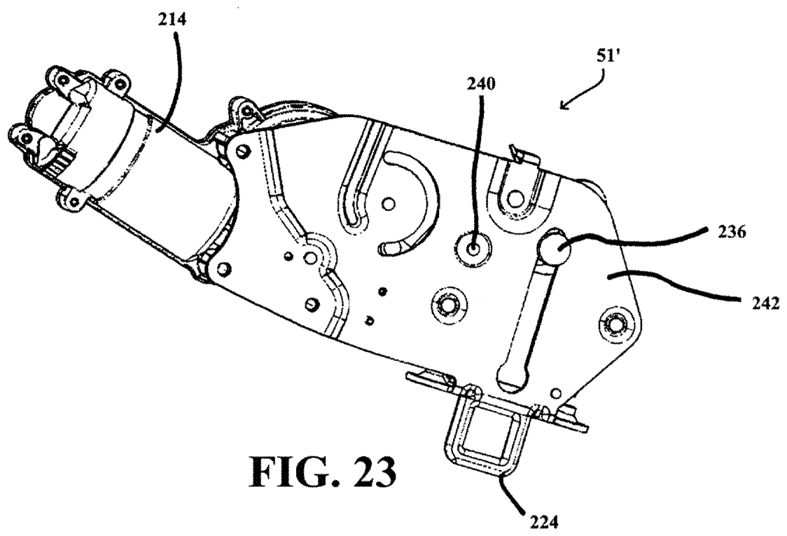

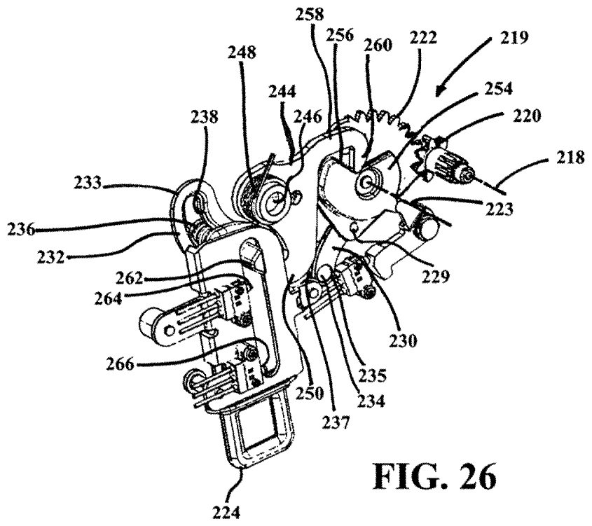

The striker assembly 51′ of closure latch assembly 1042, 1042′, 1046, 1046′, 1048 and components thereof is shown in greater detail in FIGS. 20-27. Striker assembly 51′ includes a power actuator subassembly 210 and a striker subassembly 212. Power actuator subassembly 210 includes a powered actuator, such as an electric motor 214, operably coupled to a drive gear 216, such as via a worm gear 215, such that upon selectively (intentionally energized via a signal from a controller 217 (FIGS. 29-35)) energizing the electric motor 214, worm gear 215 is driven via a motor shaft, thereby causing concurrent rotation of drive gear 216 about a drive gear axis 218 (FIGS. 21 and 26). As drive gear 216 is rotated, a pinion gear 220, operably fixed to drive gear 218 for concurrent rotation therewith about drive gear axis 218, is driven to cause concurrent movement of a driven member, shown as a sector gear 222, about a sector gear axis 223 (FIG. 26). As sector gear 222 is caused to move about sector gear axis 223, a striker 224 of striker assembly 51′ is caused to translate along a striker axis 225 between a home position, also referred to as retracted position, corresponding to a cinched position of door 22, 28, and an extended position, corresponding to a presented position of door 22, 28, discussed in more detail hereafter. Accordingly, electric motor 214 is operably coupled to striker 224, at least in part, by a gear assembly, also referred to as gear train 219, including worm gear 215, drive gear 216, pinion gear 220 and sector gear 222. It is to be recognized that gear train 219 can be configure having more or fewer gears, as desired.

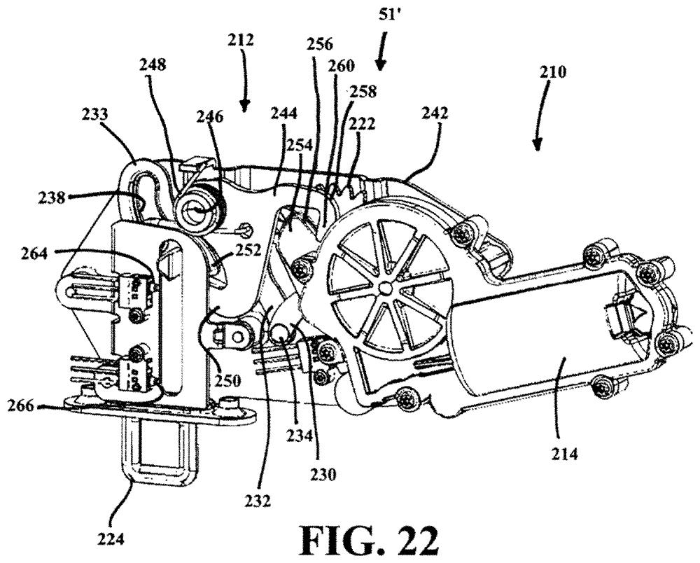

Sector gear 222 has sector teeth 226 configured in meshed engagement with pinion teeth 227 of pinion gear 220. Sector teeth 226 extend along an arc of constant radius relative to sector gear axis 223, such that rotation of pinion gear 220 in a first direction causes sector gear 222 to rotate in a first direction, while rotation of pinion gear 220 in a second direction opposite the first direction causes sector gear 222 to rotate in a second direction opposite the first direction. Accordingly, sector gear 222 is configured to oscillate in the first and second directions in response to rotation of the pinion gear 220 rotating in the first and second directions. Pinion teeth 227 are intended to remain in meshed engagement with sector teeth 226 regardless of the position of striker 224. As sector gear 222 is pivoted in the first direction, as indicated by arrow D1 (FIG. 25), striker 224 is caused to move from its retracted position to its extended position, and as sector gear 222 is pivoted in the second direction, as indicated by arrow D2 (FIG. 25), striker 224 is caused to move from its extended position to its retracted position, with striker 224 shown in its retracted position in FIG. 25.

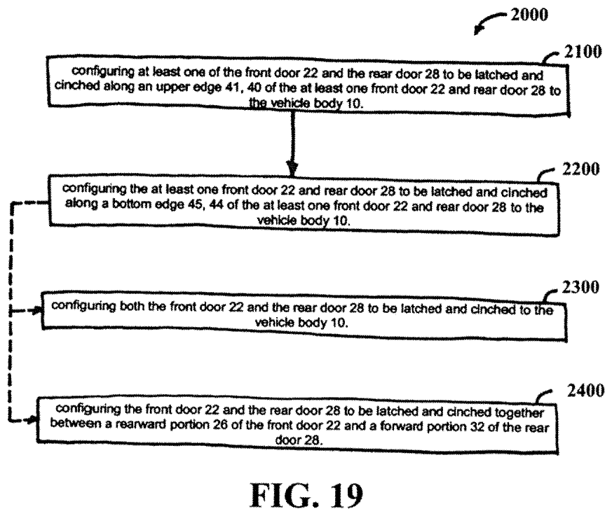

Sector gear 222 is operably coupled to striker 224 via a linkage assembly 228, wherein linkage assembly 228 is configured to convert oscillating movement of sector gear 22 into straight translation of striker 224 between its retracted and extended positions. Linkage assembly 228 is shown, by way of example and without limitation, as having a first link 230 pivotably coupled to sector gear 222 by a pin 229 at a first end 231 of first link 230 and a second link 232 pivotably and slidably coupled to striker 224 by a first end 233 of first link 230. The first link 230 and the second link 232 are pivotally coupled to one another via a pin 234 at respective second ends 235, 237. The second link 232 is coupled with striker 224 for pivotal and slidable movement relative thereto via a pin/slot arrangement, wherein a pin 236 fixed to striker 224 is received with an elongate, arcuate slot 238 formed in second link 232. The second link 232 is fixed for purely pivotal movement, such as via a pin 240, wherein pin 240 can be fixed to a housing member, such as a backplate 242 (FIG. 23). As such, when desired to move striker 224 from its retracted position to its extended position, sector gear 222 is driven counterclockwise by electric motor 214 in the direction of arrow D1 (FIG. 25), whereupon first link 230 is pulled upwardly, thereby causing second link 232 to pivot about pin 240 in a clockwise direction in the direction of arrow R1 by being pulled by first link 230, whereupon pin 236 is cause to traverse through arcuate slot 238 to forcibly drive striker 224 in straight, linear translation of along striker axis 225 from its retracted position to its extended position. Then, when desired to move striker 224 from its extended position to its retracted position, sector gear 222 is driven clockwise by electric motor 214 in the direction of arrow D2 (FIG. 25), whereupon first link 230 is pushed downwardly, thereby causing second link 232 to pivot about pin 240 in a counterclockwise direction in the direction of arrow R2 by being pushed by first link 230, whereupon pin 236 is cause to traverse through arcuate slot 238 to forcibly drive striker 224 in straight, linear translation of along striker axis 225 from its extended position to its retracted position. Accordingly, electric motor 214 is operably coupled to striker 224 by linkage assembly 228 and gear train 219.

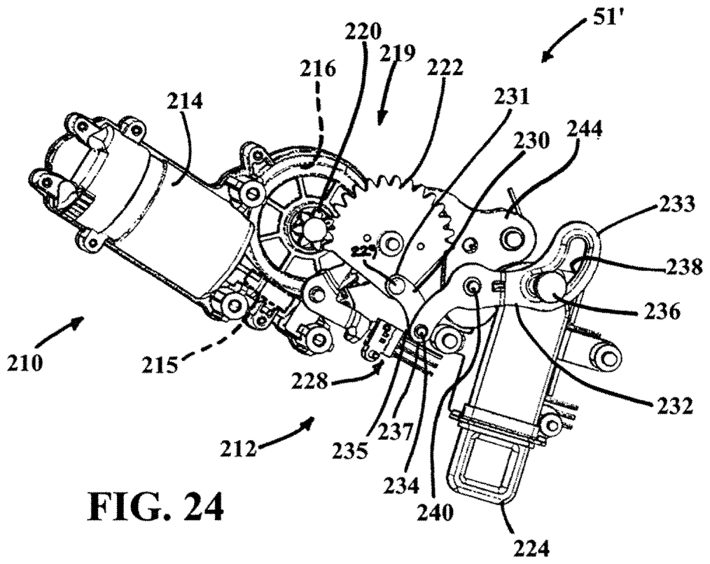

To prevent inadvertent movement of striker 224 from its retracted position to its extended position, a locking lever 244 is configured to obstruct unwanted movement of striker 224 until desired. Locking lever 224 is supported for pivotal movement about a pin 246 in response to selective energization of electric motor 214. Locking lever 244 is biased by a biasing member, shown as a torsion spring 248, toward a locked position (best shown in FIG. 27), whereat a generally J-shaped hook 250 of locking lever 244 is brought into close fitting obstruction with a projection, also referred to as nose 252, of striker 224. As such, when striker 224 is in its retracted position, and electric motor 214 is de-energized, spring member 248 biases hook 250 into blocking relation with nose 252 such that striker 224 is prevented from moving from its retracted position toward its extended position, thereby assuring door 22, 28 remains in its closed position. Then, to open door 22, 28, a signal is sent to controller 217, such as via key fob 253 or door handle 50, whereupon electric motor 214 is energized to drive sector gear 222 in a clockwise direction in the direction of arrow D1, as viewed in FIG. 27, via pinion gear 220. As sector gear 222 rotates, a cam member 254, fixed to sector gear 222, rotates conjointly with sector gear 222 to drive locking lever 244 in a counterclockwise direction in a direction of arrow r1 (FIG. 27). Cam member 254 has a cam surface 256 that engages a driven nose 260 of an arm 258 of cam locking lever 244, with arm 258 shown as being generally L-shaped, wherein driven nose 260 slides along cam surface 256 as cam member 254 is rotated, thereby causing locking lever 244 to be rotated against the bias of spring member 248 to an unlocked position, whereat hook 250 is pivoted out from blocking engagement with nose 252, thereby allowing striker 224 to translate along the striker axis 225 in response to being driven by link assembly 228. Accordingly, cam member 254 is configured in operable communication with the locking lever 244, via cam surface 256, to move the locking lever 244 between the locked position, whereat the locking lever 244 maintains the striker 224 in the retracted position, and the unlocked position, whereat the striker 224 is free to move to the extended position.

As striker 224 translates along striker axis 225, a datum, also referred to as sensor indicator 262, fixed to striker 224 interacts with at least one, and shown as a retracted sensor, also referred to as first sensor 264, and an extended sensor, also referred to as second sensor 266. Sensor indicator 262 is shown, by way of example and without limitation, as a protrusion fixed to and extending laterally outwardly from striker 224, while first and second sensors 264, 266 are fixed to a striker guide plate 268 having a guide slot 270 configured for sliding receipt of sensor indicator 262 therein. Sensor guide plate 268, as best shown in FIG. 20, is configure for fixed attachment to backplate 242, wherein striker 224 is configured to translate relative to fixed backplate 242 and striker guide plate 268. Guide slot 270 facilitates straight translation of striker 242 between its retracted and extended positions. First sensor 264 is configured in electrical communication with controller 217 to indicate when striker 224 is in the retracted position, while second sensor 266 is configured in electrical communication with controller 217 to indicate when striker 224 is in the extended position. A sector gear sensor 270 is fixed to backplate 242 to sense the position of sector gear 222. A toggle 272 has a first leg 273 biased into pivotal engagement with cam member 254 via a biasing member 274 for sliding movement into engagement with a lug 276 on cam member 254 and a second leg 275 configured to detection by sector gear sensor 270. When lug engages first leg 273, second leg 275 is biased pivotally against the bias of biasing member 274 into alignment with sector gear sensor 270, whereat sector gear sensor 270 signals controller 271 to indicate the striker 224 being in the retracted position. When lug disengages first leg 273 as sector gear 222 is rotated clockwise, as viewed in FIG. 27, second leg 275 is biased pivotally by the bias of biasing member 274 out of alignment with sector gear sensor 270, whereat sector gear sensor 270 signals controller 271 to indicate the sector gear 222 being rotated to a deployed position.

FIGS. 29-35 illustrate schematic overhead views of pillarless door system 34′ with front and rear doors 22, 28 shown in various positions, discussed in more detail hereafter. Pillarless door system 34′ can include first, and/or second and/or third closure latch assembly 1042, 1042′, 1046, 1046′, 1048, with overhead view illustrating upper closure latch assembly 1042, 1042′, which includes latch mechanism 54 and striker assembly 51′, with system 34′ further including controller 217 and a power source, such as a vehicle battery (Vbatt), by way of example and without limitation.

In FIG. 29, front and rear doors 22, 28 are shown in their open positions, while strikers 224 of striker assemblies 51′ are shown in their retracted positions. While in their retracted positions, strikers 224 have a low or non-existent outwardly extending profile, thereby reducing or negating any possibility of getting caught on or hit by a vehicle occupant.

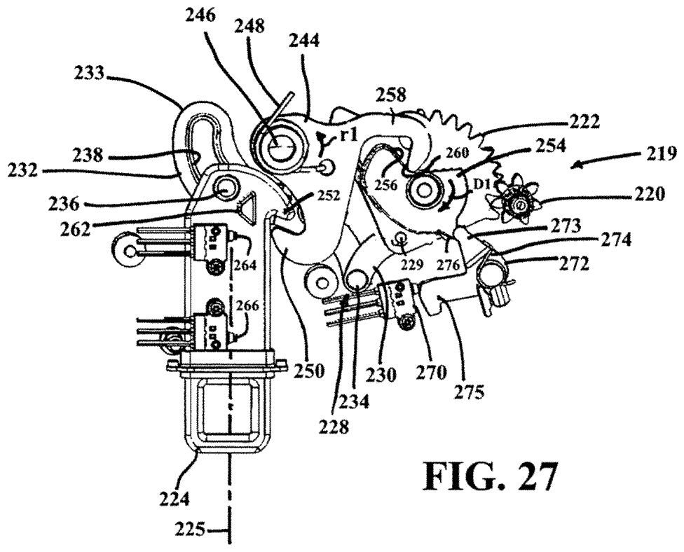

In FIG. 30, rear door 28 is shown in its fully closed, cinched position, while front door 22 is shown being moved from the open position toward the closed position. Further illustrated is striker 224 of striker assembly 51′ in its extended position. Striker 224 can be moved from its retracted position, along striker axis 225, to its extended position via energizing electric motor 214 via power source Vbatt, whereupon drive gear 216 rotates and causes pinion gear 220 to drive sector gear 222 counterclockwise (FIG. 25) in the direction of arrow D1, thereby causing linkage assembly 228 to bias striker 224 along striker axis 225 to its extended position. To initiate extension of striker 224, the electric motor 214 can be selectively energized upon controller 217 receiving a signal, such as from key fob 253 or an associated door handle 50, by way of example and without limitation. Upon striker 224 reaching its extended position, sensor 266 senses striker 224 in the extended position and signals controller 217 to de-energize electric motor 214.

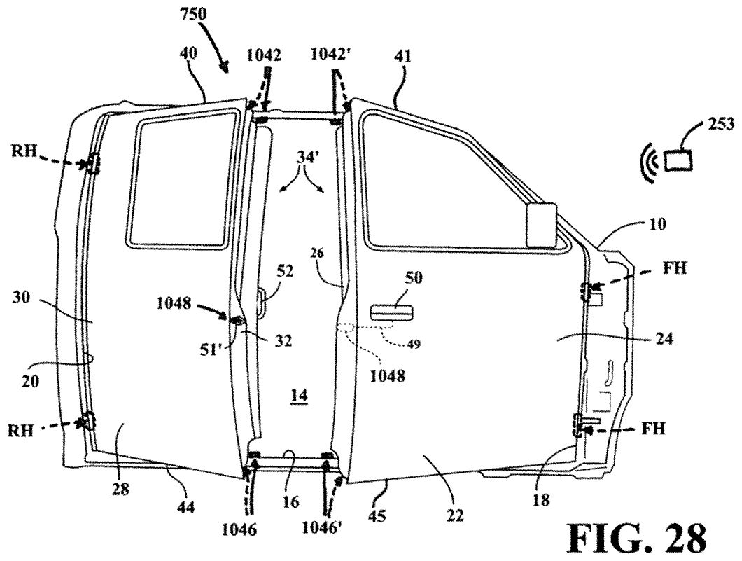

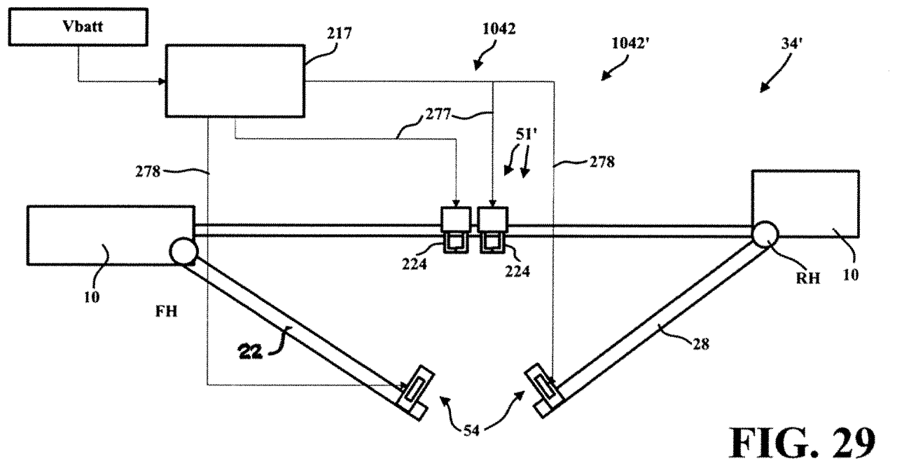

With striker 224 in its extended position, ratchet 64 of latch mechanism 54 can move to a striker capture position with striker 224, whereat latch mechanism 54 is in a primary latched position and front door 22 is in a partially open position (FIG. 31). While in this position, controller 217 can energize electric motor 214 to return striker 224 from its extended positon to its retraced position, thereby acting to cinch front door 22 to the fully closed position. During cinching, drive gear 216 causes sector gear 22 to rotate clockwise (FIG. 25) in the direction of arrow D2, thereby causing second link 232 to rotate in the direction of arrow R2, whereupon striker 224 is translated along striker axis 225 to its retracted position (FIG. 32). Upon striker 224 reaching its retracted position, sensor 264 senses striker 224 in the retracted position and signals controller 217 to de-energize electric motor 214.

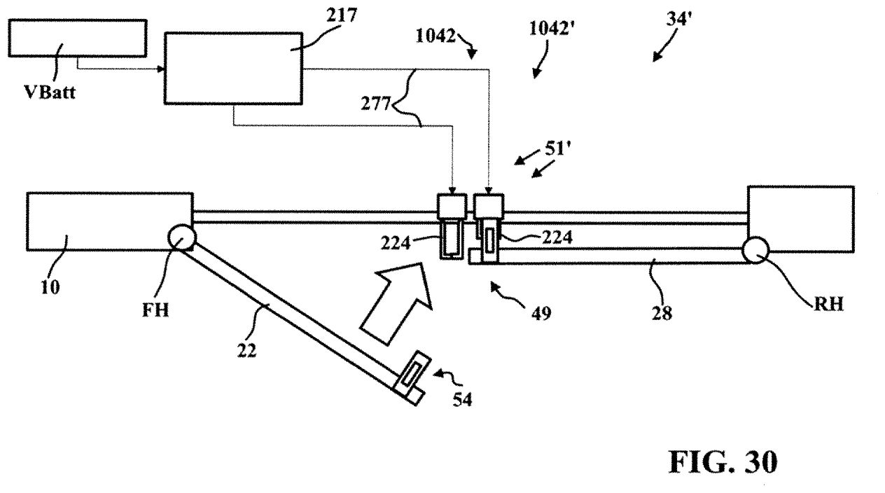

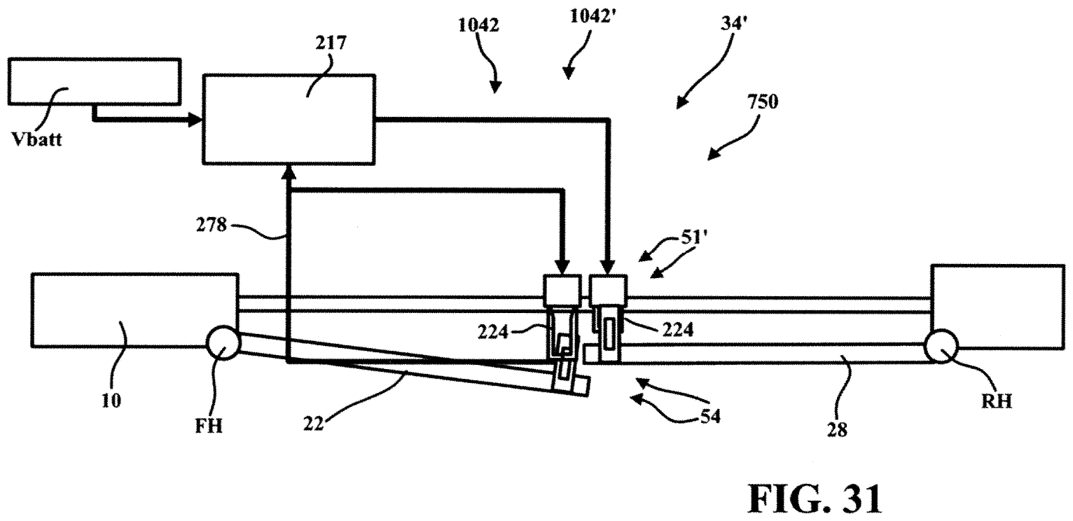

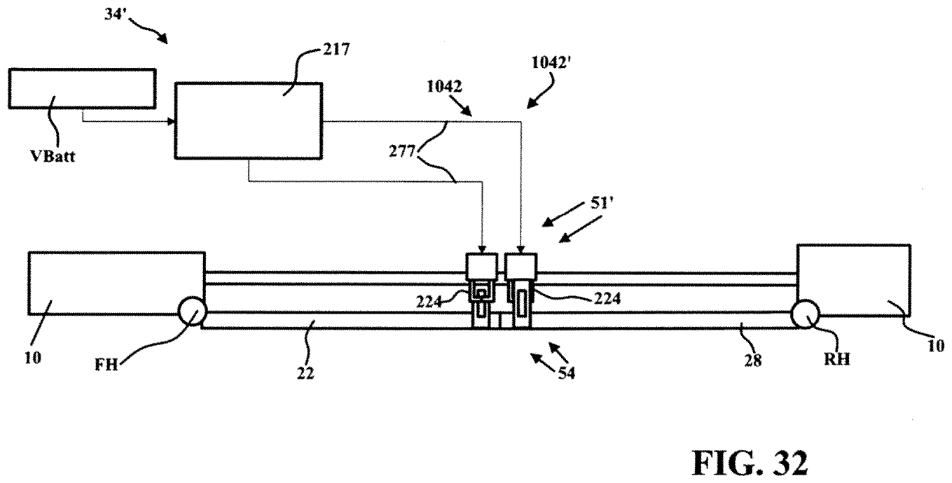

In FIG. 33, controller 217 receives a door open/unlock signal from one of key fob 253 or an inside/outside door handle, and electric motor 214 is energized via receiving a signal via an electrical member 277 from controller 217 to move striker 224 from its retracted position to its extended position via associated movement of drive gear 216, pinion gear 220, sector gear 222, and linkage assembly 228. As striker 224 moves from the retracted position toward the extended position, latch mechanism 54 remains in its latched position, with ratchet 64 remaining in its striker capture position. Accordingly, when striker 224 is moved to its extended position, front door 22 is moved to a partially opened, presented position (FIG. 34; it is to be recognized that the same applies equally to rear door 28, with front door 22 being described and shown merely as an example). Then, when desired, a suitable command can be sent from controller 217, configured in electrical communication via electrical member 278 with latch mechanism 54, to cause ratchet 64 to move to its striker release position, such as via sensing a user having manual control of front door 22 via a pressure strip 36′ configured in electrical communication via an electrical member 280 or via further actuation of key fob 253 or door handle, for example, whereat front door 22 can then be moved from the presented position to the fully open position (FIG. 35). As such, striker subassembly 212 and latch mechanism 54 are configured in operable communication with one another via controller 217, such that controller 217 is able selectively cause latch mechanism 54 to move between latched and unlatched positions in response to the position of striker subassembly 212. For example, upon the striker 224 being moved to the extended position, the controller 217 may automatically move latch mechanism 54 to its unlatched position, or it may wait until a subsequent signal is received from key fob 253 or door handle. Further, upon latch mechanism 54 being moved to its latched position with striker 224 while striker 224 is in its extended position, the controller 217 may automatically move striker 224 from the extended position to its retracted position to cinch door 22 to its fully closed position, or it may wait until a subsequent signal is received from key fob 253, pressure strip 36′ or door handle.

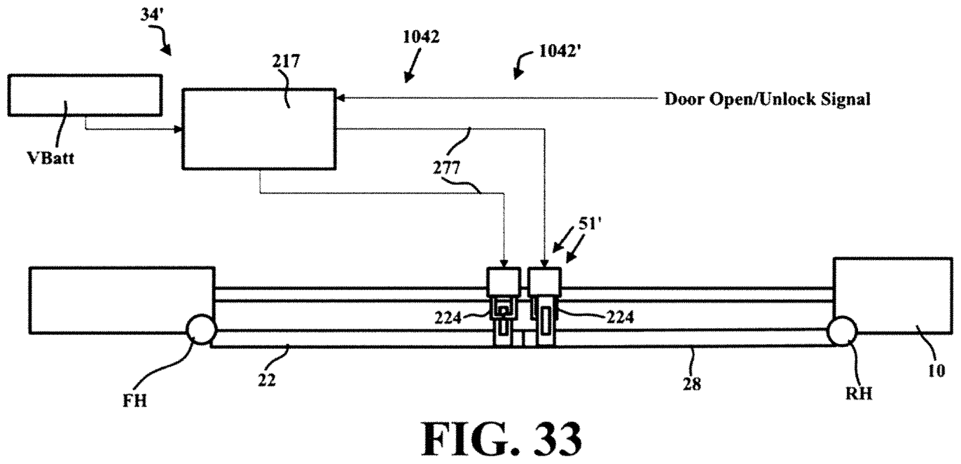

In FIG. 36, a flow diagram illustrating a method 3000 of moving a closure panel 22, 28 from a fully closed position to a presented, partially opened position, and then, from the presented, partially opened position to a fully open position is shown. The method 3000 includes a step 3100 detecting a door open signal. The door open signal can be sent from a variety of activation sources, including key fob 253, door handle, button or the like, wherein door open signal is received by controller 217. Then, a step 3200 includes controlling powered striker assembly 51′ to move door 22, 28 from the closed position to a partially opened position (presented position). The controlling of striker assembly 51′ includes energizing electric motor 214 and driving linkage assembly 228 via drive gear 216, pinion 220 and sector gear 222, thereby causing striker 224 to move from the retracted position to the extended position, whereupon door 22, 28 moves via being releasably coupled with striker 224 via ratchet 64 of latch mechanism 54. Then, a step 3300 includes detecting powered striker assembly 51′ being in its fully extended position. Detection can be facilitated via one or more sensors 266, 270 detecting a position of striker 224 and/or sector gear 222, respectively, with sensors 266, 270 being configured in electrical communication with controller 217. Then, a step 3400 includes detecting a door open signal. Door open signal can be sent to controller 217 via key fob 253, door handle, button, pressure strip 36′, or the like, whereupon controller 217 communicates with latch mechanism 64. Then, step 3500 includes releasing latch mechanism 54 from latched engagement with striker 224. The releasing includes moving ratchet 64 from one of its primary or secondary striker capture positions to its striker release position.

FIG. 37 is a view similar to FIG. 34, illustrating a front door 22′ and a rear door 28′ of a B-pillarless dual-door closure system 34′ having overlapping front and rear edges 282, 284, respectively, with the front door 22′ shown in a presented, partially opened position and the rear door 28′ being moved toward a fully open position in accordance with another aspect of the disclosure. In this arrangement, front door 22′ can first be presented by moving striker 224 from the retracted position to the extended position, with ratchet 64 of latch mechanism 54 remaining in one of its primary or secondary striker capture positions, thereby allowing the rear edge 284 to pass freely by the front edge 282, and thus, allowing rear door 28′ to be freely moved from its fully closed position to its fully open position without having to fully open front door 22′. Otherwise, operation of front and rear doors 22′, 28′ is the same as that discussed above for front and rear doors 22, 28 of FIGS. 29-35, and thus, further discussion is believed unnecessary.

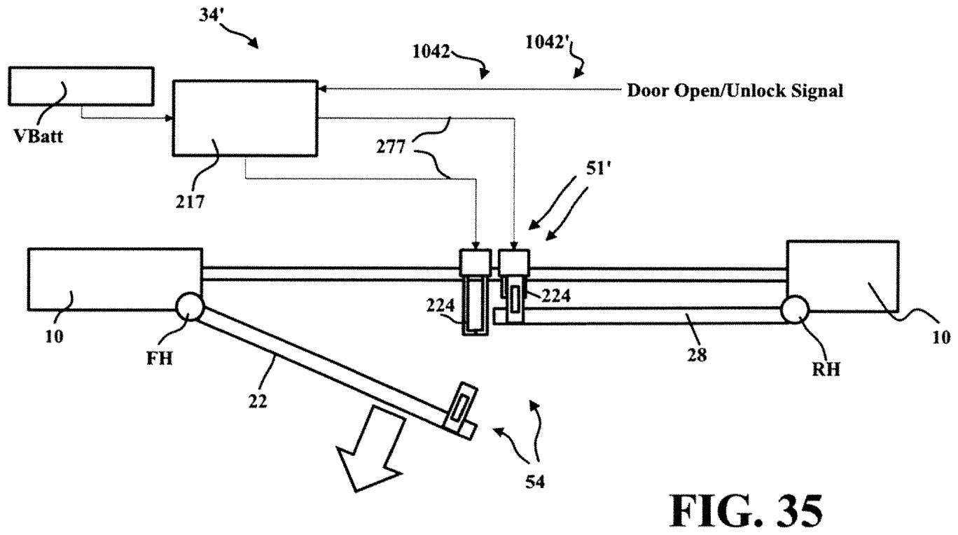

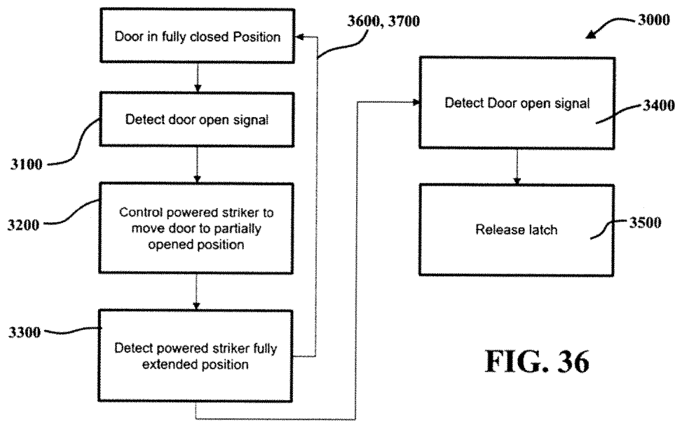

FIG. 38 illustrates a schematic side view, and FIGS. 39-44 illustrate schematic overhead views of a pillarless door latch system 850 with front and rear doors 322, 328 configured similarly as discussed above for pillarless door latch system 150-650 of FIGS. 12A-17. Rather than front and rear doors 322, 328 being pivotably attached to vehicle body, as discussed above for front and rear doors 22, 28 of pillarless door latch system 750 of FIGS. 29-35, front and rear doors 322, 328 are coupled to vehicle body 10 for movement along an X-axis extending along a length of the motor vehicle 11 and along a Y-axis extending along a width of the motor vehicle 11. No further discussion is believed necessary with regard to the movement of front and rear doors 322, 328 in view of the discussion above for front and rear doors 22, 28 of FIGS. 12A-17. FIGS. 39-44 show doors 322, 328 in various positions, discussed in more detail hereafter. Pillarless door latch system 850 can include first, and/or second and/or third closure latch assembly 1042, 1042′, 1046, 1046′, 1048, with overhead views illustrating door-to-door closure latch assembly 1048 coupling front and rear doors 322, 328 to one another, which includes latch mechanism 54 and striker assembly 51′, with system 850 further including controller 217.

In FIG. 39, striker assembly 51′ is shown with striker 224 thereof in its retracted position with ratchet of latch mechanism 54 in its primary striker capture position. As such, front and rear doors 322, 328 are in their fully closed, cinched relation with one another, with a door-to-door (D2D) seal 36 compressed in sealed relation therebetween.

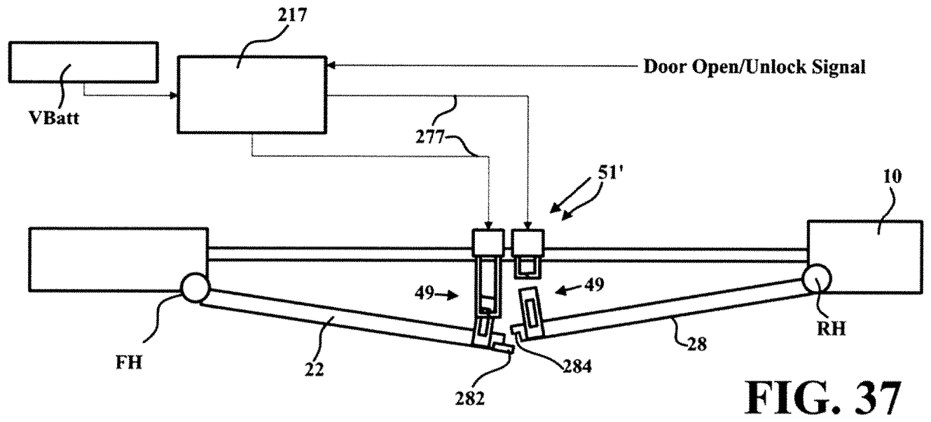

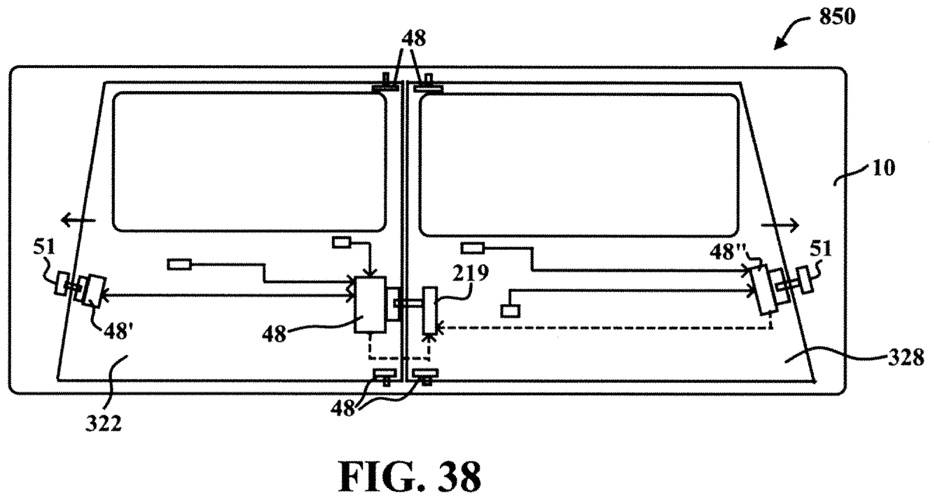

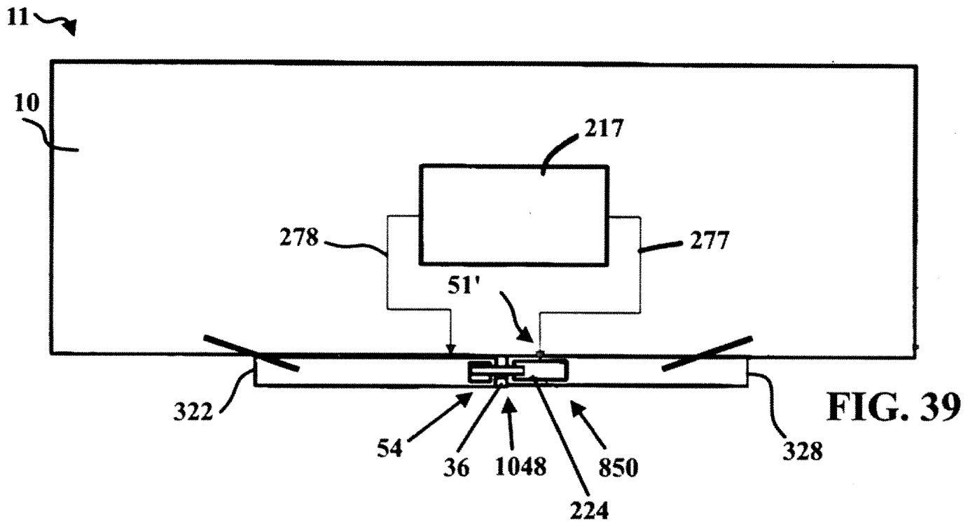

In FIG. 40, an initial step of opening door 322, 328 is shown, wherein controller 217 receives a door open/unlock signal from one of key fob 253 or an inside/outside door handle, and electric motor 214 is energized to move striker 224 from its retracted position to its extended position via associated movement of drive gear 216, pinion gear 220, sector gear 222, and linkage assembly 228. As striker 224 moves from the retracted position toward the extended position, latch mechanism 54 remains in its latched position, with ratchet 64 remaining in its striker capture position. Accordingly, when striker 224 is moved to its extended position, front door 22 is translated along the X-axis (direction) to a partially opened, presented position, whereat D2D seal 36 is permitted to slowly expand to a slightly decompressed state, thereby avoiding a “popping” noise that might otherwise occur if doors 322, 328 were suddenly moved to an open position. Then, when desired, a suitable command can be sent from controller 217, configured in electrical communication via electrical member 278 with latch mechanism 54, to cause ratchet 64 to move to its striker release position (FIG. 41), such as via further actuation of key fob 253 or door handle, for example, whereat front door 322 can then be moved from the presented position to the fully open position along the X-direction (FIG. 42). While signaling ratchet 64 to move to its striker release position, a signal can also be sent to striker assembly 51′ via electrical member 277 to cause striker 224 to return to its retracted position, thereby acting to conceal striker 224, as discussed above.

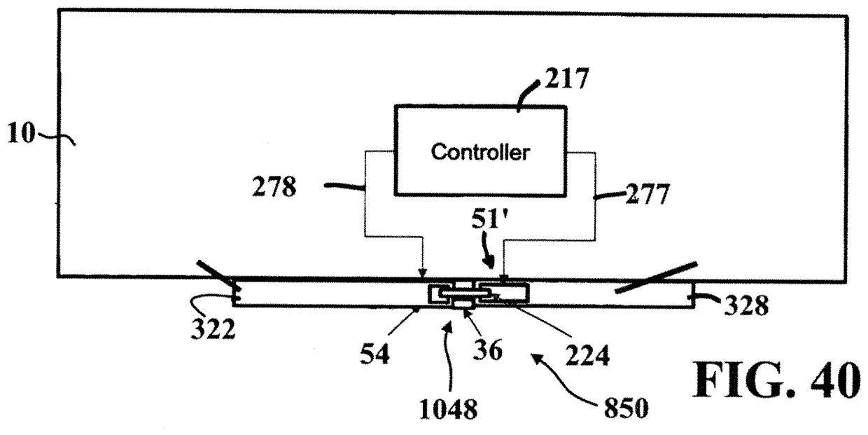

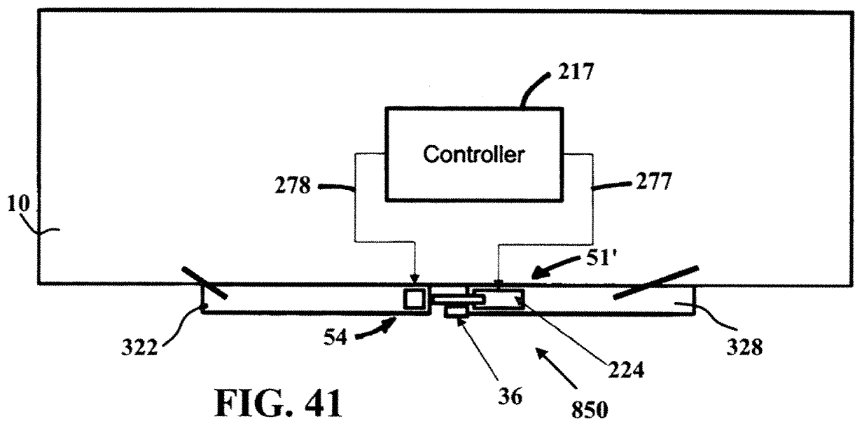

In FIG. 43, door 322 is shown returned to a closed, but uncinched position, whereat striker 224 is captured by ratchet 64 in a primary striker capture position. Then, in FIG. 44, a signal has been sent from controller 217 to striker assembly 51′ to cause striker 224 to move from its extended position to its retracted position, thereby cinching the doors 322, 328 together along the direction X and causing seal 36 to be compressed in sealed relation between doors 322, 328.

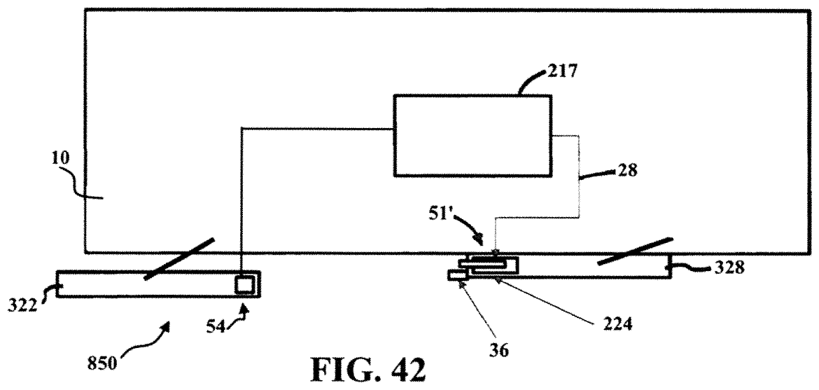

In FIG. 45, a flow diagram illustrating a method 4000 of cinching a closure panel 322, 328 to a fully closed, cinched position is shown. The method 4000 includes a step 4100 of detecting a latch mechanism 54 in a closed position, whereat striker 224 of powered striker assembly 51′ is captured by a ratchet 64 of latch mechanism 54. Then, a step 4200 includes moving striker 224 to its fully retracted position, thereby causing doors 322, 328 to be cinched together. Then, a step 4300 includes detecting striker 224 being in its fully retracted position. Detection can be performed by configuring a sensor 264 to detect the striker 224 being in its fully retracted position and/or a sensor 270 to detect the position of sector gear 222. Then, a step 4400 includes disabling the powered striker assembly 51′.

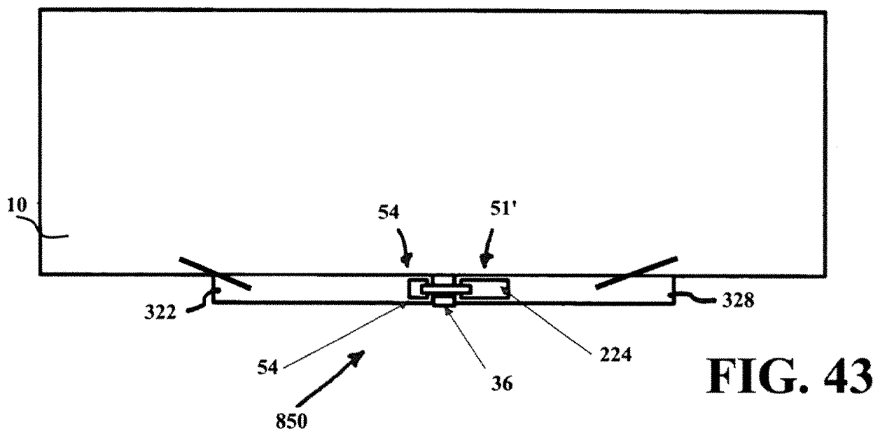

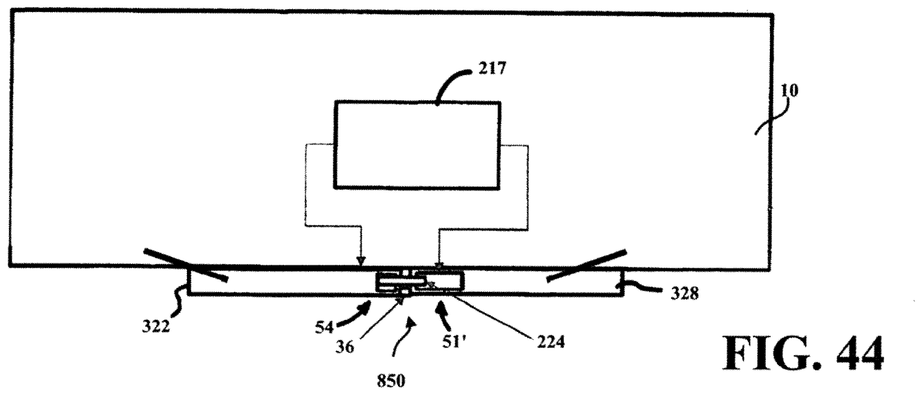

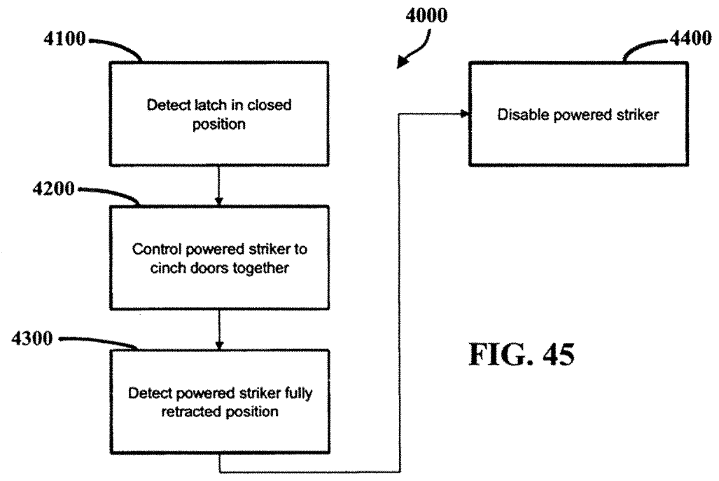

Referring to FIGS. 46-48, for a vehicle 610 with a passive entry feature, a person 631 may approach the vehicle 610 with an electronic key fob 632 and actuate (i.e. pull) an outside door handle 34 or command unlatching through the key fob 632. For example, a single command from the key fob 632 can be used for unlatching a driver's side front door 664 (i.e., the driver's door). Consequently, a latch assembly 638 associated with the driver's side front door 664 actuates the power release function to release the latch mechanism of the latch assembly 638 and unlatch for opening the driver's side front door 664. A second or subsequent command from the key fob 632 can be used for unlatching the remaining doors for passengers 633 (e.g., driver's side rear door 674, passenger's side front door 666 opposite the driver's side front door 664, and the passenger's side rear door 676 opposite the driver's side rear door 674) as shown in FIG. 48. So, all of the doors 664, 666, 674, 676 are unlocked by the second command from the key fob 632, even if the person 631 only wants to unlock the driver's side rear door 674. Thus, such operation can allow security issues on the opposite side of the vehicle 610 (e.g., an intruder could gain unauthorized entry to the vehicle 610 through the passenger's side front door 666 and/or the passenger's side rear door 676 following the second command from the key fob 632).

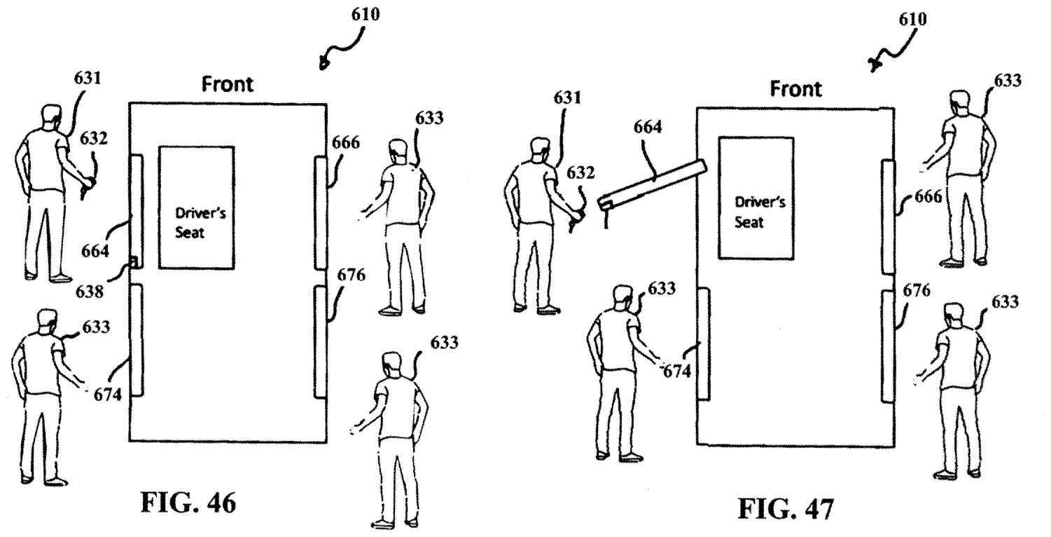

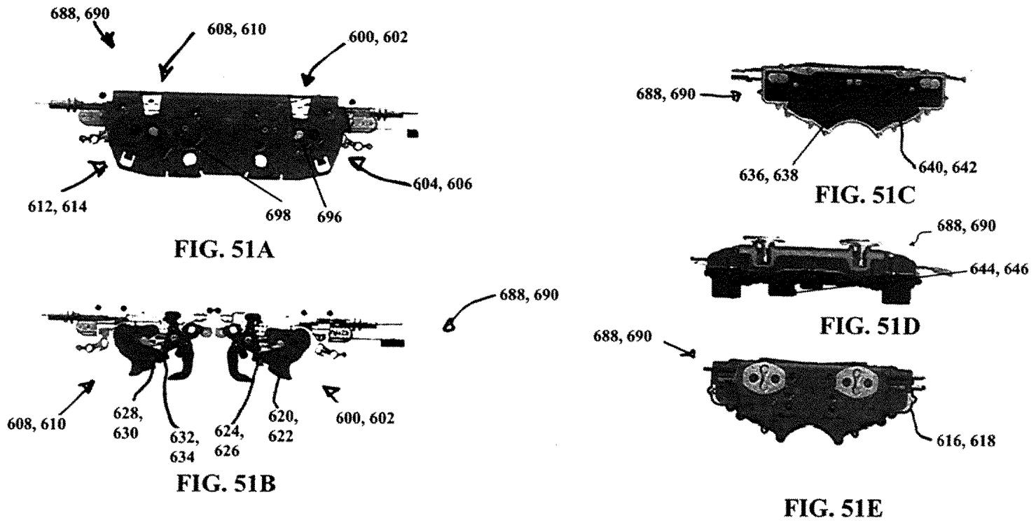

Referring initially to FIG. 49, example motor vehicle 610 is shown to include a vehicle body 611 having an exterior 613 and an interior 614 defining a passenger compartment. Connecting exterior 613 and interior 614 of vehicle body 611 is a continuous or “pillar-less” side opening 616 defining a first or front terminal end 618 and a second or rear terminal end 620. Providing a first moveable closure member for a front portion of opening 616 is a second front door 666 opposite a first front door 664 (FIGS. 53A-53D) and having a forward portion 390 pivotably connected via upper and lower passenger front hinges 670, 672 to vehicle body 611 adjacent to front terminal end 618 of opening 616. Second front door 666 has a rearward portion 394 generally opposite its pivotal connection to vehicle body 611. Providing a second moveable closure member for a rear portion of opening 616 is a second rear door 676 opposite a first rear door 674 (FIGS. 53A-53D). Second rear door 676 has a rearward portion 398 which is pivotably connected via upper and lower passenger rear hinges 680, 682 to vehicle body 611 adjacent to rear terminal end 620 of opening 616 and has a forward portion 396 generally opposite to its pivotal connection. When second front door 666 and second rear door 676 are closed together, the extreme end of rearward portion 394 of second front door 666 may or may not overlap the extreme end of forward portion 396 of second rear door 676. So, the first front door 664 and the first rear door 674 are disposed on a first side of the motor vehicle 610 and the second front door 666 and the second rear door 676 are disposed on a second side of the motor vehicle 610 opposite the first side.

A latch assembly 688, 690 (FIG. 49A) can also be part of the dual door pillar-less door or closure system 686. Still referring to FIG. 49, a second side latch assembly 690 for the closure system 686 is attached to the vehicle body 611 (e.g., along a lower portion of opening 616) for latching the first closure member (e.g., second front door 666) and the second closure member (e.g., second rear door 676). The opposite or first side of the vehicle 610 similarly includes a first side latch assembly 688 for latching the first front door 664 and first rear door 674.

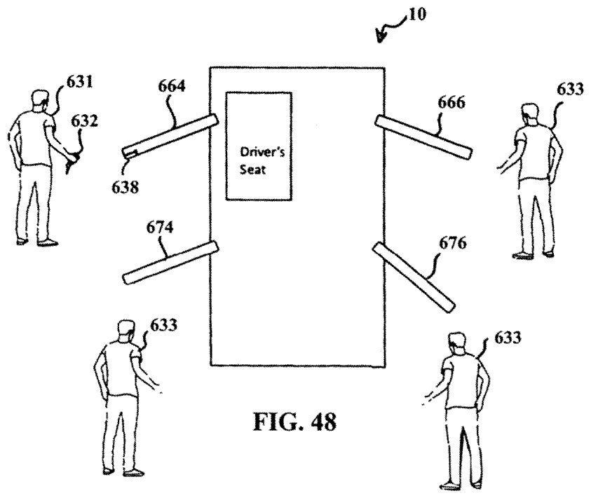

Operation of second side latch assembly 690, for example, is best shown in FIGS. 50A-50D. The first and second closure members (e.g., second front door 666 and second rear door 676) each respectively include strikers 692, 694 attached thereto that are independently received by second primary and second secondary fish-mouths 696, 698 of the second side latch assembly 690. First side latch assembly 688 provides similar operation for first front door 664 and first rear door 674. Both latch assemblies 688, 690 allow one or both closure members (e.g., second front door 666 and second rear door 676) to open and close independently.

Those skilled in the art will recognize that the particular location of the latch assemblies 688, 690, for example, as shown for second side latch assembly 690 is merely intended to illustrate one exemplary dual-door latching arrangement and is not intended to limit the present disclosure. Furthermore, the first side and second side latch assemblies 688, 690 may be employed in other automotive latching configurations, such as a hood latch, a cargo door latch, a decklid latch, a glass latch, a sliding door latch, an auxiliary latch, an emergency release latch, a seat latch, a liftgate latch, a tailgate latch, and the like. Likewise, the type of latch release mechanism employed is not relevant to the inventive concepts associated with the present disclosure and those skilled in the art will appreciate that any known power latch release mechanism can be associated with each of the latch assemblies 688, 690. Dual-door systems may also include sliding door systems, tailgate systems, access hatch systems, or other ingress/egress systems.

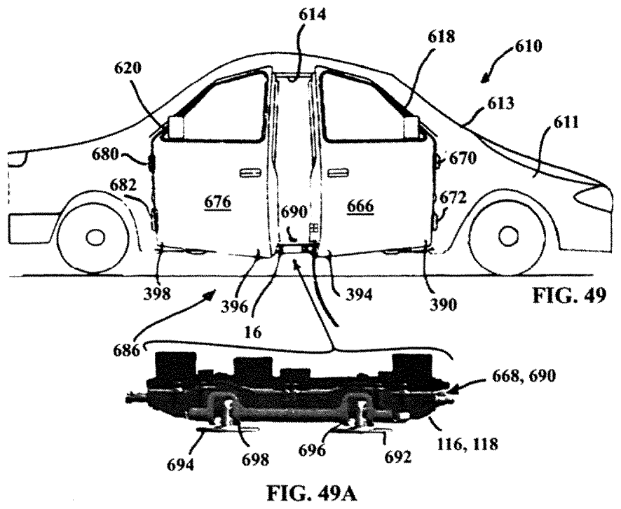

Referring now to FIGS. 51A-51E, each latch assembly 688, 690 includes a primary latch mechanism 600, 602 for the first closure member (e.g., first front door 664 or second front door 666) that has a primary actuation group 604, 606 operable to control actuation of the first closure member. In addition, each latch assembly 688, 690 includes a secondary latch mechanism 608, 610 for the second closure member (e.g., first rear door 674 or second rear door 676) that has a secondary actuation group 612, 614 operable to control actuation of the second closure member. For the first side latch assembly 688, a first primary latch mechanism 600, a first primary actuation group 604, a first secondary latch mechanism 608 and first secondary actuation group 612 are all integrated into a single first side housing 616 (FIG. 51E). Likewise, for the second side latch assembly 690, a second primary latch mechanism 602, a second primary actuation group 606, a second secondary latch mechanism 610 and second secondary actuation group 614 are all integrated into a single first side housing 618 (FIG. 51E).

The primary actuation group 604, 606 of each primary latch mechanism 600, 602 includes a primary ratchet 620, 622 moveable between a striker release position and a striker capture position. A primary pawl 624, 626 is moveable between a ratchet holding position for holding the primary ratchet 620, 622 in its striker capture position and a ratchet releasing position for permitting the primary ratchet 620, 622 to move to its striker release position. The primary actuation group 604, 606 is operable for moving the primary pawl 624, 626 between its ratchet holding position and its ratchet release position. Similarly, the secondary actuation group 612, 614 of the secondary latch mechanism 608, 610 includes a secondary ratchet 628, 630 moveable between a striker release position and a striker capture position. A secondary pawl 632, 634 is moveable between a ratchet holding position for holding the secondary ratchet 628, 630 in its striker capture position and a ratchet releasing position for permitting the secondary ratchet 628, 630 to move to its striker release position. The secondary actuation group 612, 614 is operable for moving the secondary pawl 632, 634 between its ratchet holding position and its ratchet release position.

Each latch assembly 688, 690 additionally includes a controller unit 636, 638 that is also integrated into the housing 616, 618 (e.g., mounted to a printed circuit board 640, 642 having a connector 644, 646 extending from the housing 616, 618 as shown in FIG. 51C). One example of a latch assembly having an integrated controller positioned within the housing of the latch assembly, for example embodied as a microprocessor and supporting circuitry mounted to a printed circuit board, is described in U.S. Pat. No. 10,329,807 entitled “Electrical vehicle latch” for example and without limitation, which is incorporated by reference in its entirety. The controller unit 636, 638 is coupled to the primary and secondary actuation groups 604, 606, 612, 614 and is configured to determine which of the primary actuation group 604, 606 and the secondary actuation group 612, 614 to actuate. The controller unit 636, 638 controls actuation of at least one of the primary actuation group 604, 606 and the secondary actuation group 612, 614 accordingly.

In more detail, the first side latch assembly 688 has a first side controller unit 636 coupled to the first primary and first secondary actuation groups 604, 612 and is configured to control actuation of at least one of the first primary actuation group 604 and the first secondary actuation group 612. The second side latch assembly 690 additionally includes a second side controller unit 638 in communication with the first side controller unit 636 and coupled to the second primary and second secondary actuation groups 606, 614 and configured to control actuation of at least one of the second primary actuation group 606 and the second secondary actuation group 614.

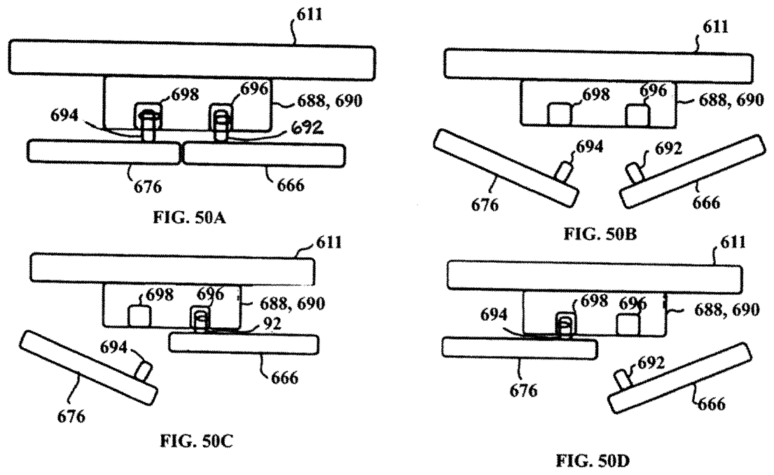

Referring now to FIG. 52, the latch assembly 688, 690 of the door system 686 is electrically connected to a main power source 648 of the motor vehicle 610, for example a main battery providing a battery voltage Vbatt of 12 volts, through an electrical connection element, for example a power cable (the main power source 648 may equally include a different source of electrical energy within the motor vehicle 610, for example an alternator). Each actuation group 604, 606, 612, 616 includes an electric motor (not shown), operable to control actuation of the closure member while using power from the main power source 648. Each pawl 624, 626, 632, 634 is driven by the respective electric motor so as to move between an engaged position and a non-engaged position.

Each latch assembly 688, 690 is controlled by an electronic control circuit 650, 652 that includes the controller units 636, 638. In more detail, each controller unit 636, 638 comprises a microcontroller, microprocessor or analogous computing module 636a, 638a and an embedded memory 636b, 638b, for example a non-volatile or random access memory, coupled to the computing module 636a, 638a, storing suitable programs and computer instructions (for example in the form of a firmware). It is recognized that the controller unit 636, 638 may alternatively comprise a logical circuit of discrete components to carry out the functions of the computing module 636a, 638a and memory 636b, 638b. So, the electronic control circuit 650, 652 is coupled to the electric motor of each actuation group 604, 606, 612, 616 and provides driving signals thereto.

The electronic control circuit 650, 652 is electrically coupled to a vehicle main management unit (also known as main BCM or “body control module”) 654, which is configured to control general operation of the motor vehicle 610, via a data bus 656, so as to exchange signals, data, commands and/or information.

Moreover, as also shown in FIG. 52, the electronic control circuit 650, 652 is (directly, and/or indirectly via the vehicle management unit 654) coupled to several different sensors 658 (shown schematically) of the motor vehicle 610, such as: handle-reading sensors or switches 658a (which read actuation of external and/or internal handles of the closure members), crash sensors 658b, lock switch sensors 658c, and the like; conveniently, the electronic control circuit 650, 652 also receives feedback information about the latch actuation from position sensors 658d, such as Hall sensors, configured to detect the operating position, for example of the ratchet 620, 622, 628, 630 and/or pawl 624, 626, 632, 634.

The electronic control circuit 650, 652 is also coupled to the main power source 648 of the motor vehicle 610, so as to receive the battery voltage Vbatt; the electronic control circuit 650, 652 is thus able to check if the value of the battery voltage Vbatt decreases below a predetermined threshold value, to promptly determine if an emergency condition (when a backup energy source may be needed) occurs.

Each electronic control circuit 650, 652 includes an embedded and integrated backup energy source 660, which is configured to supply electrical energy to the actuation group 604, 606, 612, 616 and latch electric motor, and to the same electronic control circuit 650, 652, in case of a failure or interruption of the main power supply from the main power source 648 of the motor vehicle 610.

According to an aspect of the present solution, the backup energy source 660 includes a group of low voltage supercapacitors 662 (hereinafter supercap group 662), as an energy supply unit (or energy tank) to provide power backup to the latch assembly 88, 90, even in case of power failures. Supercapacitors may include electrolytic double layer capacitors, pseudocapacitors or a combination thereof.

Supercapacitors advantageously provide high energy density, high output current capability and have no memory effects; moreover, supercapacitors have small size and are easy to integrate, have extended temperature range, long lifetime and may withstand a very high number of charging cycles. Supercapacitors are not toxic and do not entail explosive or fire risks, thus being suited for hazardous conditions, such as for automotive applications.

The backup energy source 660 further includes a charge module 664′, an equalization module 665, and a boost module 666′. The charge module 664′ is electrically coupled to the supercap group 662 and is configured to recharge, starting from the battery voltage Vbatt, whenever power from the main power source 648 is available, the supercap group 662, so that the same supercap group 662 may offer a full energy storage for emergency situations and any leakage currents are compensated.

The equalization module 665 is electrically coupled to the supercap group 662, and is configured to ensure that supercapacitor cells have a desired cell voltage value, in particular a same cell voltage value during operation (to achieve a balanced operating condition). The equalization module 665 also avoids that supercapacitor cells have a cell voltage over a maximum desired cell voltage level, protecting the supercapacitors against overcharging.

The boost module 666′ receives at its input the supercap voltage Vsc generated by the supercap group 662, and is configured to boost, that is to increase, its value up to automotive standard voltages (for example 9 V-16 V), and to provide enough output current capability to drive standard automotive electric motors, such as the electric motor of the latch assembly 688, 690. Indeed, the supercap voltage Vsc may be too low to provide an effective back-up power source to directly drive the electric motor in emergency situations, like lost or insufficient power supply from main power source 648 of the motor vehicle 610.

The boost module 666′ thus provides at its output (that is also the output of the backup energy source 660) a boosted voltage Vboost, as a function of the supercap voltage Vsc. The boosted voltage Vboost is then received by an output module of the electronic control circuit 650, 652, for example including an integrated H-bridge module 667, whose output drives the electric motor of the latch assembly 688, 690.

The backup energy source 660 further includes a diagnostic module 668, which is operatively coupled to the supercap group 662 and is configured to monitor the health status of the supercapacitors during the charging process and based on the same charging process, by measuring their voltage value, capacitance value, and internal equivalent resistance (DCR—Direct Current Resistance), for example.

A temperature sensor 669 is configured to monitor the operating temperature of the supercap group 662, and it is coupled to the diagnostic module 668 to provide the detected temperature information; for example, temperature sensor 669 may include an NTC (Negative Temperature Coefficient) resistor arranged in the proximity of the supercap group 662.

The diagnostic module 668 is operatively coupled to the controller unit 636, 638, to provide diagnostic information thereto, for example including the value of the supercap voltage Vsc. In a possible embodiment, not shown, the diagnostic module 628 may be implemented in the controller unit 636, 638, as a diagnostic routine run by the microprocessor or microcontroller thereof.

The latch assembly 688, 690 can further include a switching unit 670 coupled to the controller unit 636, 638 (e.g., to an output of the H-bridge module 667) and to the primary and secondary actuation groups 604, 606, 612, 616. Thus, the controller unit 636, 638 is further configured to control the switching unit 670 to actuate and control actuation of the at least one of the primary actuation group 604, 612 and the secondary actuation group 606, 614.

Operation of the door system 686 is shown in FIGS. 53A-53D. So, the controller unit 636, 638 is configured to receive at least one closure member opening command from an input source selected from the group consisting of a handle switch 658a, a body control module 654, and a key fob 632. In more detail, only the controller unit 636, 638 that is on the same side of the vehicle 610 as the person 631 with the key fob 632 (or the side in which the person 631 pulls a handle of the door 664, 666, 674, 676 to activate the handle switch 658a) is configured to act on the at least one closure member opening command from the input source. So, as shown in FIG. 53A, the person 631 is on the first side of the vehicle 610, therefore, the first side controller unit 636 controls actuation of both of the first front door 664 and the first rear door 674 on the first side of the vehicle 610, while the second front door 666 and second rear door 676 remain locked or latched as shown in FIG. 53B. Similarly, as shown in FIG. 53C, the person 631 is on the second side of the vehicle 610 opposite the first side. Thus, the second side controller unit 638 controls actuation of both of the second front door 666 and the second rear door 676 on the second side of the vehicle 610, while the first front door 664 and first rear door 674 remain locked or latched.

Now referring to FIG. 53D, the controller unit 636, 638 is also configured to determine whether the at least one closure member opening command from the input source includes two closure member opening commands. The controller unit 636, 638 then controls the actuation of both of the first front door 64 and the first rear door 674 on the first side using the first side controller unit 636 or both of the second front door 666 and the second rear door 676 using the second side controller unit 638 on the second side and communicates an opposite side open command to one of the first side controller unit 636 and the second side controller unit 638 in response to determining the at least one closure member opening command from the input source includes two closure member opening commands. The second side controller unit 638 then controls the actuation of both of the second front door 666 and the second rear door 676 in response to receiving the opposite side open command from the first side controller unit 636.

Referring back to FIG. 52, the door system 686 can additionally include a plurality of obstacle detection sensors 672 in communication with the first side controller unit 636 and the second side controller unit 638. The plurality of obstacle detection sensors 672 are configured to detect an object or a gesture adjacent the first front door 664 and the first rear door 674 and the second front door 666 and the second rear door 676.

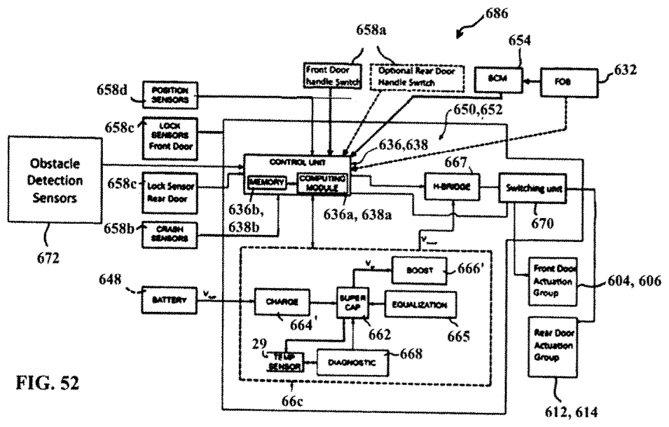

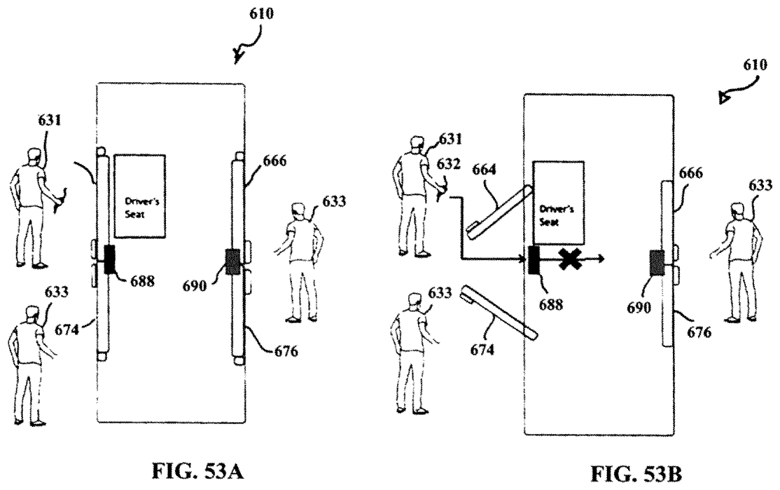

As shown in FIGS. 54 and 55, each of the first front door 664, the first rear door 674, the second front door 666, and the second rear door 676 can include more than one of the obstacle detection sensors 672. Specifically in FIG. 54, the obstacle detection sensors 672 in each door 664, 666, 674, 676 communicate over the bus 656 with a central sensor control unit 674 powered by a power source 676. The central sensor control unit 674 is additionally connected to a liquid crystal display (LCD) 678 and communicates with the key fob 632 via a wireless interface 680. Each door 664, 666, 674, 676 also includes a motor 681 used for powered movement of the door 664, 666, 674, 676. Alternatively, in FIG. 54 the obstacle detection sensors 672 in each door 664, 666, 674, 676 communicate with door sensor control units 682 which then communicate over the bus 656. The body control module 654 is powered by the power source 676. The body control module 654 is additionally connected to the liquid crystal display (LCD) 678 and communicates with the key fob 632 via the wireless interface 680. Again, each door 664, 666, 674, 676 also includes the motor 681 used for powered movement of the door 64, 66, 74, 76.

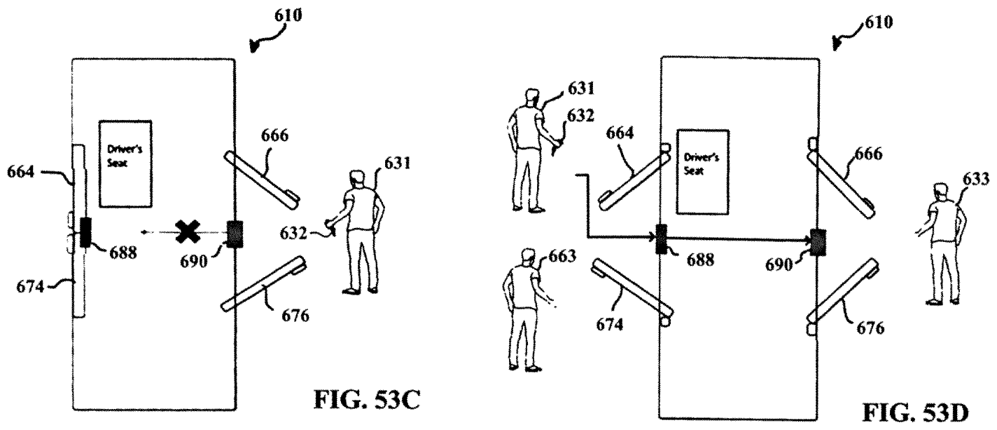

Consequently, as best shown in FIGS. 56A-56D, the first side controller unit 636 is further configured to adjust the control of the actuation of the at least one of the first primary actuation group 604 and the first secondary actuation group 612 based on the detection of the object or the gesture. Similarly, the second side controller unit 638 is further configured to adjust the control of the actuation of the at least one of the second primary actuation group 606 and the second secondary actuation group 614 based on the detection of the object or the gesture.

In more detail, the first side controller unit 636 of the door system 686 is additionally configured to receive at least one closure member opening command from an input source selected from the group consisting of a handle switch 658a, a body control module 654, and a key fob 632. The first side controller unit 636 is also configured to determine whether the object or the gesture is adjacent at least one of the first front door 664 or the first rear door 674. The first side controller unit 636 determines which of the first primary actuation group 604 and the first secondary actuation group 612 to actuate based on the at least one closure member opening command from the input source and whether the object or the gesture is adjacent the at least one of the first front door 664 or the first rear door 674.

Similarly, the second side controller unit 638 is configured to receive the at least one closure member opening command from the input source selected from the group consisting of the handle switch 658a, the body control module 654, and the key fob 632. In addition, the second side controller unit 638 is configured to determine whether the object or the gesture is adjacent at least one of the second front door 666 or the second rear door 676. The second side controller unit 638 then determines which of the second primary actuation group 606 and the second secondary actuation group 614 to actuate based on the at least one closure member opening command from the input source and whether the object or the gesture is adjacent the at least one of the second front door 666 or the second rear door 676.

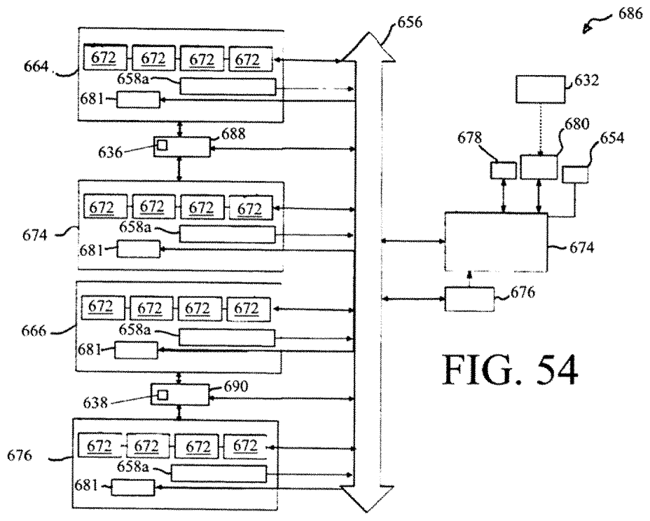

As best shown in FIGS. 57-59, a method of operating a dual door pillar-less door system of a vehicle 610 with a plurality of closure members is also provided. Referring initially to FIG. 57, the method includes the step of 200 receiving at least one closure member opening command from an input source selected from the group consisting of a handle switch 658a, a body control module 654, and a key fob 632. The method continues with the step of 202 determining which of a primary actuation group 604, 606 and a secondary actuation group 612, 614 of at least one latch assembly 688, 690 to actuate. The next step of the method is 204 controlling actuation of at least one of the primary actuation group 604, 606 and the secondary actuation group 612, 614 of the at least one latch assembly 688, 690 based on the determination of which of the primary actuation group 604, 606 and the secondary actuation group 612, 614 to actuate.

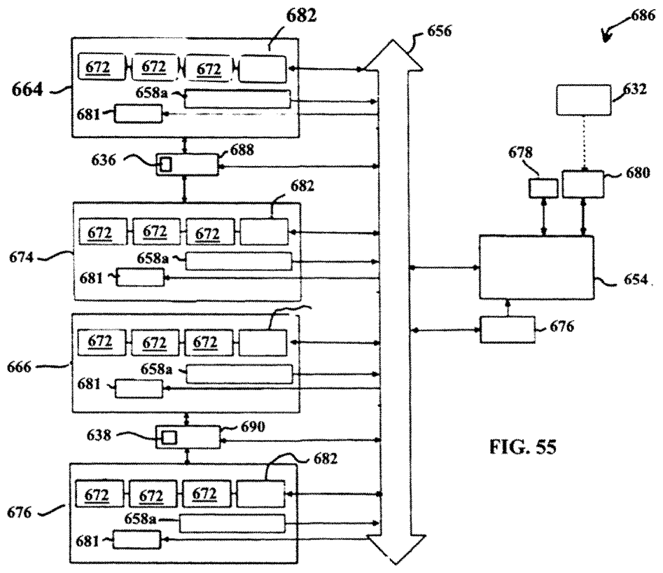

As discussed above, the plurality of closure members can include the first front door 664, the first rear door 674, the second front door 666, and the second rear door 676. The door system 686 can further include the plurality of obstacle detection sensors 672 configured to detect an object or a gesture adjacent the first front door 664 and the first rear door 674 and the second front door 666 and the second rear door 676. Thus, as best shown in FIG. 58, the method further includes the step of 206 detecting the object or the gesture adjacent the first front door 664 and the first rear door 674 and the second front door 666 and the second rear door 676.

Consequently, the method also includes the step of 208 determining whether the at least one closure member opening command from the input source includes one closure member opening command. The method proceeds by 210 controlling the actuation of both of the first front door 664 and the first rear door 674 using a first side controller unit 636 on a first side of the vehicle 610 or both of the second front door 666 and the second rear door 676 using a second side controller unit 638 on a second side of the vehicle 610 opposite the first side based on the detecting the object or the gesture adjacent the first front door 664 and the first rear door 674 and the second front door 666 and the second rear door 676 in response to determining the at least one closure member opening command from the input source includes one closure member opening command. The next step of the method is 212 determining whether the at least one closure member opening command from the input source includes two closure member opening commands. Next, the method continues with the step of 214 controlling the actuation of both of the first front door 664 and the first rear door 674 on the first side using the first side controller unit 636 or both of the second front door 666 and the second rear door 676 using a second side controller unit 638 on the second side and communicating an opposite side open command to one of the first side controller unit 636 and the second side controller unit 638 in response to determining the at least one closure member opening command from the input source includes two closure member opening commands. The method also includes the step of 216 controlling the actuation of both of the second front door 666 and the second rear door 676 using the second side controller unit 638 in response to receiving the opposite side open command from the first side controller unit 636.

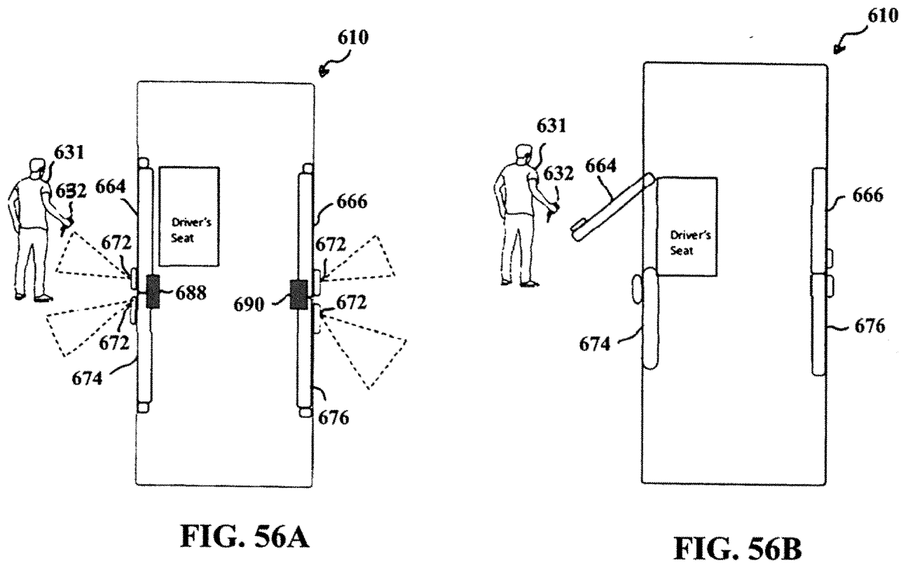

As best shown in FIG. 59 and as indicated above, the method includes the step of 218 determining whether the at least one closure member opening command from the input source includes one closure member opening command. The method proceeds by 220 controlling the actuation of the first front door 664 using a first side controller unit 636 on a first side of the vehicle 610 or actuation of the second front door 666 using a second side controller unit 638 on a second side of the vehicle 610 opposite the first side based on the detecting the object or the gesture adjacent the first front door 664 and the first rear door 674 and the second front door 666 and the second rear door 676 in response to determining the at least one closure member opening command from the input source includes one closure member opening command. The next step of the method is 222 determining whether the at least one closure member opening command from the input source includes two closure member opening commands. Then, the method continues with the step of 224 controlling the actuation of the first front door 664 and the first rear door 674 using the first side controller unit 636 on the first side of the vehicle 610 or the second front door 666 and the second rear door 676 using the second side controller unit 638 on the second side of the vehicle 610 in response to determining the at least one closure member opening command from the input source includes two closure member opening commands. Next, 226 determining whether the at least one closure member opening command from the input source includes three closure member opening commands. The method continues with the step of 228 controlling the actuation of both of the first rear door 674 and the first rear door 674 on the first side of using the first side controller unit 636 or both of the second front door 666 and the second rear door 676 using a second side controller unit 138 on the second side and communicating an opposite side open command to one of the first side controller unit 636 and the second side controller unit 638 in response to determining the at least one closure member opening command from the input source includes three closure member opening commands. The method also includes the step of 230 controlling the actuation of both of the first front door 664 and the first rear door 674 using the first side controller unit 636 or both of the second front door 666 and both of the second rear door 676 using the second side controller unit 638 in response to receiving the opposite side open command from the first side controller unit 636.

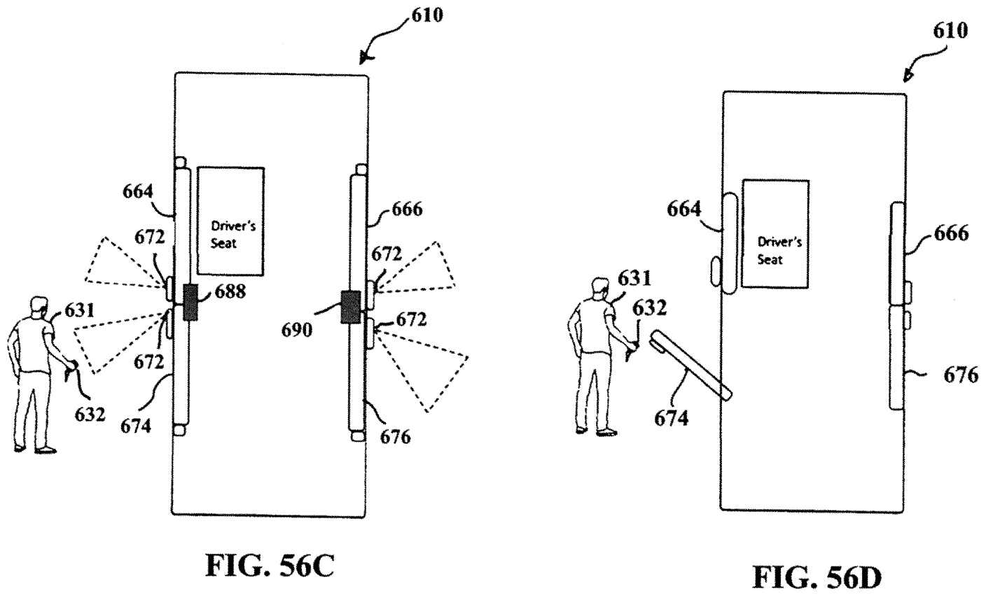

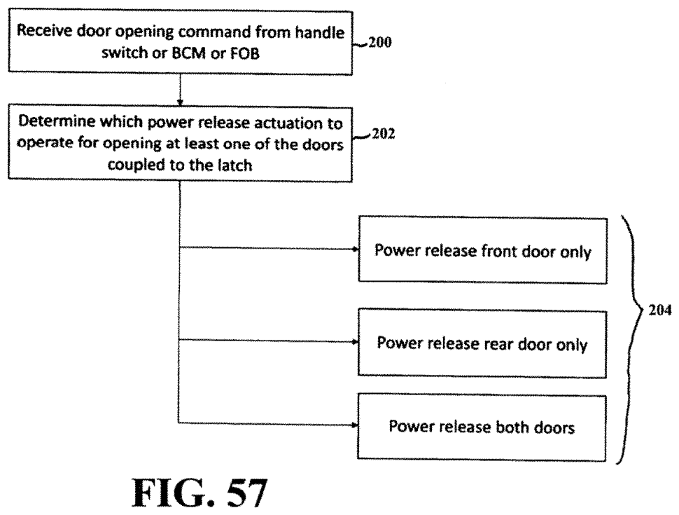

Referring initially to FIGS. 60-62, another motor vehicle 610′ is shown configured as a pickup truck, by way of example and without limitation, wherein the same reference numerals as used above for vehicle 610 are used to identify like features, including a vehicle body 611 (forming a fixed support) having an exterior 613 and an interior 614 defining a passenger compartment. Connecting exterior 613 and interior 614 of vehicle body 611 is a continuous or “pillar-less” (no B-pillar) side opening 616 defining a first or front terminal end 618 of side opening 616 and a second or rear terminal end 620 of side opening 616. Providing a moveable first closure member for a front portion of opening 616 is a first or front door 664, 666 (one on each side of the vehicle) having a forward portion 390 pivotably connected via front hinges (not shown) to vehicle body 611 adjacent to front terminal end 618 of opening 616. Front door 64, 66 has a rearward portion 394 generally opposite its pivotal connection to vehicle body 611. Providing a moveable second closure member for a rear portion of opening 616 is a second or rear door 674, 676 (one on each side of the vehicle). Rear door 674, 676 has a rearward portion 398 which is pivotably connected via rear hinges (not shown) to vehicle body 611 adjacent to rear terminal end 620 of opening 616 and has a forward portion 396 generally opposite to its pivotal connection. When front door 664, 666 and rear door 674, 676 are closed together, the extreme end of rearward portion 394 of front door 664, 666 is latched to the extreme end of forward portion 396 of rear door 674, 676. Accordingly, front door 664, 666 and rear door 674, 676 together define a pillar-less dual-door closure arrangement.

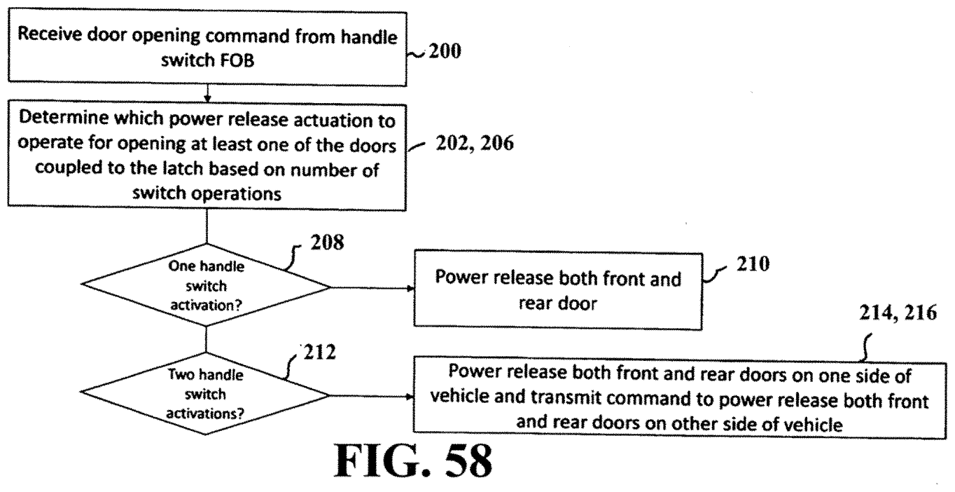

Now referring to FIG. 63, a closure system 300 for first and second closure members 664, 666, 674, 676 of motor vehicle 10 in accordance with one aspect of the disclosure is provided. The closure system 300 includes a retractable striker assembly 302, 302′, 302″, 302′″ attached to one of the first and second closure members 664, 666, 674, 676.

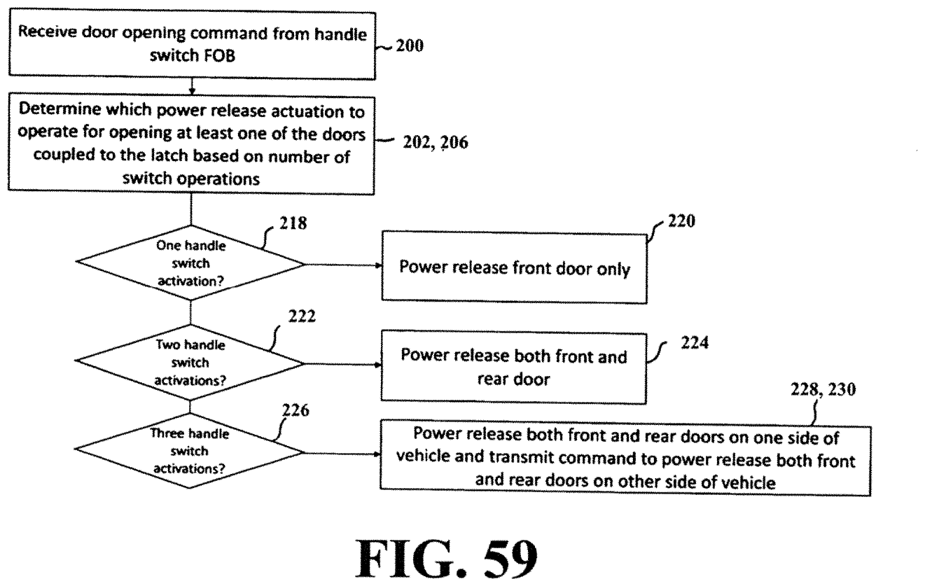

A first embodiment of the retractable striker assembly 302 is best shown in FIGS. 64A-64C. The retractable striker assembly 302 includes a retractable striker 304 being movable by a retractable striker actuator 306 between an extended position and a retracted position. Specifically, the retractable striker actuator 306 includes a retractable striker motor 308 having a motor shaft 310 extending and rotatable about a primary rotation axis 311. A worm 312 attaches to the motor shaft 310 for rotation with the motor shaft 310. The worm 312 engages and is configured to rotate a worm gear 314 about a secondary rotation axis 316 that is transverse to the primary rotation axis 311. The worm gear 314 couples to a scissor mechanism 318 that operably couples with the retractable striker 304 to move the retractable striker 304 along a striker translation axis 320 to the extended position in response to the retractable striker motor 308 being driven in a first direction and moving the retractable striker 304 along the striker translation axis 320 to the retracted position in response to the retractable striker motor 308 being driven in a second direction opposite the first direction.

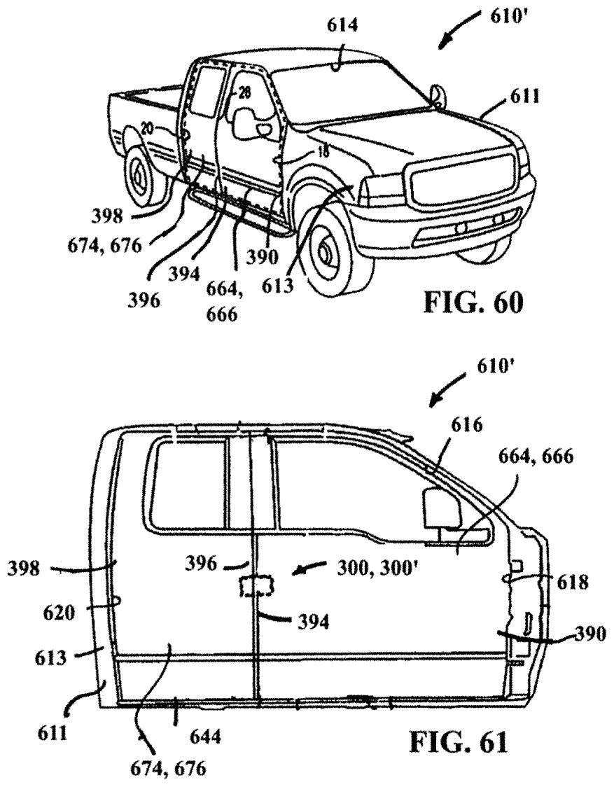

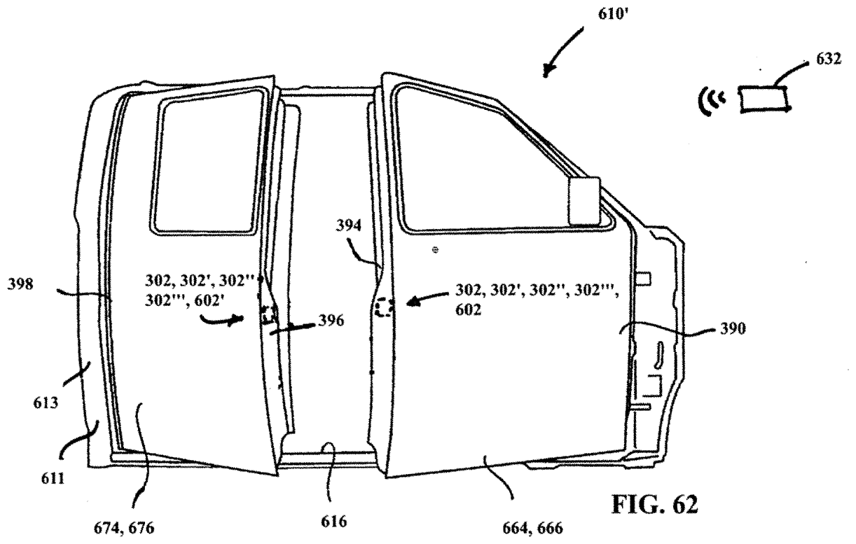

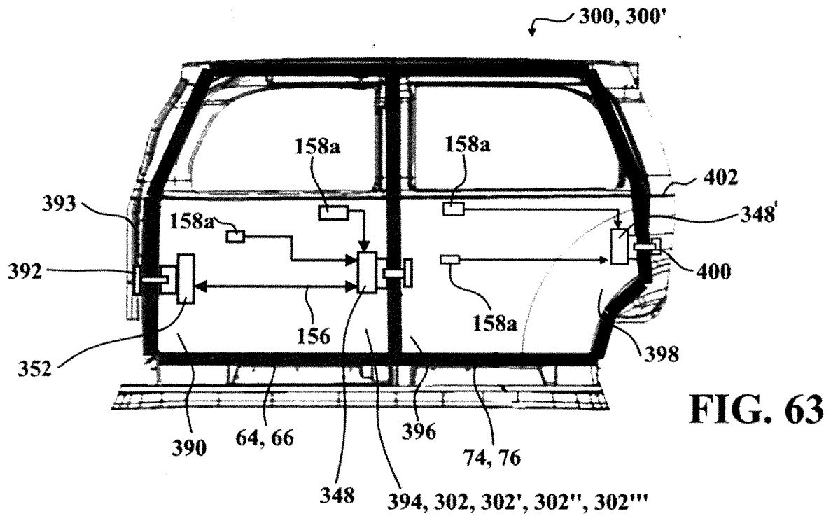

FIGS. 65-67 illustrate additional embodiments of the retractable striker assembly 302′, 302″, 302′″. Specifically, FIG. 65 shows a motor backdrive or second embodiment of the retractable striker assembly 302′ (e.g., 16 parts total), FIG. 66 shows a free with damper or third embodiment of the retractable striker assembly 302″ (e.g., 18 parts total), and FIG. 67 shows a bilateral connection or fourth embodiment of the retractable striker assembly 302′″ (e.g., 16 parts total). With each of the embodiments of the retractable striker assembly 302, 302′, 302″, 302′″, the retractable striker 304 is engaged by another of the first and second closure members 664, 666, 674, 676 in the extended position. In contrast, the retractable striker 304 is disengaged by the another of the first and second closure members 664, 666, 674, 676 in the retracted position.

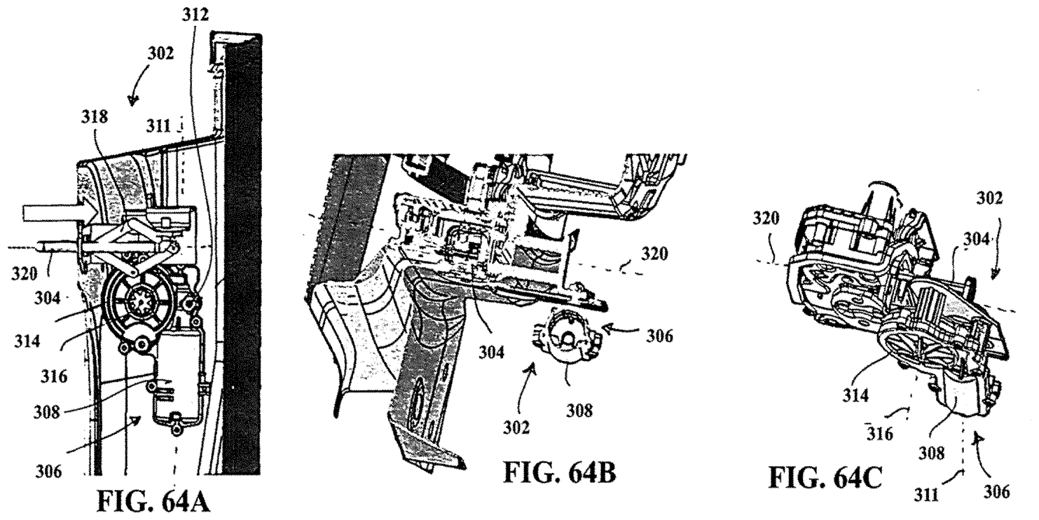

FIGS. 68A-68C show the second embodiment of the retractable striker assembly 302′ of FIG. 65 during its operation. Similar to the first embodiment of the retractable striker assembly 302, the retractable striker actuator 306′ of the second embodiment of the retractable striker assembly 302′ includes the retractable striker motor 308 having the motor shaft 310 extending and rotatable about the primary rotation axis 311. The retractable striker 304 is shown in the retracted position in FIG. 68A. The worm 312 attaches to the motor shaft 310 for rotation with the motor shaft 310. The worm 312 engages and is configured to rotate the worm gear 314 about the secondary rotation axis 316 that is transverse to the primary rotation axis 311. The worm gear 314 is attached to and configured to rotate an oblong cam 322 defining an oblong cam surface 324. As the oblong cam 322 is rotated by the worm gear 314 (ultimately by the retractable striker motor 308), the oblong cam surface 324 engages a roller 326 rotatably attached to a follower 328. Because the follower 328 is also attached to one end of the retractable striker 304, movement of the roller 326 along the oblong cam surface 324 causes the follower 328 and the retractable striker 304 to linearly slide along the striker translation axis 320 that is transverse to both the primary rotation axis 311 and the secondary rotation axis 316. Thus, in the second embodiment of the retractable striker assembly 302′, the follower 328 moves along the striker translation axis 320 at a non-constant rate with a constant speed of the retractable striker motor 308. The retractable striker 304 is shown in the extended position in FIG. 68B and FIG. 68C shows the retractable striker 304 beginning to return back to the retracted position. A plurality of striker return springs 330 are coiled about legs of the retractable striker 304 and captive between the follower 328 and a retractable striker plate 332 from which the retractable striker 304 extends in the extended position. The plurality of striker return springs 330 are configured to maintain the roller 326 in contact with the oblong cam surface 324.

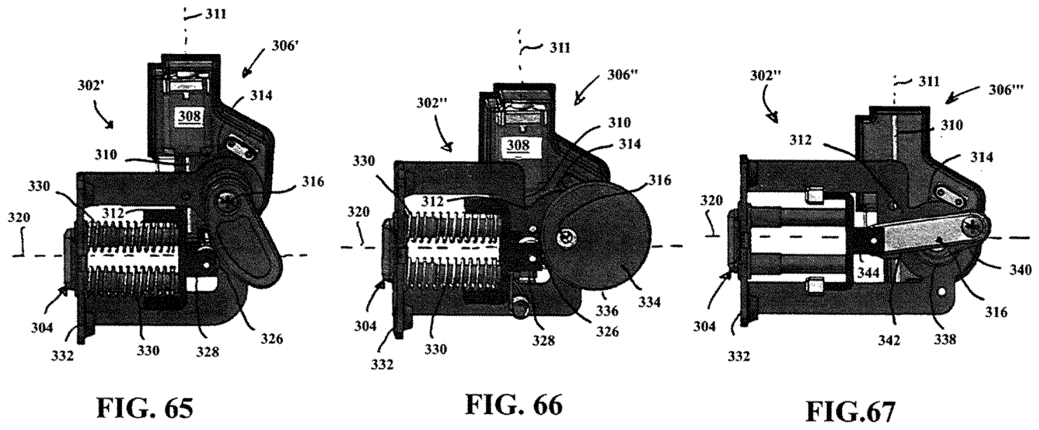

FIGS. 69A-69C show the third embodiment of the retractable striker assembly 302″ of FIG. 66 during its operation. Similar to the first and second embodiments of the retractable striker assembly 302, 302′, the retractable striker actuator 306″ of the second embodiment of the retractable striker assembly 302″ includes the retractable striker motor 308 having the motor shaft 310 extending and rotatable about the primary rotation axis 311. The retractable striker 304 is shown in the retracted position in FIG. 69A. The worm 312 attaches to the motor shaft 310 for rotation with the motor shaft 310. The worm 312 engages and is configured to rotate the worm gear 314 about the secondary rotation axis 316 that is transverse to the primary rotation axis 311. Instead of the oblong cam 322, the worm gear 314 is attached to and configured to rotate an eccentric cam 334 defining an eccentric cam surface 336 in the third embodiment of the retractable striker assembly 302″. As the eccentric cam 334 is rotated by the worm gear 314 (ultimately by the retractable striker motor 308), the eccentric cam surface 336 engages the roller 326 rotatably attached to the follower 328. Since the follower 328 is also attached to one end of the retractable striker 304, movement of the roller 326 along the eccentric cam surface 336 causes the follower 328 and the retractable striker 304 to linearly slide along a striker translation axis 320 that is transverse to both the primary rotation axis 311 and the secondary rotation axis 316. So, in the third embodiment of the retractable striker assembly 302″, the follower 328 moves along the striker translation axis 320 at a constant rate with a constant speed of the retractable striker motor 308. The retractable striker 304 is shown in the extended position in FIG. 69B and FIG. 69C shows the retractable striker 304 beginning to return back to the retracted position. Again, the plurality of striker return springs 330 are coiled about legs of the retractable striker 304 and captive between the follower 328 and the retractable striker plate 332 from which the retractable striker 304 extends in the extended position. Similar to the second embodiment of the retractable striker assembly 302′, the plurality of striker return springs 330 are configured to maintain the roller 326 in contact with the eccentric cam surface 336.

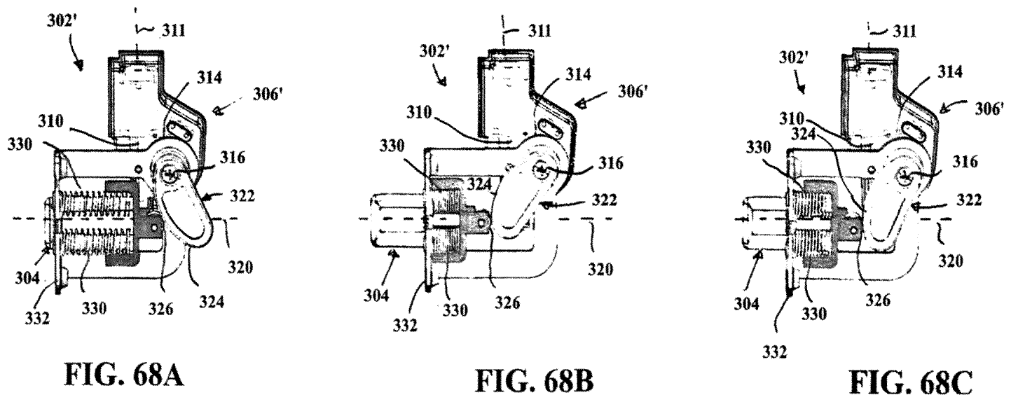

FIGS. 70A-70C show the fourth embodiment of the retractable striker assembly 302′″ of FIG. 67 during its operation. As with the first, second, and third embodiments of the retractable striker assembly 302, 302′, 302″, the retractable striker actuator 306′″ of the fourth embodiment of the retractable striker assembly 302′″ includes the retractable striker motor 308 having the motor shaft 310 extending and rotatable about the primary rotation axis 311. The retractable striker 304 is shown in the retracted position in FIG. 70A. The worm 312 attaches to the motor shaft 310 for rotation with the motor shaft 310. The worm 312 engages and is configured to rotate the worm gear 314 about the secondary rotation axis 316 that is transverse to the primary rotation axis 311. The worm gear 314 is attached to and configured to rotate a crank 338 having a crank arm 340 extending radially therefrom. As the crank 338 is rotated by the worm gear 314 (ultimately by the retractable striker motor 308), the crank arm 340 pushes or pulls a connecting rod 342 rotatably connected thereto. The connecting rod 342 is also rotatably connected to a slider 344 that is also attached to one end of the retractable striker 304. So, movement of the connecting rod 342 due to rotation of the crank 338 causes the slider 344 and the retractable striker 304 to linearly slide along the striker translation axis 320 that is transverse to both the primary rotation axis 311 and the secondary rotation axis 316. The retractable striker 304 is shown in the extended position in FIG. 70B and FIG. 70C shows the retractable striker 304 beginning to return back to the retracted position.

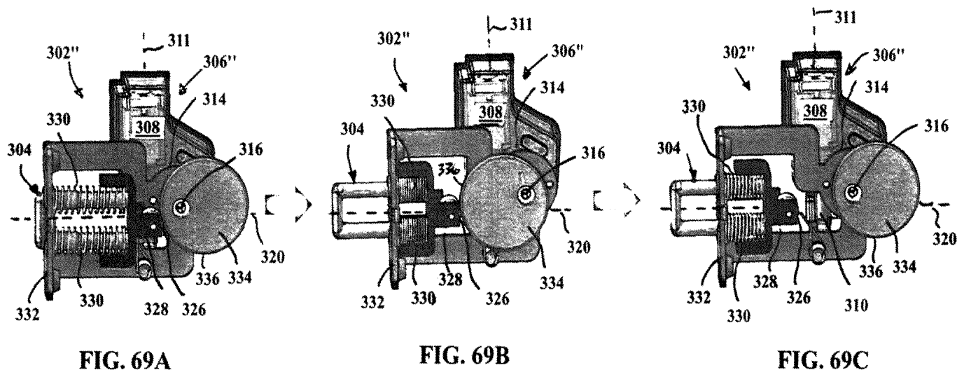

Referring to FIG. 71, the closure system 300 also includes at least one controller unit (e.g., a master controller unit 346 of at least one master latch assembly 348, 348′) in communication with the retractable striker assembly 302, 302′, 302″, 302′″. The at least one controller unit 346 is configured to receive door release signals corresponding to operation of a plurality of handles of the first and second closure members 664, 666, 674, 676 (e.g., from handle switch 658a) and a vehicle status (e.g., communicated from the vehicle main management unit 654). The at least one controller unit 346 controls the retractable striker actuator 306, 306′, 306″, 306′″ to move the retractable striker 304 based on the door release signals and vehicle status thereby selectively allowing or preventing the first and second closure members 664, 666, 674, 676 to be opened independently of one another. While the at least one controller unit is shown as the master controller unit 346 of the at least one master latch assembly 348, 348′, it should be appreciated that the at least one controller unit could instead be located elsewhere in the vehicle 610′ (e.g., a slave controller unit 350 of at least one slave latch assembly 352).

Still referring to FIG. 71 and back to FIG. 63, the closure system 300 also includes the at least one master latch assembly 348, 348′. The at least one master latch assembly 348, 348′ includes a master power release mechanism 354 configured to selectively secure the one of the first and second closure members 664, 666, 674, 676 to the vehicle body 611. The master power release mechanism 354 includes a master actuation group 356 operable to control actuation of the one of the first and second closure members 664, 666, 674, 676. As discussed, the at least one controller unit can include the master controller unit 346 of the at least one master latch assembly 348, 348′. The master controller unit 346 is coupled to the master actuation group 356 and is configured to control actuation of the master actuation group 356 in addition to the retractable striker assembly 302, 302′, 302″, 302′″. The at least one master latch assembly 348, 348′ also includes a master H-bridge module 358 coupled to the master controller unit 346 and the master actuation group 356. The master H-bridge module 358 is configured to drive the master actuation group 356.

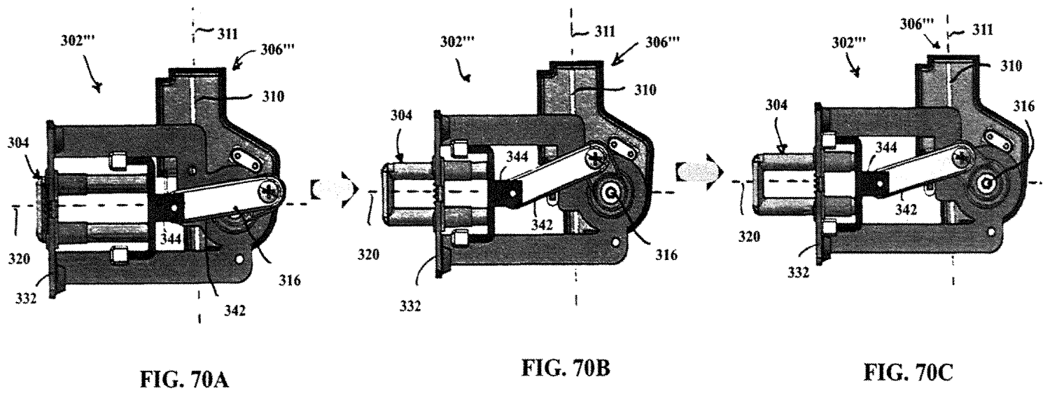

FIGS. 72A and 72B show additional details of an example of the at least one master latch assembly 348, 348′. Specifically, the at least one master latch assembly 348, 348′ can perform a latching function with cinching and power release and includes a master connector 360 (e.g., 32 pins) coupled to the master controller unit 346. The at least one master latch assembly 348, 348′ can include master backup connections 362, 364 to an outside backup (e.g., key cylinder) and/or an inside backup (e.g., inside release/emergency handle). The at least one master latch assembly 348, 348′ also includes a master fishmouth channel 366 to accept the striker (e.g., 8 millimeter striker diameter), such as the retractable striker 304 or another striker (e.g., attached to the vehicle body 611). The at least one master latch assembly 348, 348′ may be attached to one of the first and second closure members 664, 666, 674, 676 or the vehicle body 611 using fasteners 368 (e.g., three M6 screws). The at least one master latch assembly 348, 348′ may also include a power release reset backup 370. As shown, the at least one master latch assembly 348, 348′ includes the integrated backup energy source 660 (e.g., group of low voltage supercapacitors 662).

The closure system 300 also includes the at least one slave latch assembly 352. The at least one slave latch assembly 352 includes a slave power release mechanism 372 configured to selectively secure the one of the first and second closure members 664, 666, 674, 676 to the vehicle body 611. The slave power release mechanism 372 includes a slave actuation group 374 operable to control actuation of the one of the first and second closure members 664, 666, 674, 676. The at least one controller unit includes the slave controller unit 350 of the at least one slave latch assembly 352 in communication with the master controller unit 346 and coupled to the slave actuation group 374. The slave controller unit 350 is configured to control actuation of the slave actuation group 374. The at least one slave latch assembly 352 additionally includes a slave H-bridge module 376 coupled to the slave controller unit 350 and the slave actuation group 374. The slave H-bridge module 376 is configured to drive the slave actuation group 374.

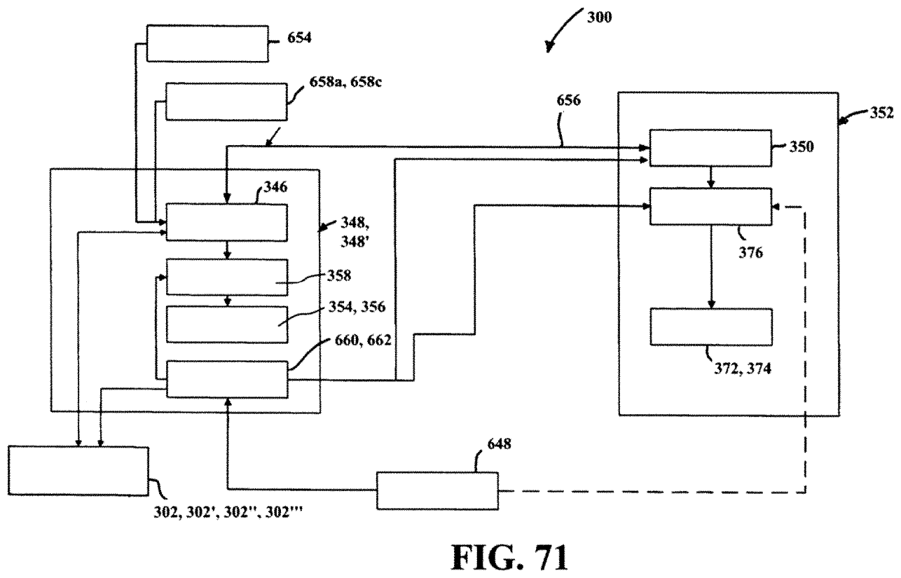

FIGS. 73A and 73B show additional details of an example of the at least one slave latch assembly 352. Like the at least one master latch assembly 348, 348′, the at least one slave latch assembly 352 can perform a latching function with cinching and power release. The at least one slave latch assembly 352 includes a slave connector 378 (e.g., 3 or 4 pins (local interconnect/LIN or controller area network/CAN communication bus such as data bus 656) coupled to the slave controller unit 350 and can include slave backup connections 380, 382 to an outside backup (e.g., key cylinder) and/or an inside backup (e.g., inside release/emergency handle). The at least one slave latch assembly 352 also includes a slave fishmouth channel 384 to accept the striker (e.g., 8 millimeter striker diameter) and may be attached to one of first and second closure members 664, 666, 674, 676 or the vehicle body 611 using fasteners 386 (e.g., three M6 screws). The at least one slave latch assembly 352 may also include a power release reset backup 388. Unlike the at least one master latch assembly 348, 348′, the at least one slave latch assembly 352 does not includes its own integrated backup energy source 660; however, it should be understood that one could be utilized.

Referring back to FIG. 71, the closure system 300 further includes the integrated backup energy source 660 (e.g., group of low voltage supercapacitors 662) coupled to the master and slave H-bridge modules 358, 376 and the master and slave controller units 346, 350 and the retractable striker assembly 302, 302′, 302″, 302′″. The integrated backup energy source 660 is configured to supply electrical energy to the master and slave H-bridge modules 358, 376 and the master and slave controller units 346, 350 and the retractable striker assembly 302, 302′, 302″, 302′″ in case of a failure or interruption of a main power supply from a main power source 648 of the motor vehicle 610′.

The master controller unit 346 is in communication with the vehicle main management unit 654. The slave controller unit 350 is configured to monitor operation of the slave actuation group 374 and collects slave diagnostic data and slave latch status. The slave controller unit 350 is also configured to transmit the slave diagnostic data and the slave latch status to the master controller unit 346 in response to collecting the slave diagnostic data and the slave latch status. The master controller unit 346 is configured to monitor operation of the master actuation group 356 and collects master diagnostic data and master latch status. The master controller unit 346 receives the slave diagnostic data and the slave latch status from the slave controller unit 350. The master controller unit 346 is also configured to transmit the slave diagnostic data and slave latch status and the master diagnostic data and the master latch status to the vehicle main management unit 654 in response to receiving the slave diagnostic data and the slave latch status. The master controller unit 346 additionally receives a main latch control signal from the vehicle main management unit 654. The master controller unit 346 is configured to verify the slave latch status and the master latch status in response to receiving the main latch control signal from the vehicle main management unit 654. Accordingly, the master controller unit 346 controls the at least one slave latch assembly 352 to release the one of the first and second closure members 664, 666, 674, 676 using the slave power release mechanism 372 and the master actuation group 356 to release the one of the first and second closure members 664, 666, 674, 676 using the master power release mechanism 354 in response to verifying the slave latch status and the master latch status.

The master controller unit 346 is additionally configured to monitor a vehicle status communicated from the vehicle main management unit 654 and determine if the vehicle 610′ is moving based on the vehicle status. The master controller unit 346 maintains the retractable striker 304 in the extended position in response to determining the vehicle 610′ is moving based on the vehicle status. The master controller unit 346 is also configured to retract the retractable striker 304 and maintain the retractable striker 304 in the retracted position using the retractable striker 304 actuator in response to determining the vehicle 610′ is not moving based on the vehicle status.

The master controller unit 346 is also configured to monitor a vehicle status communicated from the vehicle main management unit 654 and determine if a crash of the vehicle 610′ is detected based on the vehicle status. The master controller unit 346 is configured to control the at least one slave latch assembly 352 to release the one of the first and second closure members 664, 666, 674, 676 using the slave power release mechanism 372 in response to determining the crash of the vehicle 610′ is detected. The master controller unit 346 then retracts the retractable striker 304 and maintains the retractable striker 304 in the retracted position using the retractable striker actuator 306, 306′, 306″, 306′″ and control the master actuation group 356 to release another of the first and second closure members 664, 666, 674, 676 using the master power release mechanism 354.

Referring back to FIG. 63, the at least one master latch assembly 348, 348′ includes a front master latch assembly 348 and a rear master latch assembly 348′. As discussed, the first and second closure members 664, 666, 674, 676 include the front door 664, 666 and the rear door 674, 676 disposed on a side of the motor vehicle 610′. According to an aspect, the at least one slave latch assembly 352 is disposed on a first front portion 390 of the front door 664, 666 and is configured to selectively secure the front door 664, 666 to a front door slave striker 392 attached to the vehicle body 611 (e.g., A-pillar 393). The front master latch assembly 348 is disposed on a first rear portion 394 of the front door 64, 66 rearward from the first front portion 390. The retractable striker assembly 302, 302′, 302″, 302′″ is disposed on a second front portion 396 of the rear door 674, 676 and is configured to extend the retractable striker 304 toward the front door 664, 666 or retract the retractable striker 304 toward the front door 664, 666 away from the front door 664, 666. The rear master latch assembly 348′ is disposed on a second rear portion 398 of the rear door 674, 676 rearward from the second front portion 396 and is configured to selectively secure the rear door 674, 676 to a rear door master striker 400 attached to the vehicle body 611 (e.g., C-pillar 402). Again, the master controller unit 346 of each of the front and rear master latch assemblies 348, 348′ are in communication with a vehicle main management unit 654.

The master controller unit 346 monitors a latch release status and determines if a front door release signal is received. The master controller unit 346 is also configured to control the at least one slave latch assembly 352 to release the front door 664, 666 from the front door slave striker 392 using the slave power release mechanism 372 and the master actuation group 356 of the front master latch assembly 348 to release the front door 664, 666 from the retractable striker 304 using the master power release mechanism 354 of the front master latch assembly 348 in response to determining the front door release signal is received thereby allowing the front door 664, 666 to be opened. The master controller unit 346 is additionally configured to maintain the retractable striker 304 in the extended position using the retractable striker actuator 306, 306′, 306″, 306′″.

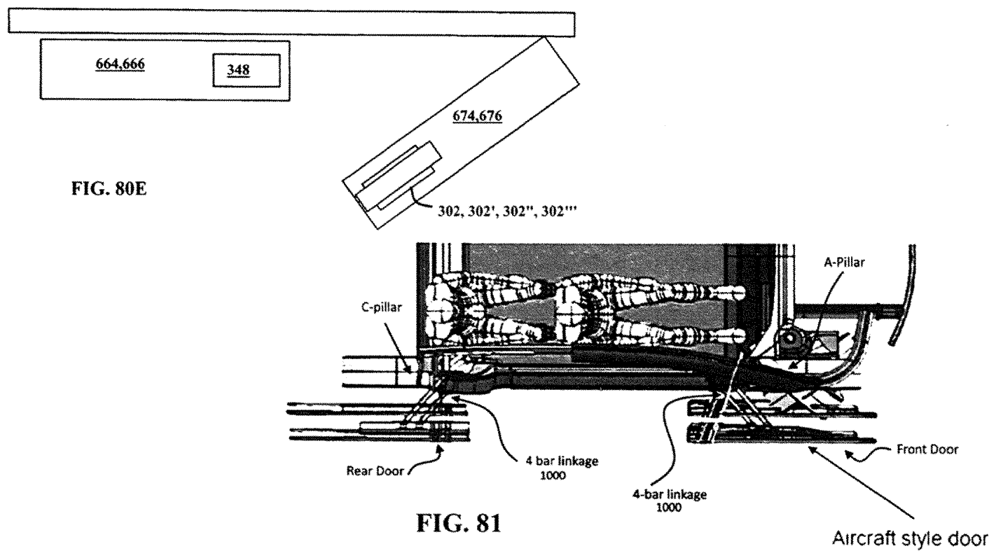

So, in an example front door opening sequence when the front door 664, 666 can swing about a pivot on the A-pillar 393, the master latch of the front door 664, 666 (i.e., front master latch assembly 348) receives an unlatch command and controls both itself and the A-pillar latch (i.e., the at least one slave latch assembly 352 attached to the A-pillar 393) to release their ratchets. It should be appreciated that instead of A-pillar latches, a top and bottom latch on the front door 664, 666 could be provided. For a sliding type/aircraft style door, an A-pillar latch is likely also needed. Similarly, the A-pillar latch (i.e., the at least one slave latch assembly 352) may be utilized for dual swing doors type (e.g., two sliding doors or four bar links mechanism type). FIG. 81 illustrates one examples of a linkage assembly 1000, illustratively shown as a four bar linkage configuration for mounting the first closure member to the A-pillar and the second closure member to the B-pillar

The master controller unit 346 is configured to monitor a latch release status and determine if a rear door release signal is received. The master controller unit 346 controls the master actuation group 356 of the front master latch assembly 348 to release the front door 64, 66 from the retractable striker 304 using the master power release mechanism 354 of the front master latch assembly 348 and control the master actuation group 356 of the rear master latch assembly 348′ to release the rear door 674, 676 from the rear door master striker 400 using the master power release mechanism 354 of the rear master latch assembly 348′ in response to determining the rear door release signal is received. The master controller unit 346 is also configured to retract the retractable striker 304 to the retracted position using the retractable striker actuator 306, 306′, 306″, 306′″ thereby allowing the rear door 674, 676 to be opened. In addition, the master controller unit 346 of each of the front and rear master latch assemblies are configured to control the at least one slave latch assembly 352 to maintain the front door 664, 666 secured to the front door slave striker 392 using the slave power release mechanism 372 in response to determining the rear door release signal is received.

Thus, in an example rear door opening sequence, the master latch of the rear door 674, 676 (i.e., rear master latch assembly 348′) receives an unlatch command and controls both itself to release its ratchet and the retractable striker assembly 302, 302′, 302″, 302′″ to retract the retractable striker 304. The front master latch (i.e., front master latch assembly 348) will also have to unlatch to allow the retractable striker 304 to retract. According to an aspect, the front master latch assembly 348 monitors a rear door opening request from the vehicle main management unit 654 or BCM, however, it is also contemplated that the rear master latch assembly 348′ transmits an open command to the front master latch assembly 348. The rear door 674, 676 can be opened after the front striker or retractable striker 304 has been retracted.

Different sequences could be implemented in case of the retractable striker 304. For instance, the door 674, 676 with the retractable striker 304 in the door latch assembly 348 of the other door 664, 666 can be kept open until the vehicle 10 is in motion and then latch the retractable striker 304. Consequently, the A-pillar slave latch assembly (i.e., the at least one slave latch assembly 352 attached to the A-pillar 393) and the C-pillar master latch assembly (i.e., the rear master latch assembly 348′ attached to the rear door 674, 676 and latching to the rear door master striker 400 on the C-pillar 402) would hold the doors 664, 666, 674, 676 closed, and only once driving (i.e., the vehicle 10 moving) would the retractable striker 304 extend to latch the front master slave latch (i.e., the front master latch assembly 348 attached to the front door 664, 666). The reason for such example operation would be to eliminate or at least reduce any door opening delays for the rear door 674, 676 due to the retractable striker 304 having to retract. The corollary is that when the motor vehicle 610′ stops (as communicated in the vehicle status from the vehicle main management unit 654), the retractable striker 304 may automatically retract to be in a state ready for the opening of the rear door 674, 676.

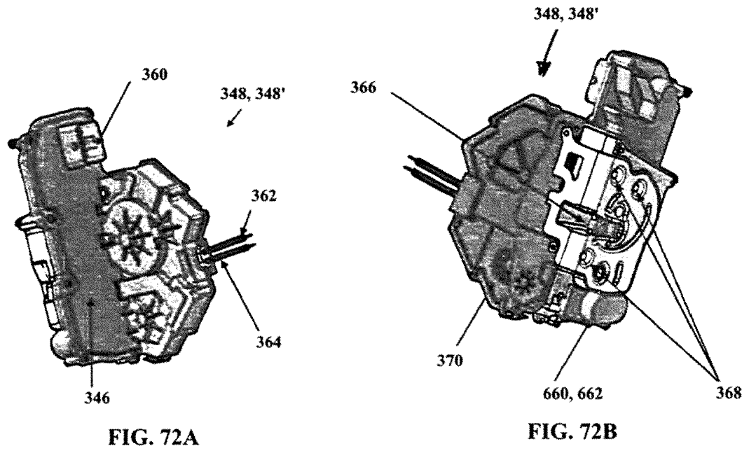

Now referring initially to FIG. 74, a method of operating a closure system 300 for a motor vehicle 610, 610′ having first and second closure members 664, 666, 674, 676 is also provided. As discussed, the first and second closure members 664, 666, 674, 676 are each movable between open and closed positions relative to a vehicle body 611 of the motor vehicle 610. The method includes the step of 500 receiving door release signals corresponding to operation of a plurality of handles of the first and second closure members 664, 666, 674, 676 and a vehicle status using at least one controller unit. The method also includes the step of 502 moving a retractable striker 304 using a retractable striker actuator 306, 306′, 306″, 306′″ of a retractable striker assembly 302, 302′, 302″, 302′″ attached to one of the first and second closure members 664, 666, 674, 676 between an extended position in which the retractable striker 304 is engaged by the another of the first and second closure members 664, 666, 674, 676 and a retracted position in which the retractable striker 304 is disengaged by the another of the first and second closure members 664, 666, 674, 676 based on the door release signals and vehicle status using the at least one controller unit thereby selectively allowing or preventing the first and second closure members 664, 666, 674, 676 to be opened independently of one another.

As discussed above, the at least one controller unit includes the master controller unit 346 of at least one master latch assembly 348, 348′ and the slave controller unit 350 of at least one slave latch assembly 352 in communication with the master controller unit 346. Thus, the method further includes the step of controlling actuation of the master actuation group 356 of the at least one master latch assembly 348, 348′ operable to control actuation of the one of the first and second closure members 664, 666, 674, 676 to selectively secure the one of the first and second closure members 664, 666, 674, 676 to the vehicle body 52 in addition to the retractable striker assembly 302, 302′, 302″, 302′″ using the master controller unit 346. The method also includes the step of controlling actuation of the slave actuation group 374 of the at least one slave latch assembly 352 operable to control actuation of the one of the first and second closure members 664, 666, 674, 676 to selectively secure the one of the first and second closure members 664, 666, 674, 676 to the vehicle body 611 using the using the slave controller unit 350.

The method additionally includes the step of driving the master actuation group 356 of the at least one master latch assembly 348, 348′ using a master H-bridge module 358 coupled to the master controller unit 346 and the master actuation group 356. The method continues by driving the slave actuation group 374 of the at least one slave latch assembly 352 using a slave H-bridge module 376 coupled to the slave controller unit 350 and the slave actuation group 374.

The method further includes the step of supplying electrical energy to the master and slave H-bridge modules 358, 376 and the master and slave controller units 346, 350 and the retractable striker assembly 302, 302′, 302″, 302′″ in case of a failure or interruption of a main power supply from a main power source 648 of the motor vehicle 610, 610′ using an integrated backup energy source 660 having a group of low voltage supercapacitors 662 coupled to the master and slave H-bridge modules 358, 376 and the master and slave controller units 346, 350 and the retractable striker assembly 302, 302′, 302″, 302′″.

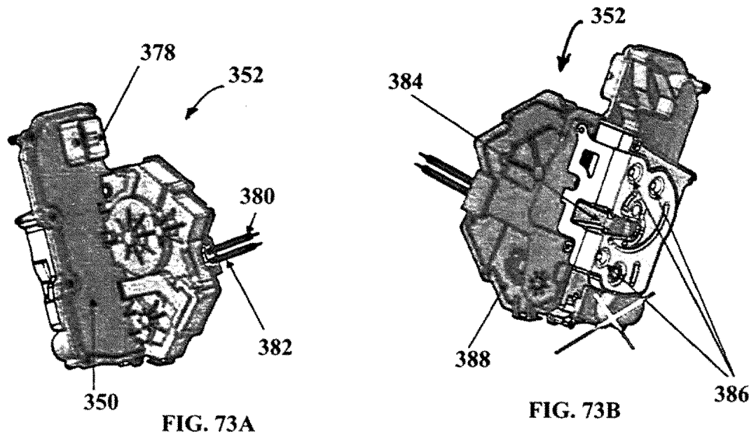

Referring to FIG. 75, the method also includes the step of 504 monitoring operation of the slave actuation group 374 and collecting slave diagnostic data and slave latch status using the slave controller unit 350. Next, 506 transmitting the slave diagnostic data and the slave latch status to the master controller unit 346 using the slave controller unit 350 in response to collecting the slave diagnostic data and the slave latch status. The method proceeds with the step of 508 monitoring operation of the master actuation group 356 and collecting master diagnostic data and master latch status using the master controller unit 346. The method additionally includes the step of 510 receiving the slave diagnostic data and the slave latch status from the slave controller unit 350 using the master controller unit 346. The next step of the method is 512 transmitting the slave diagnostic data and slave latch status and the master diagnostic data and the master latch status to the vehicle main management unit 654 using the master controller unit 346 in response to receiving the slave diagnostic data and the slave latch status.

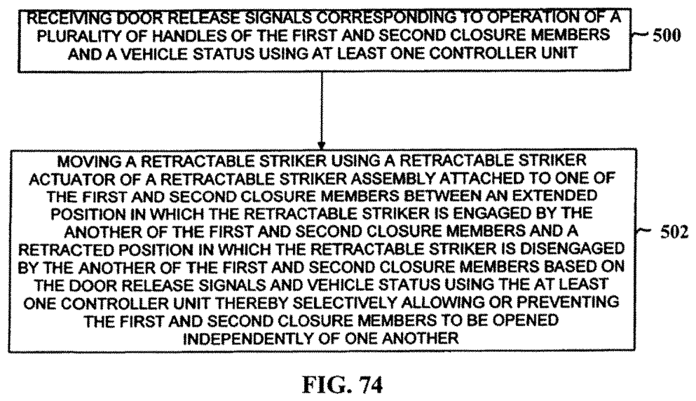

Now referring to FIG. 76, the method continues by 514 receiving a main latch control signal from the vehicle main management unit 654 using the master controller unit 346. The method also includes the step of 516 verifying the slave latch status and the master latch status in response to receiving the main latch control signal from the vehicle main management unit 654 using the master controller unit 346. The method proceeds with the step of 518 controlling the at least one slave latch assembly 352 to release the one of the first and second closure members 664, 666, 674, 676 using a slave power release mechanism 372 of the at least one slave latch assembly 352 and the master actuation group 356 to release the one of the first and second closure members 664, 666, 674, 676 using a master power release mechanism 354 of the master latch assembly in response to verifying the slave latch status and the master latch status using the master controller unit 346.

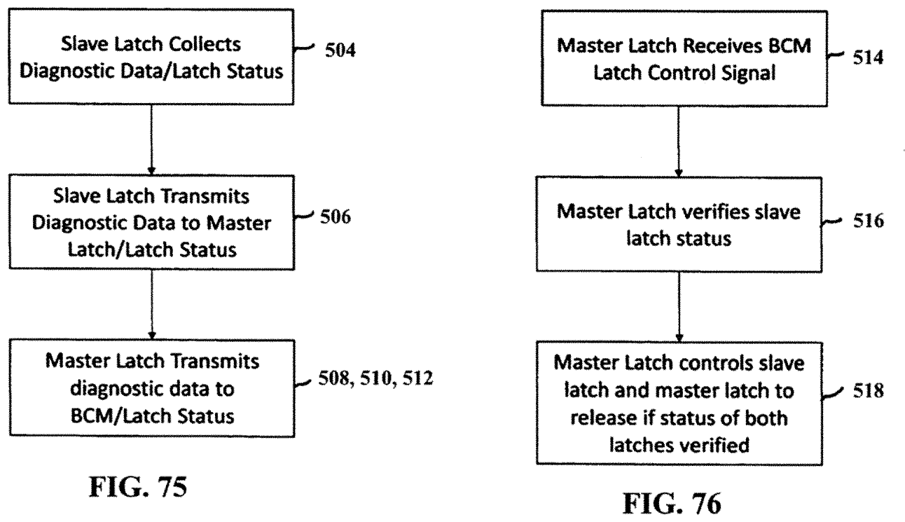

As best shown in FIG. 77, the method also includes the steps of 520 monitoring a vehicle status communicated from the vehicle main management unit 654 using the master controller unit 346 and 522 determining if the vehicle 610, 610′ is moving based on the vehicle status using the master controller unit 346. Next, the method includes the step of 524 maintaining the retractable striker 304 in the extended position in response to determining the vehicle 610, 610′ is moving based on the vehicle status using the master controller unit 346. The method also includes the step of 526 retracting the retractable striker 304 and maintaining the retractable striker 304 in the retracted position with the retractable striker actuator 306, 306′, 306″, 306′″ using the master controller unit 346 in response to determining the vehicle 610, 610′ is not moving based on the vehicle status.

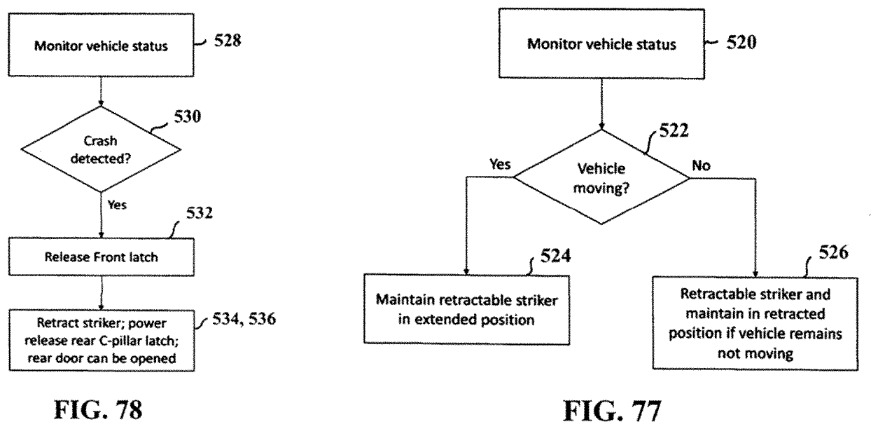

Referring to FIG. 78, the method also includes the step of 528 monitoring a vehicle status communicated from the vehicle main management unit 654 using the master controller unit 346. The method continues with the step of 530 determining if a crash of the vehicle 610, 610′ is detected based on the vehicle status using the master controller unit 346. The method additionally includes the step of 532 controlling the at least one slave latch assembly 352 to release the one of the first and second closure members 664, 666, 674, 676 with the slave power release mechanism 372 using the master controller unit 346 in response to determining the crash of the vehicle 610, 610′ is detected. The method proceeds by 534 retracting the retractable striker 304 and maintaining the retractable striker 304 in the retracted position with the retractable striker actuator 306, 306′, 306″, 306′″ and 536 controlling the master actuation group 356 to release another of the first and second closure members 664, 666, 674, 676 with the master power release mechanism 354 using the master controller unit 346.

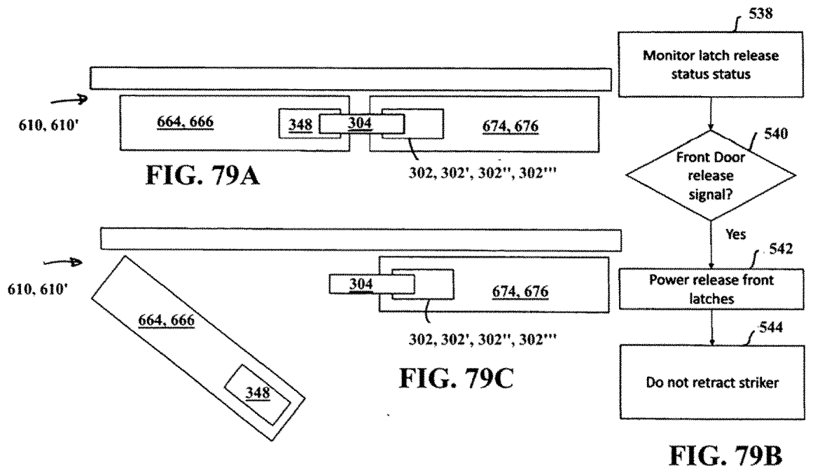

As discussed above and shown in FIG. 79A, the at least one master latch assembly 348, 348′ includes the front master latch assembly 348 and the rear master latch assembly 348′. In addition, the first and second closure members 664, 666, 674, 676 include the front door 664, 666 and the rear door 674, 676 disposed on the side of the motor vehicle 610, 610′. As shown, the front latch (e.g., front master latch assembly 348) is latched to retractable striker 304 of the retractable striker assembly 302, 302′, 302″, 302′″. Thus, as best shown in FIG. 79B, the method further includes the step of 538 monitoring a latch release status using the master controller unit 346 of each of the front and rear master latch assemblies. Next, 540 determining if a front door release signal is received using the master controller unit 346 of each of the front and rear master latch assemblies. As shown in FIG. 79C, the front latch (e.g., front master latch assembly 348) is unlatched from the retractable striker 304 of the retractable striker assembly 302, 302′, 302″, 302′″ and the retractable striker 304 is not retracted. So, the method continues with the step of 542 controlling the at least one slave latch assembly 352 to release the front door 64, 66 from a front door slave striker 392 attached to the vehicle body 52 with the slave power release mechanism 372 and the master actuation group 356 of the front master latch assembly 348 to release the front door 664, 666 from the retractable striker 304 with the master power release mechanism 354 of the front master latch assembly 348 using the master controller unit 346 of each of the front and rear master latch assemblies in response to determining the front door release signal is received thereby allowing the front door 664, 666 to be opened. The method proceeds by 544 maintaining the retractable striker 304 in the extended position (FIG. 79C) with the retractable striker actuator 306, 306′, 306″, 306′″ using the master controller unit 346 of each of the front and rear master latch assemblies.

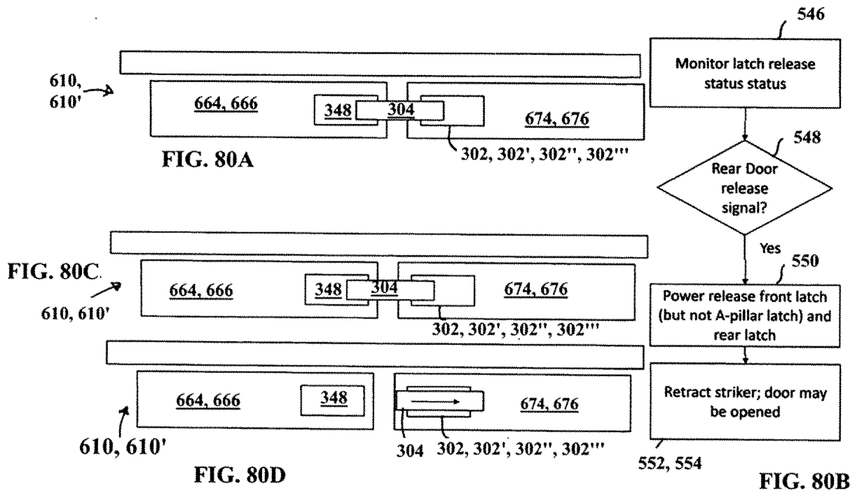

As mentioned and also shown in FIG. 80A, the at least one master latch assembly 348, 348′ includes the front master latch assembly 348 and the rear master latch assembly 348′. Again, the first and second closure members 664, 666, 674, 676 includes the front door 664, 666 and the rear door 674, 676 disposed on a side of the motor vehicle 610, 610′. As shown, the front latch (e.g., front master latch assembly 348) is again latched to retractable striker 304 of the retractable striker assembly 302, 302′, 302″, 302′″. Consequently, as best shown in FIG. 80B, the method further includes the steps of 546 monitoring a latch release status using the master controller unit 346 of each of the front and rear master latch assemblies and 548 determining if a rear door release signal is received using the master controller unit 346 of each of the front and rear master latch assemblies. As shown in FIG. 80C, the front latch (e.g., front master latch assembly 348) is unlatched from the retractable striker 304 of the retractable striker assembly 302, 302′, 302″, 302′″ and the retractable striker 304 is not retracted. Thus, the method also includes the step of 550 controlling the master actuation group 356 of the front master latch assembly 348 to release the front door 664, 666 from the retractable striker 304 with the master power release mechanism 354 of the front master latch assembly 348 and controlling the master actuation group 356 of the rear master latch assembly 348′ to release the rear door 674, 676 from a rear door master striker 400 attached to the vehicle body 611 with the master power release mechanism 354 of the rear master latch assembly 348′ using the master controller unit 346 of each of the front and rear master latch assemblies in response to determining the rear door release signal is received. As shown in FIG. 80D, the front latch (e.g., front master latch assembly 348) is unlatched from the retractable striker 304 of the retractable striker assembly 302, 302′, 302″, 302′″ and the retractable striker 304 is retracted. So, the next step of the method is 552 retracting the retractable striker 304 to the retracted position (FIG. 80D) with the retractable striker actuator 306, 306′, 306″, 306′″ using the master controller unit 346 of each of the front and rear master latch assemblies 348, 348′ thereby allowing the rear door 674, 676 to be opened (FIG. 80E). The method can further include the step of 554 controlling the at least one slave latch assembly 352 to maintain the front door 664, 666 secured to the front door slave striker 392 with the slave power release mechanism 372 using the master controller unit 346 of each of the front and rear master latch assemblies 348, 348′ in response to determining the rear door release signal is received.

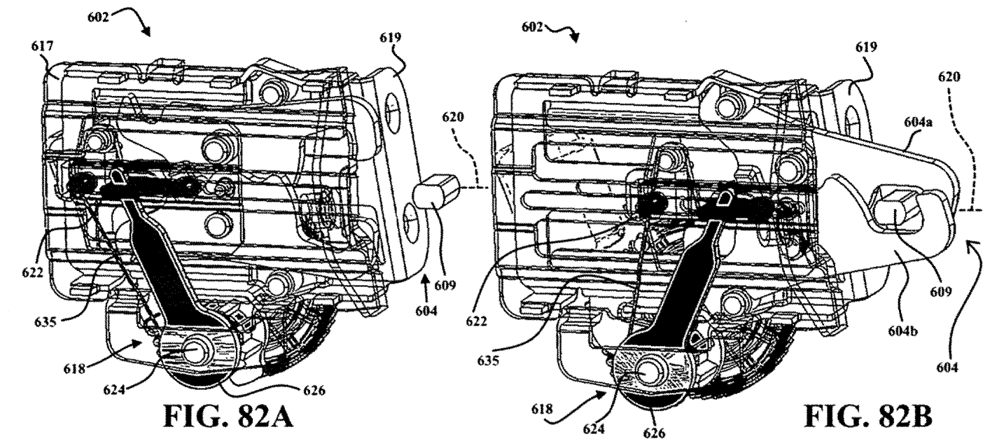

Now, with continued reference to FIG. 63, another closure system 300′ for motor vehicle 10 having first and second closure members 664, 666, 674, 676 is illustrated. The closure system 300′, rather than including a retractable striker, includes a retractable ratchet assembly 602 (FIGS. 82A and 82B) attached to at least one or more of the first and second closure members 664, 666, 674, 676. It is to be recognized that the discussion above with regard to the closure system 300 is the same for closure system 300′, including the master control system 346, and thus, repetition of discussion is believed unnecessary for the master control system 346 associated with retractable ratchet assembly 602. Accordingly, discussion hereafter, unless otherwise stated, is directed expressly to retractable ratchet assembly 602.

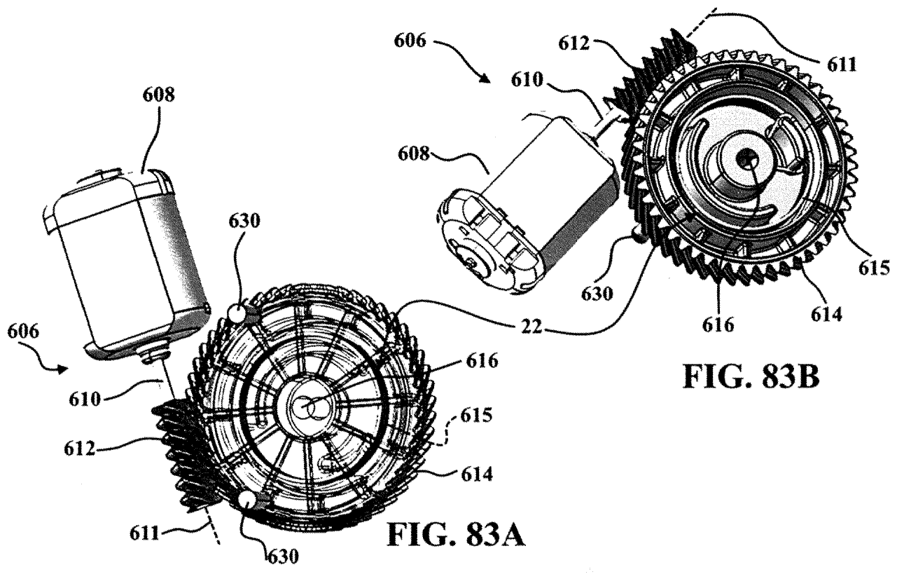

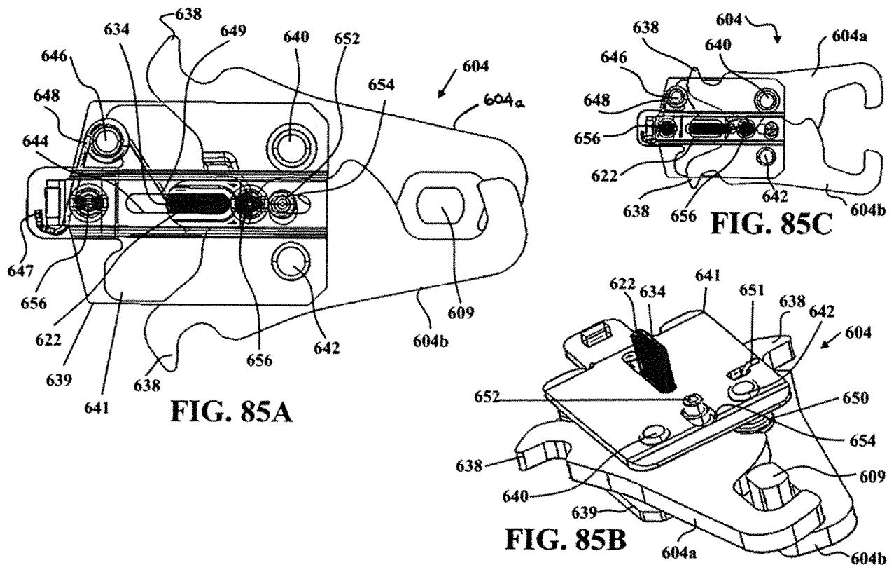

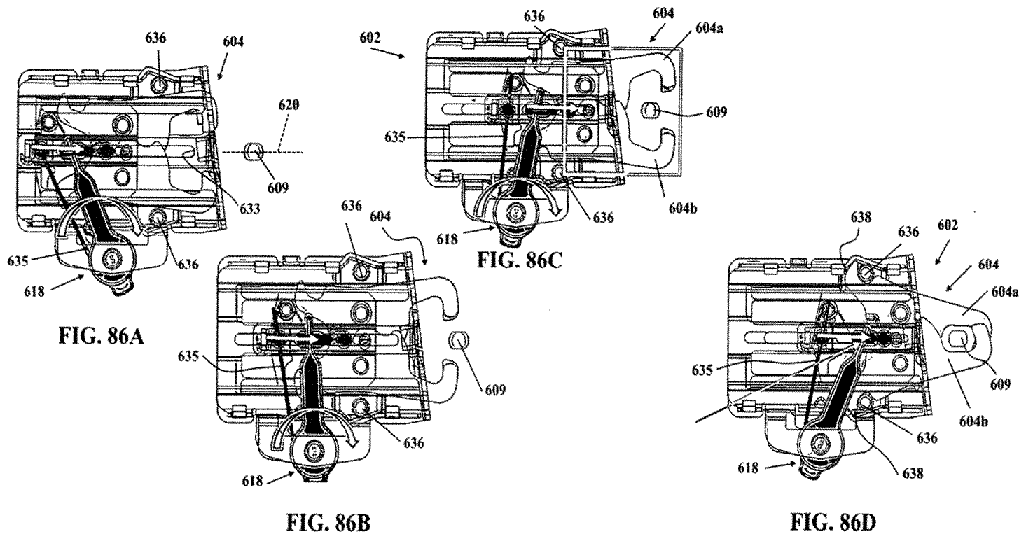

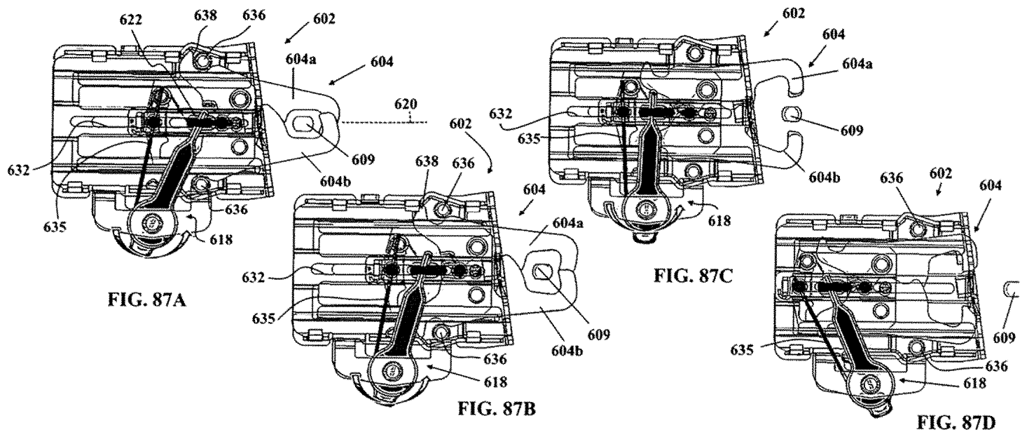

Referring to FIGS. 82A and 82B, retractable ratchet assembly 602 includes a moveable, translatable retractable ratchet subassembly, referred to hereafter as retractable ratchet 604 (FIGS. 85A-85C), being movable by a retractable ratchet actuator, and referred to hereafter as ratchet actuator 606 (FIGS. 83A and 83B), between a retracted position, also referred to as striker release position or latched position (FIG. 82A), and an extended position, also referred to as striker capture position or latched position (FIG. 82B) for captured engagement with a fixed striker 609. Specifically, the ratchet actuator 606 includes a retractable ratchet motor, referred to hereafter as ratchet motor 608, having a motor shaft 610 extending and rotatable about a primary rotation axis 611. A worm 612 attaches to the motor shaft 610 for fixed rotation with the motor shaft 610. The worm 612 engages and is configured to rotate a worm gear 614 upon selective actuation of ratchet motor 608, shown as a helical gear, by way of example and without limitation, about a secondary rotation axis 616 that is transverse to the primary rotation axis 611. The worm 612 is back drivable upon ratchet motor 608 being de-energized via a return spring 615 (FIGS. 83A and 83B). Return spring 615 is shown as a torsion spring, having one end fixed to worm gear 614 and an opposite end fixed to a fixed, stationary member or portion of retractable ratchet assembly 602, such as a housing assembly, referred to hereafter as housing 621, of retractable ratchet assembly 602, wherein stationary housing 621 is provided by a stationary frame plate 617 and a stationary back plate 619 fixed to stationary frame plate 617. The worm gear 614 couples to a drive mechanism 618, referred to hereafter as pawl lever, with pawl lever being provided as a pair of laterally spaced pawl levers 618a, 618b arranged in mirrored, interconnected relation with one another. Pawl levers 618a, 618b, although pivotal, as discussed hereafter, are consider to be part of stationary housing assembly 621, as they do not translate with retractable ratchet 604. Pawl levers 618a, 618b are operably coupled with the retractable ratchet 604 via a pawl 622 (FIGS. 85A-85C) to move the pawl 622 and the retractable ratchet 604 along a straight ratchet translation axis 620 to the extended position in response to the ratchet motor 608 being energized and driven in a first direction and moving the retractable ratchet 604 along the ratchet translation axis 620 to the retracted position in response to the ratchet motor 608 being driven in a second direction, via being energized and/or via bias imparted by return spring 615, opposite the first direction.

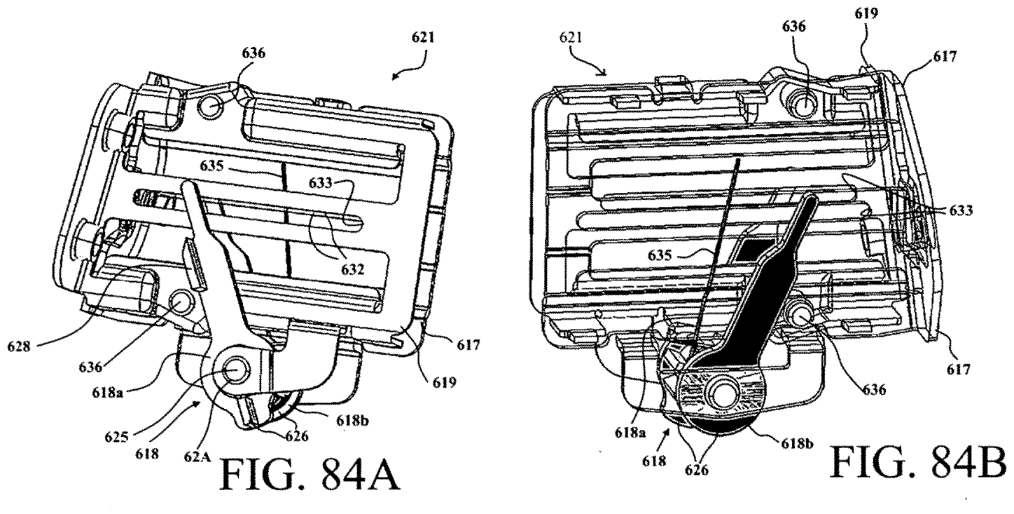

Referring to FIGS. 84A and 84B, stationary frame plate 617 and stationary back plate 619 form a stationary, non-translatable subassembly of retractable latch assembly 602 that mounts in fixed relation to the first and second closure members 664, 666, 674, 676. Pawl levers 618a, 618b, interconnected for conjoint movement with one another, are pivotably coupled to stationary frame plate 617 and stationary back plate 619 via a pawl pin 624 adjacent fixation ends 626 of pawl levers 618a, 618b. During actuation of retractable ratchet assembly 602, at least one driven member, shown as a driven tab 628 extending laterally outwardly from pawl lever 618a, is driven via at least one actuating member, also referred to as drive member, cog or drive pin, and shown in FIG. 83A as a pair of drive pins 630, extending laterally outwardly from worm gear 614 to pivot pawl levers 618a, 618b about a pawl pin axis 625. As pawl levers 618a, 618b pivot clockwise about pawl pin 624, drive ends 628 of pawl levers 618a, 618b, opposite fixation ends 626, drive pawl 622 along alignment slots 632 in stationary frame plate 617 and stationary back plate 619 to move retractable ratchet 604 between its striker release and striker capture positions, as discussed further below. Alignment slots 632 receive guide tabs 634 of pawl 622 therein, with pawl 622 being disposed between stationary frame plate 617 and stationary back plate 619 and guide tabs 634 extending laterally away from one another for sliding receipt in alignment slots 632. Alignment slots 632 extend to a common positive stop 633 (FIGS. 84A and 84B) to limit travel of retractable ratchet 604 to the extended position and to facilitate movement of retractable ratchet 604 to its striker capture position, as discussed further below. A retracting spring, also referred to as pawl lever biasing member or spring 635, is supported by pawl pin 624, wherein pawl lever spring 635 imparts a bias on retractable ratchet 604 to bias retractable ratchet to its retracted, striker release position. To enhance structural integrity and rigidity of retractable ratchet assembly 602 while in the striker capture position, stop members, also referred to as stop rivets 636, both fixedly interconnect frame plate 617 and stationary back plate 619 with one another and act as positive stops to engage hook-shaped ends 638 of individual ratchets 604a, 604b of retractable ratchet 604.

Referring to FIGS. 85A-85C, retractable ratchet 604 forms a portion of a moveable subassembly or portion of retractable latch assembly 602. Ratchets 604a, 604b are operably coupled to one another in sandwiched relation between a moveable, translatable frame plate 639 and a moveable, translatable back plate 641. It is to be recognized that frame plate 639 and back plate 641 form a part of moveable, translatable retractable ratchet subassembly 604. Ratchet 604a is pivotably coupled to a moveable frame plate 639 and moveable back plate 641 via a first pin 640 for pivotal movement about first pin 640 and ratchet 604b is pivotably coupled to moveable frame plate 639 and moveable back plate 641 via a second pin 642 for pivotal movement about second pin 642, with first pin 640 being spaced from second pin 642 and with ratchets 604a, 604b being laterally offset relative to one another to allow scissor-like movement therebetween along parallel planes. The moveable frame plate 639 and moveable back plate 641 have slots 644 aligned with one another for sliding receipt of guide tabs 634 therethrough and into alignment slots 632 of stationary frame plate 617 and stationary back plate 619, with pawl 622 being captured for slidable movement, along ratchet translation axis 620, between the moveable frame plate 639 and moveable back plate 641. In addition to the first and second pins 640, 642, a pawl spring pin 646 is shown fixed to moveable frame plate 639 for fixed attachment of one end 647 of a pawl spring 648 thereto, while an opposite end 649 of pawl spring 648 is configured to impart a bias on pawl 622 to move pawl 622 toward and into forcible engagement with retractable ratchet 604.

In addition to first pin 640 supporting ratchet 604b for pivotal movement, first pin 640 supports a ratchet biasing member, also referred to as ratchet spring 650 (FIG. 85B), thereon, with ratchet spring 650 having one end 651 fixed to moveable back plate 641 and another end configured to impart a bias on a ratchet pin 652. Ratchet pin 652 is captured between stationary frame plate 617 and stationary back plate 619 for slidable movement within aligned slots 654 in moveable frame plate 639 and moveable back plate 641 and within alignment slots 632 of stationary frame plate 617 and stationary back plate 619. The bias imparted by ratchet spring 650 on ratchet pin 652 acts to move ratchet pin 652 to a position within slots 654 to urge ratchets 604a, 604b toward their open, striker release position. Ratchets 604a, 604b have slots for receipt of ratchet pin 652 therethrough, wherein the slots in ratchets 604a, 604b act as a camming mechanism to synchronize movement of ratchets 604a, 604b between their open, striker release position, also referred to as striker release state, whereat striker 609 is removed from the ratchets 604a, 604b and a closed, striker capture position, also referred to as striker capture state, whereat striker 609 is retained between the pair of ratchets 604a, 604b, as ratchet pin 652 slides therethrough and slides through slots 654.

To further facilitate slidable movement of moveable frame plate 639 and moveable back plate 641 along ratchet translation axis 620 between stationary frame plate 617 and stationary back plate 619, a pair of guide pins, also referred to as slide pins 656, are fixed to at least one of moveable frame plate 639 and/or moveable back plate 641, with slide pins 656 being shown, by way of example and without limitation, as being fixed to moveable frame plate 639 and extending laterally outwardly therefrom for sliding receipt within alignment slot 632 of stationary frame plate 617.

In operation, the retractable ratchet assembly 602 of the closure system 300, 300′ can be attached to at least one of the first and second closure members 64, 66, 74, 76. The retractable ratchet 604, and in particular, the retractable ratchets 604a, 604b of the ratchet assembly 602 are movable between the extended position into engagement with the striker 609 whereat the at least one first and second closure member 664, 666, 674, 676 is configured to be maintained in a closed position, and a retracted position out from engagement with the striker 609, whereat the at least one first and second closure member 664, 666, 674, 676 is configured to be moved to an open position.

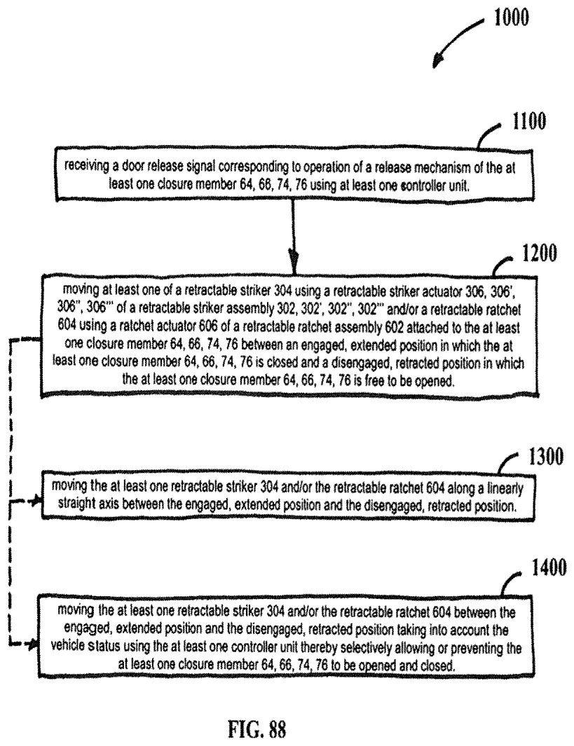

In accordance with another aspect of the disclosure, as shown in FIG. 88, a method 1000 of operating a closure system 300, 300′ for a motor vehicle 610, 610′ having at least one closure member 664, 666, 674, 676 movable between open and closed positions relative to a vehicle body 611 of the motor vehicle 610, 610′ is provided. The method 1000 includes the steps of: 1100 receiving a door release signal corresponding to operation of a release mechanism of the at least one closure member 664, 666, 674, 676 using at least one controller unit; and 1200 moving at least one of a retractable striker 304 using a retractable striker actuator 306, 306′, 306″, 306′″ of a retractable striker assembly 302, 302′, 302″, 302′″ and/or a retractable ratchet 604 using a ratchet actuator 606 of a retractable ratchet assembly 602 attached to the at least one closure member 664, 666, 674, 676 between an engaged, extended position in which the at least one closure member 664, 666, 674, 676 is closed and a disengaged, retracted position in which the at least one closure member 664, 666, 674, 676 is free to be opened.

The method 1000 can further include a step 1300 of moving the at least one retractable striker 304 and/or the retractable ratchet 604 along a linearly straight axis between the engaged, extended position and the disengaged, retracted position.

The method 1000 can further include a step 1400 of moving the at least one retractable striker 304 and/or the retractable ratchet 604 between the engaged, extended position and the disengaged, retracted position taking into account the vehicle status using the at least one controller unit thereby selectively allowing or preventing the at least one closure member 664, 666, 674, 676 to be opened and closed.

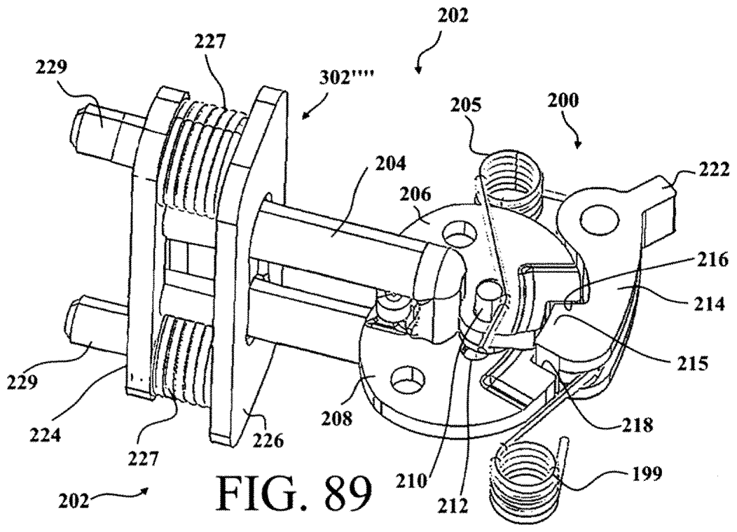

Now further referring to FIGS. 89 to 97E, there is illustrated another alternative construction of a retractable striker assembly, referred to using the reference numeral 302″″, shown in combination with a latch assembly 200. Illustratively, retractable striker assembly 302″″ can be mounted to a vehicle door, such as front door 64 and latch assembly 200 can be mounted on rear door 74 as shown in FIG. 63 for latching the vehicle doors forming part of a B-pillarless door system in one possible configuration. Other configurations are possible, such as retractable striker assembly 302″″ can be mounted to rear door 74, while latch assembly 200 can be mounted to front door 64, or either of latch assembly 200 or retractable striker assembly 302″″ can be mounted to one of a vehicle body 10, such as to one of a B-Pillar, A-Pillar, or C-Pillar of the vehicle 10, while the other one of latch assembly 200 or retractable striker assembly 302″″ can be mounted to a vehicle door for latching the vehicle door to the vehicle body. Alternatively, the retractable striker assembly 302″″ may be provided for releasably latching with other types of latches, such as a cinching latch, a power release latch, an E-latch, or such as those described herein above without limitation, as well as for use in other types of closure systems, such as sliding door systems, pivoting door systems, liftgate door systems, frunk closure systems, as but non-limiting examples. Retractable striker assembly 302″″ may be utilized as part of a B-pillarless door system, such as those illustrated herein with reference to FIGS. 1, 2, 3, 11A to 17, 28, 38, 49, 60 to 63, 79A, to 80 as but examples, and can allow an operation of the front and/or rear doors such that either of the front or the rear doors may be opened and closed independently. Retractable striker assembly 302″″ can be employed as part of a center door to door latch configuration (and may be provided in conjunction with other latches such as upper and lower latches (see FIG. 28 for example) which may be synchronized in operation with one another using either a mechanical brain plate (not shown) or an electronic interface or control system). Referring in particular to FIG. 89, there is illustrated a closure system 202 comprising the latch assembly 200 configured for releasably latching with the retractable striker assembly 302″″ for securing a front door 64 to a rear door 74 of a B-pillarless door system.

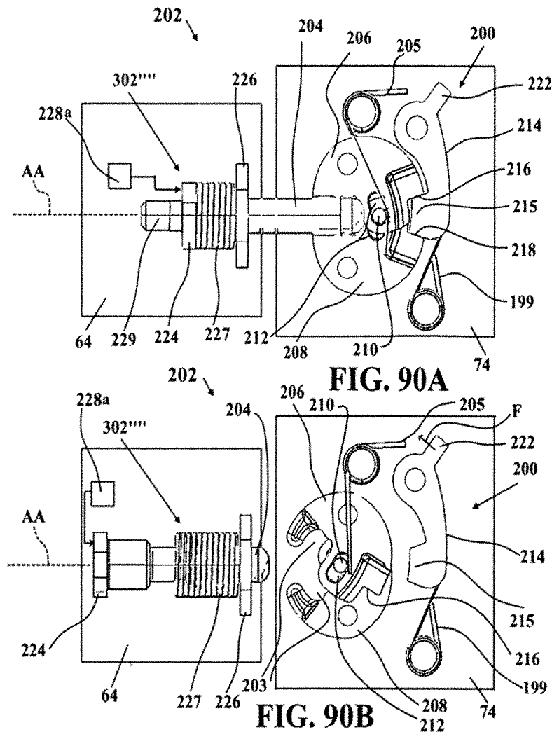

Now referring additionally to FIGS. 90A and 90B, there is illustrated possible states of the closure system 202, with FIG. 90A showing the retractable striker assembly 302″″ in an extended state such that a moveable striker 204 of the retractable striker assembly 302″″ is in a deployed position for engaging with the latch assembly 200 shown in a closed or latched state to secure the front door 64 in a closed position with the rear door 74, and with FIG. 90B showing the retractable striker assembly 302″″ in retracted state such that the moveable striker 204 is in a retracted position and disengaged from the latch assembly 200 now shown in an unlatched or releasing state to allow the front door 64 or the rear door 74 to be opened independently relative to the other door; or, in other words, the front door 64 or the rear door 74 may be moved to an opened position without requiring the other door to be moved away from the closed position to allow for the moveable striker 204 to bypass without contacting the other door 64, 74 as compared to a configuration of a non-moveable striker whereby in order for the front door 64 to be opened when the striker 204 is configured not to be retracted, the rear door may have to be moved to a partially opened position.

Still referring to FIG. 90A and FIG. 90B, latch assembly 200 is shown to include a first ratchet 206 and a second ratchet 208 each configured for pivotal rotation such each of the first ratchet 206 and the second ratchet 208 are configured to secure or capture the moveable striker 204 within a mouth 203 of the ratchets 206, 208 when the ratchets 206, 208 have been rotated to a striker capture position such that latch assembly 200 is in a closed or latched state (as shown in FIG. 90A). First ratchet 206 and the second ratchet 208 are further configured to release the moveable striker 204 from the mouth 203 of the ratchet 206, 208 when the latch assembly 200 is in an open or unlatched state (as shown in FIG. 90B). Each of the ratchets 206, 208 are illustrated as being pivotally mounted about a ratchet pin 210 within a slot 212 provided for on each of the ratchets 206, 208. Ratchet pin 210 is illustratively shown as a twinning pin for synchronizing the rotation of the ratchets 206, 208, such that they can rotate at similar rates. A spring 205 is provided for acting on the twinning (synchronizing) pin 210 to bias the ratchets 206, 208 towards the open shown in FIG. 90B. Ratchet pin 210 may be guided in a housing or frame plate (not shown) of the latch assembly 200.

Latch assembly 200 further includes a pawl 214 configured for holding the ratchets 206, 208 in a latched position (FIG. 90A) by a provided pawl tooth 215 for engaging with notches 216, 218 provided on each of the ratchets 206, 208 for blocking rotation of the ratchet 206, 208 from the striker capture position of FIG. 90A to a striker releasing position of FIG. 90B. Pawl 214 is shown in FIG. 90A to be biased by a pawl spring 199 into a ratchet blocking or ratchet holding position. Pawl 214 is shown in FIG. 90B to be moved out of the ratchet blocking position against the bias of pawl spring 199 into a ratchet releasing position to allow the ratchets 206, 208 to rotate and the moveable striker 204 to be released. Pawl 214 can be moved out of the ratchet blocking position against the bias of pawl spring 200 by a force F acting on a pawl arm 222 in a counter clockwise direction, where such a force F may be generated by a manual force from a user activating a handle assembly operably connected to the pawl actuation arm 222 for example, or such a force F may be generated by a motor based force from a DC motor, such as a power release motor, operably connected to the pawl arm 222 as another example.

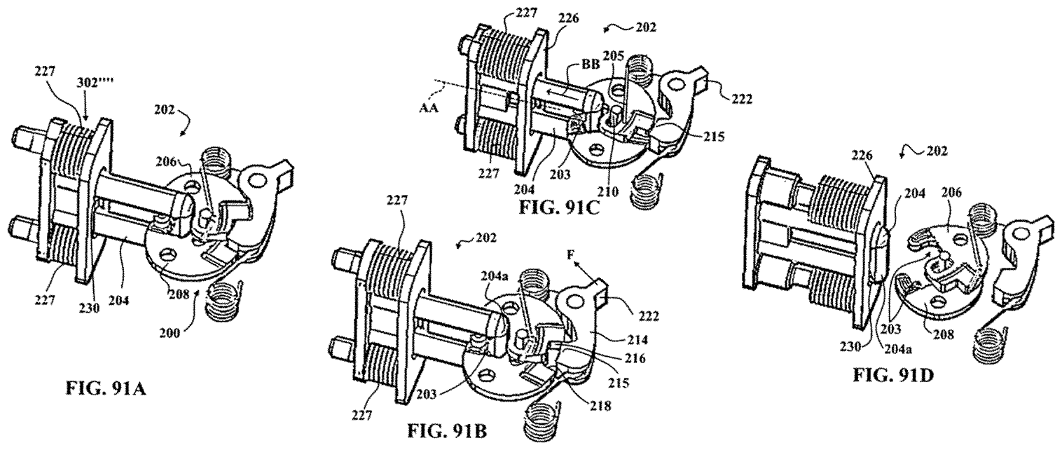

Still referring to FIG. 90A and FIG. 90B, retractable striker assembly 302″″ comprises the moveable striker 204 moveable along an axis AA. Retractable striker assembly 302″″ includes a base plate 224 connected to the moveable striker 204 and a reference plate 226, and a spring 227, or bias, disposed between the base plate 224 and the reference plate 226. Reference plate 226 may be mounted to a housing or frame plate of the retractable striker assembly 302″″, which may be mountable to the vehicle door 64, such as to a shut face of the vehicle door, such as to be non-moveable relative to the vehicle door 64 to which the retractable striker assembly 302″″ is mounted to, while base plate 224 and moveable striker 204 are moveable relative to the vehicle door 64 and to the reference plate 226. For example, moveable striker 204 may be configured to slide, such as slide through the reference plate 226. For example, moveable striker 204 may be configured to slide, about the reference plate 226. Reference plate 226 is illustratively shown to include at least one striker mount post 229 about which base plate 224 is configured to slide or move. For example apertures may be provided in the base plate 224 for slideably receiving the striker mount posts 229. Alternatively, notches in the base plate 224 may be provided. Illustratively two springs 227 are provided each surrounding two striker mount post 229 (see FIGS. 91A to 91D). Spring(s) 227 function(s) to cause the base plate 224 to move away from the reference plate 226, such that moveable striker 204 is biased towards a retracted position as shown in FIG. 90B. In order to move the moveable striker 204 to the deployed or extended position as shown in FIG. 90A, an actuator 228a may be provided to act on the base plate 224. When the actuator 228a moves the base plate 224 towards the reference plate 226, the spring(s) 227 is (are) compressed between the base plate 224 and the reference plate 226.

Now referring additionally to FIGS. 91A to 91D, there is illustrated a sequence of views showing an opening or releasing operation of the closure system 202 so as to release the doors 64, 74 from locking engagement with one another. As shown in FIG. 91A, corresponding to FIG. 90A, the closure system 202 is initially shown in a latched state whereby the retractable striker assembly 302″″ in an extended or deployed state, with springs 227 in a compressed state, such that the moveable striker 204 is in a deployed position and engaged by the ratchets 206, 208 of the latch assembly 200 when in a closed or latched state to secure the first door 64 in a closed position with the second door 74. Following a force F applied to the pawl arm 222, the pawl 214 is moved to a ratchet releasing position as shown in FIG. 91B such that the two opposite surfaces of pawl tooth 215 are disengaged from notches 216, 218. Now the ratchets 206, 208 are free to rotate in the releasing direction as caused by at least one of the motion of the moveable striker 204 retraction in the direction BB along axis AA from the mouths 203 of the ratchets 206, 208 due to the decompression of the spring 227 causing the moveable striker 204 to move illustratively leftwards along axis AA in FIG. 91C, and the force of the spring 205 acting on ratchet pin 210 to assist with the synchronization of rotation of the ratchets 206, 208 to avoid a scenario whereby one ratchet of the ratchets 206, 208 is rotated to a striker releasing position, while the other ratchet is not rotated to a striker releasing position to thereby prevent the release of the striker 204. As shown in FIG. 91C, the pawl 214 may be released from activation (Force F is ceased to be applied to pawl arm 222) such that the pawl tooth 215 is shown to be allowed to rest against the ratchets 206, 208 outer surface without acting to prevent the rotation of the ratchets 206, 208. Now referring to FIG. 91D, corresponding to FIG. 90B, the moveable striker 204 is shown to have been moved to a fully retracted position, and the ratchets 206, 208 are shown in a striker releasing position. Moveable striker 204 is illustrated to have translated within a slot 230 of the reference plate 226 such that part (end 204a) of the striker 204 may possibly be extending away from the base plate 226, yet positioned so as not to interfere with door 74, such as by striking a seal, a door hem or lip, or shut face of door 74, should door 64 be moved to an open position. It is possible that end 204a may not extend beyond the base plate 226.

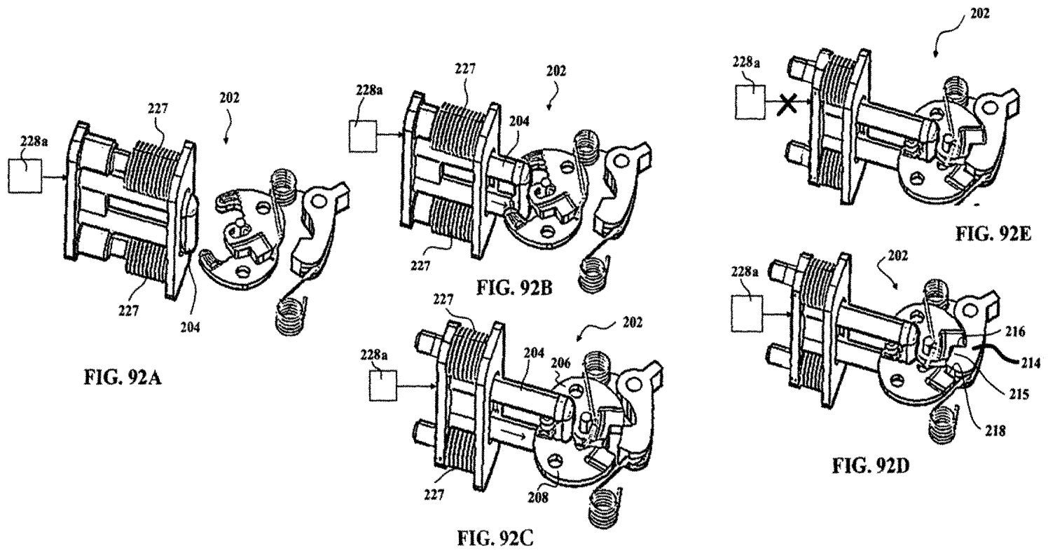

Now referring additionally to FIGS. 92A to 92E, there is illustrated a sequence of views showing a closing or latching operation of the closure system 202. In a closing or latching operation of the closure system 202 so as to latch the doors 64, 74 into engagement with one another, a reverse order of sequence with reference to FIGS. 91A to 91D may be provided, such that when the doors 64, 74 have been moved into a closed position, the actuation of the actuator 228a to advance or extend the moveable striker 204 against the force of the springs 227 to compress the spring 227 (FIG. 92B) and cause rotation of the ratchets 206, 208 (FIG. 92C) until pawl tooth 215 is moved into a ratchet holding position in engagement with notches 216, 218 (FIG. 92D). When pawl 214 is detected to have moved to a ratchet holding position, such as by use of a microswitch or hall sensor arrangement detecting the position of the pawl 214 (or alternatively, a sensor detecting the position of the door, or the ratchets 206, 208), the actuator 228a may be disabled in FIG. 91E whereat the moveable striker 204 is prevented from being moved into a retracted position by the ratchets 206, 208 in the striker capture position and the doors 64, 74 are thus latched together.

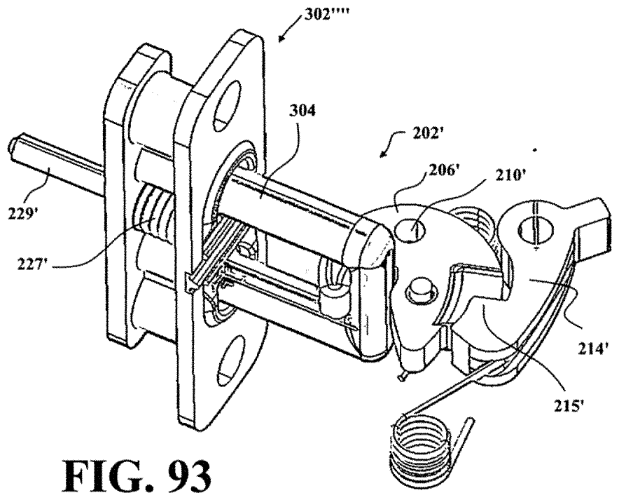

Now further referring to FIG. 93, alternate configurations of closure system 202 may be provided with reference to a closure system 202′, showing the retractable striker assembly 302″″ modified to include a single spring 227′ surrounding a striker mount post 229′, and also showing a single ratchet 206′. Pawl 214′ is shown as a tension pawl in tension having a tooth 215′ whereby the rotation of the ratchet 206′ about a pivot axis or post 210′ in a releasing or opening direction causes the pawl 214′ to be in a tensed state, as compared to the compression pawl 214 of previous figures having a configuration whereby tooth 215 is in compression by the rotation of both the ratchets 206, 208 in a releasing or opening direction.

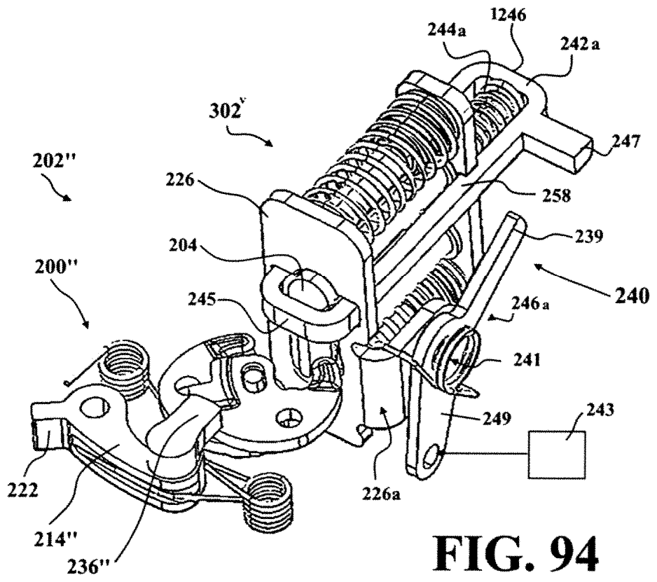

Now further referring to FIG. 94, there is illustrated a modified version of the closure system 202′, referred to using reference number 202″. Closure system 202″ includes latch assembly 200″ similar to latch assembly 200′ yet having a pawl 214″ modified with an additional pawl actuation lug 236′″ as will be described herein below in more detail. Closure system 202″ further includes a retractable striker assembly 302″ similar to retractable striker assembly 302′″ yet modified with an unlocking mechanism 240 for moving the pawl 214″ to a ratchet releasing position. The unlocking mechanism 240 may be actuated by an actuator 243 (either a powered actuator, such as a DC power release motor or a manual actuator such as a connection to a handle provided on the door the assembly 302″ is mounted to), such that the release of the latch assembly 200″ can be realized through an actuation of a release mechanism provided on the door (e.g. rear door 74) adjacent to that door (e.g. front door 64 which the latch assembly 200″ is mounted).

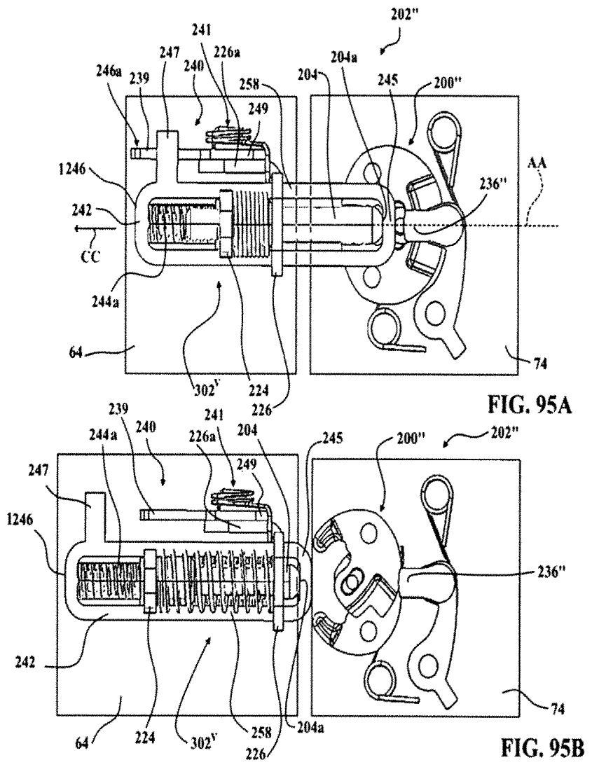

Still referring to FIG. 94, in addition to FIG. 95A and FIG. 95B, the unlocking mechanism 240 of retractable striker assembly 302″ includes a striker release link 242a configured for translation along the axis AA. Illustratively striker release link 242a is biased in a direction of retraction (indicated by arrow CC) similar to the retraction direction of the moveable striker 204 via a striker release biasing spring 244a. Striker release link 242a is shown to have a first end 245 and an opposite second end 1246 interconnected with the first end via a loop 258 configured to surround the moveable striker 204 and the base plate 224. Striker release link 242a is shown to slidably pass through reference plate 226 and be independently translatable relative to the moveable striker 204. The first end 245 of striker release link 242a is configured to abut on its outer surface the pawl actuation lug 236″ when moved in a direction towards the pawl 214″ against the force exerted by striker release biasing spring 244a. The first end 245 of striker release link 242a is further configured to abut on its inner surface the moveable striker 204 (e.g. end 204a) when moved in a direction towards the moveable striker 204 by action of the striker release biasing spring 244a. The inner surface of the opposite second end 1246 of striker release link 242a is configured to abut against the striker release biasing spring 244a disposed between the inner surface of the second end 1246 and the base plate 224. The unlocking mechanism 240 further includes a release lever 246a pivotally mounted to the reference plate 226 (via a flange 226a) about a pivot point 241 and includes a first lever end 239 configured for abutting contact with a lug 247 of the striker release striker release link 242a and a second lever end 249 for actuation by a manual force F or powered force for moving the first lever end 239.

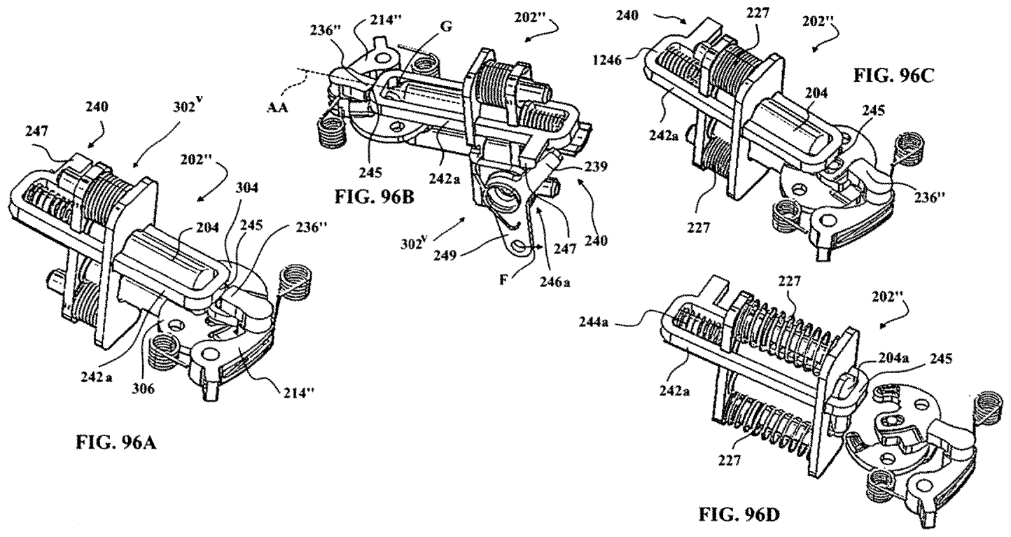

The operation of the closure system 202″ will now be described. With reference to FIG. 96A to 96D, the opening operation of the closure system 202′ by actuation of the striker release link 242a via the actuation of the unlocking mechanism 240 is described as follows. When the closure system 202″ is in a fully latched state as shown in FIG. 96A, the first end 245 of striker release link 242a does not interact with the pawl actuation lug 236″ to cause movement of the pawl 214″. In order to release the pawl 214″ provided on the front door 64 in the configuration whereby the retractable striker assembly 302″ is provided on the rear door 74 for example release lever 246a is pivoted by applying a force F on second lever end 249 originating from an actuation source on the door 74, such as by a motor provided on the door 74, or a the pull of a handle provided on the door 74 connected to second lever end 249 via a bowden cable (FIG. 96B), as an example of an actuator 243. Rotation of second lever end 249 causes first lever end 239 to contact lug 247 (FIG. 96B) to extend the striker release link 242a along the axis AA such that the first end 245 is moved towards the pawl actuation lug 236″ and into eventual contact with the pawl actuation lug 236″. A gap G between the moveable striker 204 and the inner surface of the first end 245 of the striker release link 242a is apparent in FIG. 96B. Spring 244a is now compressed as a result of the extension of the striker release link 242a as shown in FIG. 96B. Continued extension of the moveable striker 204 causes the first end 245 to eventually contact pawl actuation lug 236″ and move the pawl 214″ to its ratchet releasing position. In other words movement of the pawl actuation lug 236″ causes pivoting of the pawl 214″ about its pivot point to a ratchet releasing position. Once the ratchets 206, 208 have moved to a striker releasing position, the moveable striker 204 under the force of the springs 227 is moved to the retracted position as shown occurring in FIG. 96C and FIG. 96D. The striker release link 242a follows the retraction of the moveable striker 204 as spring 244a causes the inner surface of the first end 245 of the striker release link 242a to abut against the moveable striker 204 end (e.g. 204a) as shown in FIG. 96C and FIG. 96D. In such a configuration, the latch assembly 200″ can be released via an actuator positioned on a structure adjacent to the structure the latch assembly 200″ is mounted to. The opening operation of the closure system 202″ by actuation of the pawl actuation lug 222 is similar to that of the opening operation of the closure system 202, and will not be described in detail except to indicate that following the release of the moveable striker 204 by the ratchets 206, 208, the striker release link 242a is retracted along with the retraction of the moveable slider 204 under action of the spring 244a.

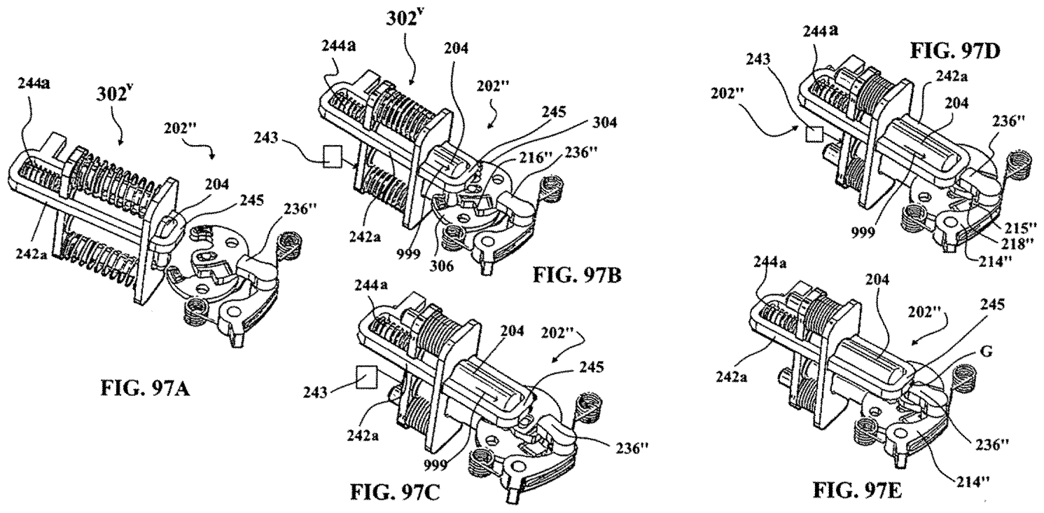

With further reference to FIGS. 97A to 97E, the closing operation of the closure system 202″ is similar to that of the closing operation of the closure system 202. During the advancement or extension of the moveable striker 204 in a direction indicated by arrow 999, the first end 245 of striker release link 242a remains in abutment on its inner surface with the moveable striker 204 due to the bias imparted by the striker release biasing spring 244a. The first end 245 of striker release link 242a does not interact with the ratchets 206, 208 nor with the pawl actuation lug 236″ during the advancement or extension of the moveable striker 204 with the first end 245 of striker release link 242a in abutment on its inner surface with the moveable striker 204. As such when the closure system 202″ is in a fully latched state as shown in FIG. 94E such that actuator 243 no longer urges moveable striker 204 in direction 999, a gap G may be present between the first end 245 of striker release link 242a and the pawl actuation lug 236″ such that the pawl 214″ remains in a ratchet holding position after pawl tooth 215″ is reengaged with ratchet notches 216″, 218″ as shown in FIG. 97D.

FIGS. 89 to 97E therefore illustrates a closure system having a retractable striker for coupling with a latching assembly, where the retractable striker is biased towards a retracted position and is moveable in response to activation of an actuator to advance the retractable striker towards the latching assembly for causing the latching assembly to be shifted from an unlatched state to a latched state. Further, in response to release of the latching assembly, the retractable striker is configured to be automatically retracted to the retracted position by a bias. Further, a locking mechanism associated with the retractable striker may be provided having a member that is extendable and retractable, where when the member is extended, the member is operable for acting on the latching assembly to release the latching assembly.

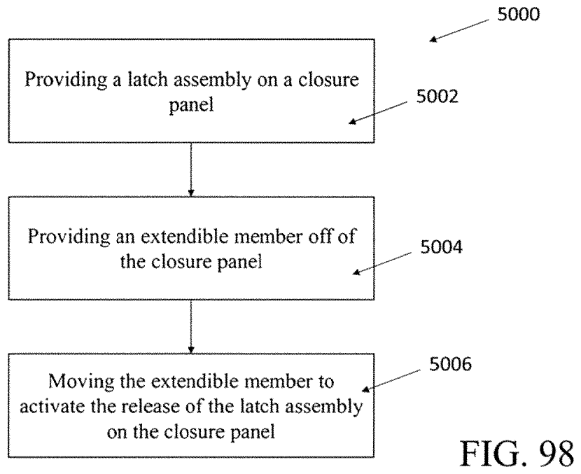

Now additionally referring to FIG. 98, there is shown an illustrative method 5000 for releasing a closure latch assembly provided on a closure panel, or a vehicle body, by extension of an extendible member provided on another closure panel, or provided off of the same closure panel the closure latch assembly is mounted to. The method 5000 includes the steps of providing a latch assembly on a closure panel 5002, providing an extendible member off of (not mounted to) the closure panel 5004, and moving the extendible member to activate the release of the latch assembly on the closure panel 5006. In the step 5006, the extendible member may extend through a divide or gap between two different support structures, which may be a gap between two adjacent doors, such as in a B-pillarless configuration as provided herein above as examples, or extend through a divide or gap between a vehicle closure panel and a vehicle body.

The teachings herein may be applied to and used in conjunction other door system and door latching systems, such as for example door systems described in PCT/CA2020/051786 entitled “DUAL FUNCTION LATCH ASSEMBLY AND RETRACTABLE STRIKER AND/OR RETRACTABLE RATCHET ASSEMBLY FOR DUAL DOOR PILLAR-LESS DOOR SYSTEM AND METHOD OF OPERATION THEREOF”, the entire contents of which are incorporated herein by reference.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A closure system for a motor vehicle having first closure members and second closure members each movable between open and closed positions relative to a vehicle body of the motor vehicle, the closure system comprising:
a retractable striker assembly including a retractable striker and/or a retractable ratchet assembly including a retractable ratchet attached to at least one of the first and second closure members, said retractable striker and said retractable ratchet being movable between an extended position whereat the one of the first and second closure members is maintained in a closed position, and a retracted position, whereat the one of the first and second closure members is free to be moved to an open position.

2. The closure system of claim 1, wherein the first closure member is mounted to an A-pillar of the vehicle body and the second closure member is mounted to a C-pillar of the vehicle body and wherein the vehicle body does not include a B-pillar between the A-pillar and the C-pillar.

3. The closure system of claim 1, wherein the retractable striker, in the extended position, is configured to releasably engage with a latch assembly attached to an adjacent one of the of the first and second closure members and wherein the retractable striker assembly further includes a retractable striker actuator and at least one controller unit configured in communication with the retractable striker actuator to control movement of the retractable striker between the extended position and the retracted position.

4. The closure system of claim 1, wherein the retractable ratchet, in the extended position, is configured to releasably engage with the retractable striker or a fixed striker attached to an adjacent one of the of the first and second closure members.

5. The closure system of claim 4, wherein the retractable ratchet includes a pair of ratchets configured for scissor-like movement between a striker capture position, whereat the retractable striker or a fixed striker is releasably captured between the pair of ratchets and a striker release position whereat the retractable striker or the fixed striker can be removed from between the pair of ratchets.

6. The closure system of claim 5, wherein a ratchet biasing member urges the pair of ratchets toward their striker release position.

7. The closure system of claim 5, wherein the pair of ratchets are sandwiched between a moveable frame plate and a moveable back plate, with one of the pair of ratchets being coupled to the moveable frame plate and the moveable back plate by a first pin for pivotal movement about the first pin and with the other of the pair of ratchets being coupled to the moveable frame plate and the moveable back plate by a second pin for pivotal movement about the second pin, the first pin being spaced from the second pin.

8. The closure system of claim 7, wherein the moveable frame plate and the moveable back plate are received in a housing for slidable movement in the housing along a ratchet translation axis.

9. The closure system of claim 8, further including a pawl lever pivotably attached to the housing, the pawl lever being operably coupled with the retractable ratchet by a pawl to move the retractable ratchet along the ratchet translation axis.

10. The closure system of claim 9, further including an actuator including a ratchet motor operably coupled to the pawl lever to pivot the pawl lever and move the pawl and the retractable ratchet along the ratchet translation axis in a first direction to the extended position in response to the ratchet motor being energized.

11. The closure system of claim 9, further including a pawl spring configured to impart a bias on the pawl to move the pawl toward and into forcible engagement with the retractable ratchet.

12. A method of operating a closure system for a motor vehicle having first and second closure members each movable between open and closed positions relative to a vehicle body of the motor vehicle, the method comprising the steps of:
receiving, by at least one controller unit, a door release signal corresponding to opening of one of the first and the second closure members; and
moving a retractable striker with a retractable striker actuator and/or a retractable ratchet with a respective ratchet actuator of a retractable striker assembly and/or ratchet assembly attached to one of the first and second closure members in response to the door release signal from an extended position, whereat the retractable striker and/or retractable ratchet is engaged with the other of the first and second closure members or a fixed striker, to a retracted position, whereat the retractable striker and/or retractable ratchet is disengaged from the other of the first and second closure members or the fixed striker, thereby allowing the one of the first and second closure members to be opened independently of the other of the first and second closure members.

13. The method of claim 12, wherein the at least one controller unit includes a master controller unit of at least one master latch assembly and a slave controller unit of at least one slave latch assembly in communication with the master controller unit, the method further including the steps of:
controlling actuation of the master actuation group of the at least one master latch assembly operable to control actuation of the one of the first and second closure members to selectively secure the one of the first and second closure members to the vehicle body in addition to the retractable striker assembly using the master controller unit; and
controlling actuation of a slave actuation group of the at least one slave latch assembly operable to control actuation of the one of the first and second closure members to selectively secure the one of the first and second closure members to the vehicle body using the using the slave controller unit.

14. The method of claim 13, further including the steps of:
driving the master actuation group of the at least one master latch assembly using a master H-bridge module coupled to the master controller unit and the master actuation group; and
driving the slave actuation group of the at least one slave latch assembly using a slave H-bridge module coupled to the slave controller unit and the slave actuation group.

15. The method of claim 14, further including the step of supplying electrical energy to the master and slave H-bridge modules and the master and slave controller units and the retractable striker assembly in case of a failure or interruption of a main power supply from a main power source of the motor vehicle using an integrated backup energy source having a group of low voltage supercapacitors coupled to the master and slave H-bridge modules and the master and slave controller units and the retractable striker assembly.

16. The method of claim 13, further including the steps of:
monitoring operation of the slave actuation group and collecting slave diagnostic data and slave latch status using the slave controller unit;
transmitting the slave diagnostic data and the slave latch status to the master controller unit using the slave controller unit in response to collecting the slave diagnostic data and the slave latch status;
monitoring operation of the master actuation group and collecting master diagnostic data and master latch status using the master controller unit;
receiving the slave diagnostic data and the slave latch status from the slave controller unit using the master controller unit;
transmitting the slave diagnostic data and slave latch status and the master diagnostic data and the master latch status to the vehicle main management unit using the master controller unit in response to receiving the slave diagnostic data and the slave latch status;
receiving a main latch control signal from the vehicle main management unit using the master controller unit;
verifying the slave latch status and the master latch status in response to receiving the main latch control signal from the vehicle main management unit using the master controller unit; and
controlling the at least one slave latch assembly to release the one of the first and second closure members using a slave power release mechanism of the at least one slave latch assembly and the master actuation group to release the one of the first and second closure members using a master power release mechanism of the master latch assembly in response to verifying the slave latch status and the master latch status using the master controller unit.

17. The method of claim 13, further including the steps of:
monitoring a vehicle status communicated from the vehicle main management unit using the master controller unit;
determining if the vehicle is moving based on the vehicle status using the master controller unit;
maintaining the retractable striker in the extended position in response to determining the vehicle is moving based on the vehicle status using the master controller unit; and
retracting the retractable striker and maintaining the retractable striker in the retracted position with the retractable striker actuator using the master controller unit in response to determining the vehicle is not moving based on the vehicle status.

18. The method of claim 13, further including the steps of:
monitoring a vehicle status communicated from the vehicle main management unit using the master controller unit;
determining if a crash of the vehicle is detected based on the vehicle status using the master controller unit;
controlling the at least one slave latch assembly to release the one of the first and second closure members with the slave power release mechanism using the master controller unit in response to determining the crash of the vehicle is detected; and
retracting the retractable striker and maintaining the retractable striker in the retracted position with the retractable striker actuator and controlling the master actuation group to release another of the first and second closure members with the master power release mechanism using the master controller unit.

19. The method of claim 13, wherein the at least one master latch assembly includes a front master latch assembly and a rear master latch assembly, the first and second closure members includes a front door and a rear door disposed on a side of the motor vehicle, the method further including the steps of:
monitoring a latch release status using the master controller unit of each of the front and rear master latch assemblies;
determining if a front door release signal is received using the master controller unit of each of the front and rear master latch assemblies;
controlling the at least one slave latch assembly to release the front door from a front door slave striker attached to the vehicle body with the slave power release mechanism and the master actuation group of the front master latch assembly to release the front door from the retractable striker with the master power release mechanism of the front master latch assembly using the master controller unit of each of the front and rear master latch assemblies in response to determining the front door release signal is received thereby allowing the front door to be opened; and
maintaining the retractable striker in the extended position with the retractable striker actuator using the master controller unit of each of the front and rear master latch assemblies.

20. The method of claim 13, wherein the at least one master latch assembly includes a front master latch assembly and a rear master latch assembly, the first and second closure members includes a front door and a rear door disposed on a side of the motor vehicle, the method further including the steps of:
monitoring a latch release status using the master controller unit of each of the front and rear master latch assemblies;
determining if a rear door release signal is received using the master controller unit of each of the front and rear master latch assemblies;
controlling the master actuation group of the front master latch assembly to release the front door from the retractable striker with the master power release mechanism of the front master latch assembly and controlling the master actuation group of the rear master latch assembly to release the rear door from a rear door master striker attached to the vehicle body with the master power release mechanism of the rear master latch assembly using the master controller unit of each of the front and rear master latch assemblies in response to determining the rear door release signal is received; and
retracting the retractable striker to the retracted position with the retractable striker actuator using the master controller unit of each of the front and rear master latch assemblies thereby allowing the rear door to be opened.
